(19) United States
(12) Patent Application Publication
(10) Pub. No.: US 2024/0147493 A1
(43) Pub. Date: May 2, 2024

(54) METHOD AND DEVICE USED IN COMMUNICATION NODE FOR WIRELESS COMMUNICATION

(71) Applicants: Qiaoling YU, Shanghai (CN); Xiaobo ZHANG, Shanghai (CN)

(72) Inventors: Qiaoling YU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/404,909

(22) Filed: Jan. 5, 2024

Related U.S. Application Data
(63) Continuation of application No. PCT/CN2022/104045, filed on Jul. 6, 2022.

(30) Foreign Application Priority Data
Jul. 7, 2021 (CN) 202110766077.X
Jul. 28, 2021 (CN) 202110854168.9

(51) Int. Cl. H04W 72/232; H04L 5/00

(52) U.S. Cl. CPC H04W 72/232; H04L 5/0051; H04L 5/0053

(57) ABSTRACT

A communication node receives a first signaling, and the first signaling indicates a target identity; monitors a first PDCCH, the first PDCCH is associated with a first downlink RS resource, the first downlink RS resource is associated with a first PCI; receives a second signaling, the second signaling is used to indicate a second PCI; as a response to the behavior of receiving a second signaling, monitors a second PDCCH and discards monitoring the first PDCCH, the second PDCCH is associated with a second downlink RS resource, and the second downlink RS resource is associated with the second PCI; the first signaling comprises an RRC message; the second signaling comprises a signaling below the RRC layer; the first PDCCH uses a source identity for scrambling; the second PDCCH uses the target identity for scrambling; the source identity and the target identity are different.

### CROSS REFERENCE TO RELATED APPLICATIONS

This application is the continuation of the international patent application No. PCT/CN2022/104045, filed on Jul. 6, 2022, and claims the priority benefit of Chinese Patent Application No. CN202110766077.X, filed on Jul. 7, 2021 and claims the priority benefit of Chinese Patent Application No. CN202110854168.9, filed on Jul. 28, 2021, the full disclosure of which is incorporated herein by reference.

### BACKGROUND

### Technical Field

The present application relates to transmission methods and devices in wireless communication systems, and in particular to a transmission scheme and device for mobility.

### Related Art

Traditional Network Controlled mobility comprises cell-level mobility and beam-level mobility, where the cell-level mobility depends on a Radio Resource Control (RRC) signaling and the beam-level mobility does not involve an RRC signaling. Prior to 3rd Generation Partnership Project (3GPP) R16, beam-level mobility is only for beam management within a single cell for example. 3GPP RAN #80 meeting decided to carry out a Work Item (WI) “Further enhancements on MIMO for NR” to support multi-beam operation with enhancements for Layer 1 (L1)/Layer 2 (L2)-centric inter-cell mobility and inter-cell multiple Transmit/Receive Points (multi-TRP).

### SUMMARY

L1/L2-centric inter-cell mobility can be implemented in a manner similar to mTRP, where parameters related to L1/L2-centric inter-cell mobility are configured through an RRC message, and a User Equipment (UE), within the coverage area of a current serving cell, determines by receiving a downlink command to use a TRP of another cell for data transmission, which has a different PCI from the current serving cell. When the UE uses a TRP of another cell for data transmission, the operation of the serving cell is affected and needs to be enhanced.

To address the above problem, the present application provides a solution. It should be noted that though the present application only took the Uu interface scenario for example in the statement above; the present application is also applicable to scenarios such as sidelink, where similar technical effects can be achieved. Additionally, the adoption of a unified solution for various scenarios contributes to the reduction of hardware complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict.

The present application provides a method in a first node for wireless communications, comprising:
receiving a first signaling, the first signaling indicating a target identity;
monitoring a first Physical Downlink Control Channel (PDCCH), the first PDCCH being associated with a first downlink Reference Signal (RS) resource, and the first downlink RS resource being associated with a first Physical Cell Identifier (PCI);
receiving a second signaling, the second signaling being used to indicate a second PCI; and
as a response to the behavior of receiving the second signaling, monitoring a second PDCCH and discarding monitoring the first PDCCH, the second PDCCH being associated with a second downlink RS resource, and the second downlink RS resource being associated with the second PCI;
herein, the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively a Radio Network Temporary Identifier (RNTI).

In one embodiment, a problem to be solved in the present application comprises: how to achieve L1/L2-centric inter-cell mobility.

In one embodiment, the L1/L2-centric inter-cell mobility comprises: the first node is located within a serving cell and uses radio resources of another cell, and the another cell and the serving cell have different PCIs.

In one embodiment, when the first node is within a serving cell and uses radio resources of another cell, the serving cell remains unchanged.

In one embodiment, the first node continues to monitor a Broadcast Control Channel (BCCH) of the serving cell while using radio resources of another cell within one serving cell.

In one embodiment, the first node continues to monitor a system message of the serving cell while using radio resources of another cell within one serving cell.

In one embodiment, the L1/L2-centric inter-cell mobility comprises: the first node performs a Physical uplink shared channel (PUSCH)/Physical downlink shared channel (PDSCH) transmission within a serving cell through another TRP, and the another TRP does not belong to the serving cell.

In one embodiment, the L1/L2-centric inter-cell mobility comprises: the first node triggers cell switching based on L1/L2 measurement.

In one embodiment, the L1/L2-centric inter-cell mobility comprises: not performing switching based on L3.

In one embodiment, when the first node triggers cell handover based on L1/L2 measurement, the serving cell undergoes a change.

In one embodiment, a problem to be solved in the present application comprises: how to ensure service continuity.

In one embodiment, a problem to be solved in the present application comprises: how to implement HARQ operations for L1/L2-centric inter-cell mobility.

In one embodiment, advantages of the above method comprise: when L1/L2-centric inter-cell mobility is executed, not resetting a MAC.

In one embodiment, advantages of the above method comprise: improving service continuity.

In one embodiment, advantages of the above method comprise: multiplexing a HARQ process.

In one embodiment, advantages of the above method comprise: avoiding triggering unnecessary beam failure.

In one embodiment, advantages of the above method comprise: avoiding HARQ merging of data on cells identified by different PCIs, so as to reduce data processing complexity.

In one embodiment, advantages of the above method comprise: avoiding L3 switching.

According to one aspect of the present application, comprising:
as a response to the behavior of receiving a second signaling, regarding a first secondary cell to be deactivated;
herein, the first secondary cell and a cell identified by the first PCI belong to a same cell group.

In one embodiment, characteristics of the above method comprise: when a Special Cell (SpCell) executes L1/L2-centric inter-cell mobility, regarding an SCell within a corresponding cell group to be in deactivated state.

According to one aspect of the present application, it is characterized in that the first secondary cell and a cell identified by the second PCI belong to different Timing Advance Groups (TAGs).

In one embodiment, characteristics of the above method comprise: a state of an SCell belonging to a same TAG as an SpCell remains unchanged.

In one embodiment, characteristics of the above method comprise: de-activating an SCell belonging to a different TAG than the SpCell.

According to one aspect of the present application, comprising:

as a response to the behavior of receiving a second signaling, setting a Cell RNTI (C-RNTI) as the target identity.

In one embodiment, characteristics of the above method comprise: the UE side only maintains one C-RNTI at the same time, and a value of the C-RNTI is related to currently used physical resources.

In one embodiment, characteristics of the above method comprise: when an SpCell executes L1/L2-centric inter-cell mobility, setting a C-RNTI as the target identity.

According to one aspect of the present application, comprising:
receiving a first uplink grant and a second uplink grant, the first uplink grant being associated with the source identity, the second uplink grant being associated with the target identity; and
as a response to the behavior of receiving a first uplink grant and a second uplink grant, considering that a first New Data Indicator (NDI) has been toggled;
herein, the first uplink grant and the second uplink grant are associated with a same Hybrid automatic repeat request (HARQ) process; a time for receiving the first uplink grant is earlier than a time for receiving the second uplink grant.

According to one aspect of the present application, comprising:
receiving a first uplink grant and a second uplink grant, the first uplink grant being associated with the source identity, the second uplink grant being associated with the target identity; as a response to the behavior of receiving a first uplink grant and a second uplink grant, considering that a first NDI is not toggled; herein, the first uplink grant and the second uplink grant are associated with a same HARQ process; a time for receiving the first uplink grant is earlier than a time for receiving the second uplink grant.

In one embodiment, characteristics of the above method comprise: for a same HARQ process, when a UL grant associated with C-RNTI is received, if a previous UL grant is associated with a target identity, it is considered that the first NDI has been toggled; herein, the target identity is a C-RNTI of the first node in a cell identified by the second PCI.

According to one aspect of the present application, comprising:

as a response to the behavior of receiving a second signaling, clearing a first counter to zero; the first counter being maintained at the Medium Access Control (MAC) layer.

In one embodiment, characteristics of the above method comprise: the first counter is BFI_COUNTER.

In one embodiment, characteristics of the above method comprise: the first counter is LBT_COUNTER.

In one embodiment, characteristics of the above method comprise: the first counter is for a cell identified by the first PCI, or the first counter is for a cell identified by the second PCI.

In one embodiment, characteristics of the above method comprise: when an SpCell executes L1/L2-centric inter-cell mobility, clearing the first counter to zero.

According to one aspect of the present application, comprising:
receiving a first-type reference signal, the first-type reference signal being associated with the second PCI, and a measurement for the first-type reference signal being used to determine updating the first counter;
and

when the first counter reaches a first value, initiating a first random access process; as a response to the behavior of initiating a first random access process, transmitting a first radio signal, and the first radio signal being associated with the first PCI;

herein, the first value is a positive integer; the first-type reference signal is unrelated to the first PCI.

In one embodiment, characteristics of the above method comprise: when an SpCell executes L1/L2-centric inter-cell mobility, and if beam failure occurs on a cell identified by the second PCI, executing beam failure recovery on a cell identified by the first PCI.

In one embodiment, characteristics of the above method comprise: configuring random access resources for BFR on a cell identified by the first PCI, while not configuring random access resources for BFR on a cell identified by the second PCI.

According to one aspect of the present application, comprising:
transmitting a second radio signal, the second radio signal comprising the source identity;
herein, the second radio signal belongs to the first random access process; the second radio signal is transmitted after the first radio signal.

The present application provides a method in a second node for wireless communications, comprising:
transmitting a first signaling, the first signaling indicating a target identity;
transmitting a first PDCCH, the first PDCCH being associated with a first downlink RS resource, the first downlink RS resource being associated with a first PCI; and
transmitting a second signaling, the second signaling being used to indicate a second PCI;
herein, as a response to the second signaling being received, a second PDCCH is monitored and the first PDCCH is discarded to be monitored, the second PDCCH is associated with a second downlink RS resource, and the second downlink RS resource is associated with the second PCI; the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI.

According to one aspect of the present application, it is characteristic in that as a response to the second signaling being received, a first secondary cell is regarded to be deactivated; herein, the first secondary cell and a cell identified by the first PCI belong to a same cell group.

According to one aspect of the present application, it is characterized in that the first secondary cell and a cell identified by the second PCI belong to different TAGs.

According to one aspect of the present application, it is characteristic in that as a response to the second signaling being received, a C-RNTI is set as the target identity.

According to one aspect of the present application, comprising:
transmitting a first uplink grant, the first uplink grant being associated with the source identity;
herein, as a response to the first uplink grant and the second uplink grant being received, a first NDI is considered to have been toggled; the second uplink grant is associated with the target identity; the first uplink grant and the second uplink grant are associated with a same HARQ process; a time for receiving the first uplink grant is earlier than a time for receiving the second uplink grant.

According to one aspect of the present application, comprising:
transmitting a first uplink grant, the first uplink grant being associated with the source identity;
herein, as a response to the first uplink grant and the second uplink grant being received, a first NDI is considered not to be toggled; the second uplink grant is associated with the target identity; the first uplink grant and the second uplink grant are associated with a same HARQ process; a time for receiving the first uplink grant is earlier than a time for receiving the second uplink grant.

According to one aspect of the present application, it is characteristic in that as a response to the second signaling being received, a first counter is cleared to zero; the first counter is maintained at the MAC layer.

According to one aspect of the present application, comprising:
receiving a first radio signal, the first radio signal being associated with first PCI;
herein, a first-type reference signal is received, the first-type reference signal is associated with the second PCI, and a measurement for the first-type reference signal is used to determine updating the first counter;
when the first counter reaches a first value, a first random access process is initiated; as a response to the first random access process being initiated, the first radio signal is transmitted; the first value is a positive integer;
the first-type reference signal is unrelated to the first PCI.

According to one aspect of the present application, comprising:
receiving a second radio signal, the second radio signal comprising the source identity;
herein, the second radio signal belongs to the first random access process; the second radio signal is transmitted after the first radio signal.

The present application provides a first node for wireless communications, comprising:
a first receiver, receiving a first signaling, the first signaling indicating a target identity; monitoring a first PDCCH, the first PDCCH being associated with a first downlink RS resource, the first downlink RS resource being associated with a first PCI; receiving a second signaling, the second signaling being used to indicate a second PCI; as a response to the behavior of receiving the second signaling, monitoring a second PDCCH and discarding monitoring the first PDCCH, the second PDCCH being associated with a second downlink RS resource, and the second downlink RS resource being associated with the second PCI;
herein, the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI.

The present application provides a second node for wireless communications, comprising:
a second transmitter, transmitting a first signaling, the first signaling indicating a target identity;
transmitting a first PDCCH, the first PDCCH being associated with a first downlink RS resource, the first downlink RS resource being associated with a first PCI; transmitting a second signaling, the second signaling being used to indicate a second PCI;
herein, as a response to the second signaling being received, a second PDCCH is monitored and the first PDCCH is discarded to be monitored, the second PDCCH is associated with a second downlink RS resource, and the second downlink RS resource is associated with the second PCI; the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI.

In one embodiment, the present application has the following advantages over conventional schemes:
avoiding L3 switching;
improving service continuity;
multiplexing a HARQ process;
avoiding triggering unnecessary beam failure;
when L1/L2-centric inter-cell mobility is executed, not resetting a MAC;
avoiding HARQ merging of data on cells identified by different PCIs, so as to reduce data processing complexity.

To implement inter-cell L1/L2 mobility or inter-cell mTRP, when a UE is in a serving cell, the network configures radio parameters of another cell to the UE through an RRC message, and the UE can use a TRP of another cell for data transmission within the coverage area of a serving cell, where the another cell and the serving cell have different PCIs. When the UE uses a TRP of another cell for data transmission within the serving cell and if the current Radio Link Monitoring (RLM) mechanism is adopted, it can lead to premature triggering of Radio Link Failure (RLF), which affects the UE performance. Therefore, enhancements need to be made for the radio link monitoring mechanism.

To address the above problem, the present application provides a solution. It should be noted that though the present application only took the Uu interface scenario for example in the statement above; the present application is also applicable to scenarios such as sidelink, where similar technical effects can be achieved. Additionally, the adoption of a unified solution for various scenarios contributes to the reduction of hardware complexity and costs.

The present application provides a method in a first node for wireless communications, comprising:
receiving a first signaling, the first signaling being used to configure a first Reference Signal (RS) resource group, the first RS resource group comprising at least one RS resource; assessing radio link quality based on the first RS resource group; receiving a second signaling after receiving the first signaling; as a response to the behavior of receiving second signaling, executing a first action set, the first action set comprising resetting count of a first-type indication;
herein, the first signaling is an RRC layer signaling, and the second signaling is a protocol-layer signaling below the RRC layer; the second signaling is used to indicate that all RS resources in a first RS resource subgroup are associated with a first PCI, the first RS resource subgroup comprises at least one RS resource, and any RS resource in the first RS resource subgroup belongs to the first RS resource group; the first-type indication is related to link failure.

In one embodiment, a problem to be solved in the present application comprises: how to avoid triggering RLF in the serving cell when the UE uses radio resources of a cell identified by another PCI in the serving cell.

In one embodiment, a problem to be solved in the present application comprises: how to avoid premature triggering of RLF when the UE uses radio resources of a cell identified by another PCI in the serving cell.

In one embodiment, a problem to be solved in the present application comprises: how to execute RLM measurement when the UE configures radio resources of a cell identified by another PCI in a serving cell.

In one embodiment, characteristics of the above method comprise: a reference signal used for RLM is not only related to a serving cell, but also to a cell identified by another PCI.

In one embodiment, characteristics of the above method comprise: indicating radio resources of a cell identified by another PCI through a signaling below the RRC layer.

In one embodiment, characteristics of the above method comprise: associating at least one reference signal with a cell identified by another PCI through a signaling below the RRC layer.

In one embodiment, characteristics of the above method comprise: radio link monitoring is related to a cell associated with an activated TCI state.

In one subembodiment of the embodiment, when a cell associated with an activated TCI state is a serving cell, radio link monitoring is related to a serving cell and is unrelated to the cell identified by another PCI.

In one subembodiment of the embodiment, when a cell associated with an activated TCI state is a cell identified by another PCI, radio link monitoring is related to the cell identified by the another PCI and is unrelated to a serving cell.

In one subembodiment of the embodiment, when a cell associated with an activated TCI state is a serving cell and a cell identified by another PCI, radio link monitoring is related to both a serving cell and the cell identified by the another PCI.

In one embodiment, characteristics of the above method comprise: radio link monitoring is related to both a cell associated with an activated TCI state and a serving cell.

In one subembodiment of the embodiment, regardless of whether a cell associated with an activated TCI state is a serving cell or the cell identified by the another PCI, radio link monitoring is related to both a serving cell and the cell identified by the another PCI.

In one embodiment, characteristics of the above method comprise: radio link monitoring is only related to a serving cell.

In one subembodiment of the embodiment, regardless of whether a cell associated with an activated TCI state is a serving cell or a cell identified by the another PCI, radio link monitoring is only related to a serving cell, and is unrelated to the cell identified by the another PCI.

In one embodiment, characteristics of the above method comprise: modifying RS resources used for RLM monitoring according to a second signaling.

In one embodiment, characteristics of the above method comprise: RS resources used for RLM monitoring can be associated with a candidate cell for L1/L2 mobility.

In one embodiment, advantages of the above method comprise: avoiding triggering RLF too quickly.

In one embodiment, advantages of the above method comprise: ensuring UE transmission quality.

In one embodiment, advantages of the above method comprise: improving UE service continuity.

According to one aspect of the present application, comprising:

each time the radio link quality assessed based on the first RS resource group being worse than a first threshold, the physical layer of the first node reporting a first indication to a higher layer of the first node; the first-type indication comprising the first indication; the first threshold being configurable.

According to one aspect of the present application, comprising:

each time the radio link quality assessed based on the first RS resource group being better than a second threshold, the physical layer of the first node reporting a second indication to the higher layer of the first node; the first-type indication comprising the second indication; the second threshold being configurable.

According to one aspect of the present application, it is characterized in that the behavior of assessing radio link quality based on the first RS resource group comprises:
after the behavior of resetting count of the first-type indication, count of the first-type indication being unrelated to a measurement result on all REs occupied by the first RS resource subgroup before a first moment, and the second signaling being used to indicate the first moment.

According to one aspect of the present application, it is characterized in that the first action set comprises stopping a first-type timer, and the first-type timer is related to link failure.

According to one aspect of the present application, comprising:

determining that a physical-layer problem occurs; as a response to the behavior of determining an occurrence of a physical-layer problem, starting a first timer;

herein, the first timer is maintained at the RRC layer; the first-type timer comprises the first timer.

According to one aspect of the present application, comprising:
receiving a first radio signal, the first radio signal being used to determine first signal quality;
determining that first signal quality meets a target condition; during a running period of the first timer, as a response to the behavior of determining that first signal quality meets a target condition, starting a second timer;
herein, the target condition comprises a measurement report triggering event; the first-type timer comprises the second timer.

According to one aspect of the present application, comprising:
submitting a first RLC PDU, the first RLC PDU comprising a polling indication; accompanying the behavior of submitting a first RLC PDU, starting a third timer;
herein, an expiration of the third timer is used to determine a retransmission of a polling indication;
the first-type timer comprises the third timer.

According to one aspect of the present application, comprising:
determining a retransmission of a first RLC SDU; as a response to the behavior of determining a retransmission of a first RLC SDU, updating count of a third indication;
herein, count of the third indication is used to determine a number of times the first RLC SDU is retransmitted; the first-type indication comprises the third indication.

The present application provides a method in a second node for wireless communications, comprising:
transmitting a first signaling, the first signaling being used to configure a first RS resource group, the first RS resource group comprising at least one RS resource; and transmitting a second signaling after transmitting the first signaling;
herein, radio link quality is assessed according to the first RS resource group; as a response to the second signaling being received, a first action set is executed, the first action set comprises resetting count of a first-type indication; the first signaling is an RRC layer signaling, and the second signaling is a protocol-layer signaling below the RRC layer; the second signaling is used to indicate that all RS resources in a first RS resource subgroup are associated with a first PCI, the first RS resource subgroup comprises at least one RS resource, and any RS resource in the first RS resource subgroup belongs to the first RS resource group; the first-type indication is related to link failure.

According to one aspect of the present application, it is characterized in that each time the radio link quality assessed based on the first RS resource group is worse than a first threshold, a first indication is reported by the physical layer of a receiver of the first signaling to the higher layer of a receiver of the first signaling; the first-type indication comprises the first indication; the first threshold is configurable.

According to one aspect of the present application, it is characterized in that each time the radio link quality assessed based on the first RS resource group is better than a second threshold, a second indication is reported by the physical layer of the first node to the higher layer of the first node; the first-type indication comprises the second indication; the second threshold is configurable.

According to one aspect of the present application, it is characterized in that the phrase of being assessed according to the first RS resource group radio link quality comprises:
after the behavior of resetting count of the first-type indication, count of the first-type indication being unrelated to a measurement result on all REs occupied by the first RS resource subgroup before a first moment, and the second signaling being used to indicate the first moment.

According to one aspect of the present application, it is characterized in that the first action set comprises stopping a first-type timer, and the first-type timer is related to link failure.

According to one aspect of the present application, it is characterized in that an occurrence of a physical-layer problem is determined; as a response to the occurrence of the physical-layer problem being determined, a first timer is started; herein, the first timer is maintained at the RRC layer; the first-type timer comprises the first timer.

According to one aspect of the present application, comprising:
transmitting a first radio signal, the first radio signal being used to determine first signal quality;
herein, the first signal quality satisfying a target condition is determined; during a running period of the first timer, and as a response to the first signal quality satisfying the target condition being determined, a second timer is started; the target condition comprises a measurement report triggering event; the first-type timer comprises the second timer.

According to one aspect of the present application, it is characterized in that a first RLC PDU is submitted, and the first RLC PDU comprises a polling indication; accompanying the first RL PDU being submitted, a third timer is started; herein, an expiration of the third timer is used to determine a retransmission of a polling indication; the first-type timer comprises the third timer.

According to one aspect of the present application, it is characterized in that a first RLC SDU is determined to be retransmitted; as a response to the first RLC SDU being determined to be retransmitted, count of a third indication is updated; herein, count of the third indication is used to determine a number of times the first RLC SDU is retransmitted; the first-type indication comprises the third indication.

The present application provides a first node for wireless communications, comprising:
a first receiver, receiving a first signaling, the first signaling being used to configure a first RS resource group, the first RS resource group comprising at least one RS resource; assessing assess radio link quality based on the first RS resource group; receiving a second signaling after receiving the first signaling; as a response to the behavior of receiving second signaling, executing a first action set, the first action set comprising resetting count of a first-type indication;
herein, the first signaling is an RRC layer signaling, and the second signaling is a protocol-layer signaling below the RRC layer; the second signaling is used to indicate that all RS resources in a first RS resource subgroup are associated with a first PCI, the first RS resource subgroup comprises at least one RS resource, and any RS resource in the first RS resource subgroup belongs to the first RS resource group; the first-type indication is related to link failure.

The present application provides a second node for wireless communications, comprising:
a second transmitter, transmitting a first signaling, the first signaling being used to configure a first RS resource group, the first RS resource group comprising at least one RS resource; and transmitting a second signaling after transmitting the first signaling;
herein, radio link quality is assessed according to the first RS resource group; as a response to the second signaling being received, a first action set is executed, the first action set comprises resetting count of a first-type indication; the first signaling is an RRC layer signaling, and the second signaling is a protocol-layer signaling below the RRC layer; the second signaling is used to indicate that all RS resources in a first RS resource subgroup are associated with a first PCI, the first RS resource subgroup comprises at least one RS resource, and any RS resource in the first RS resource subgroup belongs to the first RS resource group; the first-type indication is related to link failure.

In one embodiment, the present application has the following advantages over conventional schemes:
avoiding triggering an RLF too quickly;
ensuring UE transmission quality;
improving UE service continuity.

### BRIEF DESCRIPTION OF THE DRAWINGS

Other features, objects and advantages of the present application will become more apparent from the detailed description of non-restrictive embodiments taken in conjunction with the following drawings:

FIG. 1A illustrates a flowchart of transmission of a first signaling, a second signaling, a first PDCCH and a second PDCCH according to one embodiment of the present application;

FIG. 1B illustrates a flowchart of transmission of a first signaling and a second signaling according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5A illustrates a flowchart of radio signal transmission according to one embodiment of the present application;

FIG. 5B illustrates a flowchart of radio signal transmission according to one embodiment of the present application;

FIG. 6A illustrates a flowchart of radio signal transmission according to another embodiment of the present application;

FIG. 6B illustrates a flowchart of radio signal transmission according to another embodiment of the present application;

FIG. 7A illustrates a flowchart of radio signal transmission according to another embodiment of the present application;

FIG. 7B illustrates a flowchart of radio signal transmission according to another embodiment of the present application;

FIG. 8A illustrates a flowchart of radio signal transmission according to another embodiment of the present application;

FIG. 8B illustrates a schematic diagram of the physical layer of a first node reporting a first indication to the higher layer of the first node according to one embodiment of the present application;

FIG. 9A illustrates a schematic diagram of a first secondary cell and a cell identified by a second PCI belonging to different TAGs according to one embodiment of the present application;

FIG. 9B illustrates a schematic diagram of the physical layer of a first node reporting a second indication to the higher layer of the first node according to one embodiment of the present application;

FIG. 10A illustrates a schematic diagram of a relation of a second node and a fourth node according to one embodiment of the present application;

FIG. 10B illustrates a schematic diagram of a relation of a second node and a third node according to one embodiment of the present application;

FIG. 11A illustrates a structure block diagram of a processor in a first node according to one embodiment of the present application;

FIG. 11B illustrates a schematic diagram of assessing radio link quality according to a first RS resource group according to one embodiment of the present application;

FIG. 12A illustrates a structure block diagram of a processor in a second node according to one embodiment of the present application;

FIG. 12B illustrates a structure block diagram of a processor in a first node according to one embodiment of the present application;

FIG. 13A illustrates a flowchart of radio signal transmission of receiving a first uplink grant and a second uplink grant being used to determine considering that a first NDI is not toggled according to one embodiment of the present application;

FIG. 13B illustrates a structure block diagram of a processor in a second node according to one embodiment of the present application;

FIG. 14 illustrates a schematic diagram of a first notification according to one embodiment of the present application;

FIG. 15 illustrates a schematic diagram of a reporting period and an assessment period according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1A

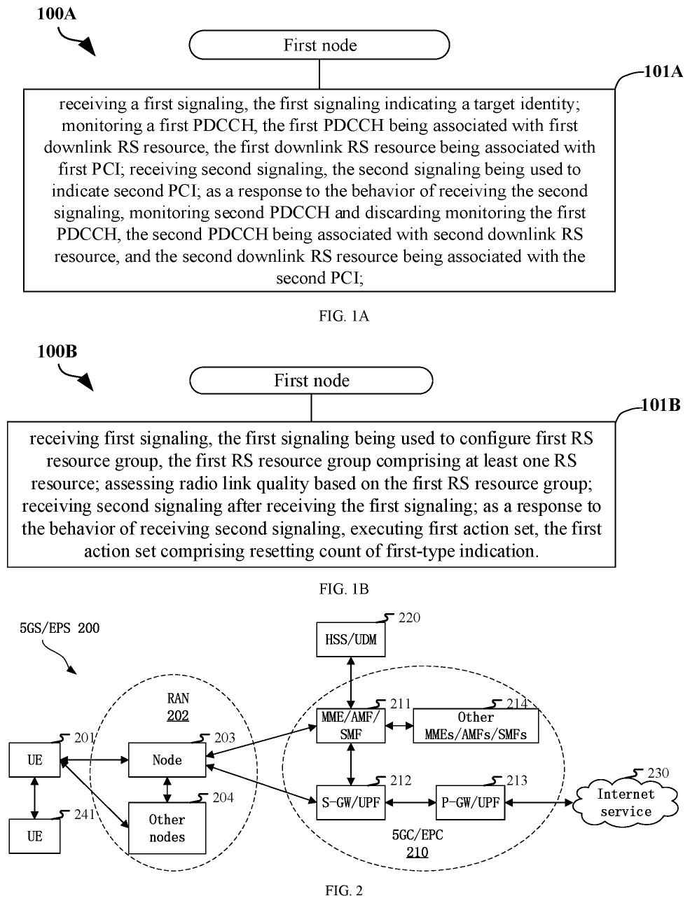

Embodiment 1A illustrates a flowchart of transmission of a first signaling, a second signaling, a first PDCCH and a second PDCCH according to one embodiment of the present application, as shown in FIG. 1A. In FIG. 1A, each box represents a step. It should be noted particularly that the order in which the boxes are arranged does not imply a chronological sequence of each step respectively marked.

In embodiment 1A, a first node in the present application receives a first signaling in step 101A, and the first signaling indicates a target identity; monitors a first PDCCH, the first PDCCH is associated with a first downlink RS resource, the first downlink RS resource is associated with a first PCI; receives a second signaling, the second signaling is used to indicate a second PCI; as a response to the behavior of receiving the second signaling, monitors a second PDCCH and discards monitoring the first PDCCH, the second PDCCH is associated with a second downlink RS resource, and the second downlink RS resource is associated with the second PCI; herein, the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI.

In one embodiment, the phrase that the first signaling comprises an RRC message comprises: the first signaling comprises at least one RRC message.

In one embodiment, the phrase that the first signaling comprises an RRC message comprises: the first signaling comprises at least one Information Element (IE) in an RRC message.

In one embodiment, the phrase that the first signaling comprises an RRC message comprises: the first signaling comprises at least one field in an RRC message.

In one embodiment, the first signaling comprises an RRCReconfiguration message or an RRCConnectionReconfiguration message.

In one embodiment, the first signaling is transmitted via a radio interface.

In one embodiment, the first signaling is a higher-layer message.

In one embodiment, a Signalling Radio Bearer (SRB) of the first signaling comprises SRB1.

In one embodiment, a signaling radio bearer of the first signaling comprises SRB3.

In one embodiment, the first signaling is a command to modify an RRC connection.

In one embodiment, the first signaling comprises an RRCSetup message or an RRCConnectionSetup message.

In one embodiment, the first signaling comprises an RRCReestablishment message or an RRCConnectionReestablishment message.

In one embodiment, the first signaling comprises an RRCResume message or an RRCConnectionResume message.

In one embodiment, the phrase that the first signaling indicates a target identity comprises: the first signaling is used to determine the target identity.

In one embodiment, the phrase that the first signaling indicates a target identity comprises: the target identity is set according to the first signaling.

In one embodiment, the phrase that the first signaling indicates a target identity comprises: the first signaling comprises the target identity.

In one embodiment, the phrase that the first signaling indicates a target identity comprises: a field in the first signaling indicates the target identity.

In one embodiment, the meaning of the monitoring comprises sensing.

In one embodiment, the meaning of the monitoring comprises searching.

In one embodiment, the meaning of monitoring comprises monitoring.

In one embodiment, the meaning of the monitoring comprises passing Cyclic Redundancy Check (CRC) check.

In one embodiment, the behavior of monitoring a PDCCH comprises: determining whether there exists a DCI through an energy detection on search space corresponding to the first PDCCH.

In one embodiment, the behavior of monitoring a PDCCH comprises: determining whether there exists a DCI through a coherent detection on search space corresponding to the PDCCH, where the PDCCH is the first PDCCH or the second PDCCH.

In one embodiment, the behavior of monitoring a PDCCH comprises: determining whether there exists a DCI through a wideband detection on search space corresponding to the PDCCH, where the PDCCH is the first PDCCH or the second PDCCH.

In one embodiment, the behavior of monitoring a PDCCH comprises: determining whether there exists a DCI through a related detection on search space corresponding to the PDCCH, where the PDCCH is the first PDCCH or the second PDCCH.

In one embodiment, the behavior of monitoring a PDCCH comprises: determining whether there exists a DCI through a synchronization detection on search space corresponding to the PDCCH, where the PDCCH is the first PDCCH or the second PDCCH.

In one embodiment, the behavior of monitoring a PDCCH comprises: determining whether there exists a DCI through a waveform detection on search space corresponding to the PDCCH, where the PDCCH is the first PDCCH or the second PDCCH.

In one embodiment, the behavior of monitoring a PDCCH comprises: determining whether there exists a DCI through a maximum likelihood detection in search space corresponding to the PDCCH, where the PDCCH is the first PDCCH or the second PDCCH.

In one embodiment, the behavior of monitoring a first PDCCH comprises: monitoring a PDCCH candidate for a DCI whose CRC is scrambled by the source identity.

In one embodiment, the behavior of monitoring a second PDCCH comprises: monitoring a PDCCH candidate for a DCI whose CRC is scrambled by the target identity.

In one embodiment, the behavior of monitoring a first PDCCH is used to determine a DCI whose CRC is scrambled by the source identity.

In one embodiment, the behavior of monitoring a second PDCCH is used to determine a DCI whose CRC is scrambled by the target identity.

In one embodiment, the first PDCCH bears at least one DCI.

In one embodiment, the first PDCCH comprises a DCI.

In one embodiment, the first PDCCH comprises a PDCCH candidate.

In one embodiment, CRC of a DCI on the first PDCCH is scrambled by the source identity.

In one embodiment, the first PDCCH comprises a PDCCH candidate for a DCI whose CRC is scrambled by the source identity.

In one embodiment, the first PDCCH comprises a PDCCH transmission scrambled by the source identity.

In one embodiment, the first PDCCH comprises a PDCCH transmission scrambled by the source identity, and the PDCCH transmission comprises a DCI.

In one embodiment, the first PDCCH comprises a PDCCH search space.

In one embodiment, the first PDCCH comprises a PDCCH search space set.

In one embodiment, the first PDCCH comprises at least one PDCCH candidate.

In one embodiment, the first PDCCH comprises a Common search space (CSS) set.

In one embodiment, the first PDCCH comprises a set of UE specific search space (USS).

In one embodiment, the first PDCCH is a USS set.

In one embodiment, the first PDCCH is a Type3-PDCCH CSS set.

In one embodiment, the first PDCCH is a Type3A-PDCCH CSS set.

In one embodiment, the first PDCCH is a Type4-PDCCH CSS set.

In one embodiment, the first PDCCH does not comprise a Type0-PDCCH CSS set.

In one embodiment, the first PDCCH does not comprise a Type0A-PDCCH CSS set.

In one embodiment, the first PDCCH does not comprise a Type1-PDCCH CSS set.

In one embodiment, the first PDCCH does not comprise a Type2-PDCCH CSS set.

In one embodiment, the first PDCCH is associated with a search space, the search space is associated with a CORESET, and the CORESET is associated with the first downlink RS resource.

In one embodiment, the phrase that the first PDCCH is associated with a first downlink RS resource comprises: the first PDCCH comprises a PDCCH dedicated to the first node.

In one embodiment, the phrase that the first PDCCH is associated with a first downlink RS resource comprises: the first PDCCH is associated with a time/frequency control resource set (CORESET), and the CORESET comprises the first downlink RS resource.

In one embodiment, the phrase that the first PDCCH is associated with a first downlink RS resource comprises: the first PDCCH is associated with a search space, the search space corresponds to a CORESET, and the CORESET comprises the first downlink RS resource.

In one embodiment, the first downlink RS resource is used to determine a CORESET used for searching downlink control information.

In one embodiment, the first downlink RS resource corresponds to a CORESET identifier.

In one embodiment, the first downlink RS resource corresponds to a search space identifier.

In one embodiment, the first downlink RS resource is associated with a CORESET.

In one embodiment, the first downlink RS resource corresponds to a Transmission Configuration Indication (TCI) state identifier.

In one embodiment, the first downlink RS resource is associated with a TCI state.

In one embodiment, the first downlink RS resource comprises at least one reference signal.

In one embodiment, the first downlink RS resource comprises at least one Channel State Information Reference Signal (CSI-RS).

In one embodiment, the first downlink RS resource comprises at least one Synchronization Signal Block (SSB).

In one embodiment, the first downlink RS resource comprises a CSI-RS indexed by NZP-CSI-RS-ResourceId.

In one embodiment, the first downlink RS resource comprises an SSB indexed by SSB-Index.

In one embodiment, the phrase that the first downlink RS resource is associated with a first PCI comprises: the first downlink RS resource is used to determine a CORESET for searching downlink control information in a cell identified by the first PCI.

In one embodiment, the phrase that the first downlink RS resource is associated with a first PCI comprises: the first downlink RS resource is configured for the cell identified by the first PCI.

In one embodiment, the phrase that the first downlink RS resource is associated with a first PCI comprises: the first downlink RS resources is dedicated to the cell identified by the first PCI.

In one embodiment, the phrase that the first downlink RS resource is associated with a first PCI comprises: any reference signal comprised in the first downlink RS resource is transmitted through a TRP in the cell identified by the first PCI.

In one embodiment, the phrase that the first downlink RS resource is associated with a first PCI comprises: any reference signal comprised in the first downlink RS resource corresponds to a beam of a TRP in the cell identified by the first PCI.

In one embodiment, the phrase that the second signaling comprises a signaling below the RRC layer comprises: the second signaling is a MAC layer signaling.

In one embodiment, the phrase that the second signaling comprises a signaling below the RRC layer comprises: the second signaling is a physical-layer signaling.

In one embodiment, the phrase that the second signaling comprises a signaling below the RRC layer comprises: the second signaling is generated at the MAC layer.

In one embodiment, the phrase that the second signaling comprises a signaling below the RRC layer comprises: the second signaling is generated at the physical layer.

In one embodiment, the phrase that the second signaling comprises a signaling below the RRC layer comprises: the second signaling is not one of a CCCH SDU, a DCCH SDU, a DTCH SDU, a BCCH SDU, or a PCCH SDU.

In one embodiment, the second signaling is used to determine an execution of L1/L2-centric inter-cell mobility.

In one embodiment, the second signaling is used to determine radio resources of the cell identified by the second PCI.

In one embodiment, the second signaling comprises a MAC Protocol Data Unit (PDU).

In one embodiment, the second signaling comprises a MAC Service Data Unit (SDU).

In one embodiment, the second signaling comprises a MAC Control Element (CE).

In one embodiment, the second signaling comprises a MAC subheader.

In one embodiment, the second signaling comprises a MAC field.

In one embodiment, the second signaling comprises a PDCCH.

In one embodiment, the second signaling comprises a DCI.

In one embodiment, the phrase that the second signaling is used to indicate a second PCI comprises:

the second signaling explicitly indicates the second PCI.

In one embodiment, the phrase that the second signaling is used to indicate a second PCI comprises: the second signaling implicitly indicates the second PCI.

In one embodiment, the phrase that the second signaling is used to indicate a second PCI comprises: the second signaling is associated with the second PCI.

In one embodiment, the phrase that the second signaling is used to indicate a second PCI comprises: the second signaling is used to determine radio resources of the cell identified by the second PCI.

In one embodiment, the phrase that the second signaling is used to indicate a second PCI comprises: the second signaling is used to determine a PDCCH for monitoring the cell identified by the second PCI.

In one embodiment, the phrase that the second signaling is used to indicate a second PCI comprises: the second signaling is used to determine an execution of L1/L2-centric inter-cell mobility.

In one embodiment, the second signaling comprises a CORESET ID field, and the CORESET ID field is used to indicate a CORESET.

In one embodiment, the second signaling comprises a CORESET ID field, the CORESET ID field is used to indicate a CORESET, and the CORESET is associated with the cell identified by the second PCI.

In one embodiment, the second signaling comprises a TCI State ID field, and the TCI State ID field is used to indicate a TCI state.

In one embodiment, the second signaling comprises a TCI State ID field, the TCI State ID field is used to indicate a TCI state, and the TCI state is associated with the cell identified by the second PCI.

In one embodiment, the second signaling comprises a TCI State ID field, the TCI State ID field is used to indicate a TCI state, and the TCI state is associated with the second downlink RS resource; herein, the second downlink RS resource is associated with the second PCI.

In one embodiment, the second signaling comprises a Serving Cell ID field, and the Serving Cell ID field indicates an identifier of the serving cell.

In one embodiment, the second signaling comprises a first field, the first field indicates the second PCI, and the first field is not one of a Serving Cell ID field, a CORESET ID field, or a TCI State ID field.

In one subembodiment of the above embodiment, the first field is set as the second PCI.

In one subembodiment of the above embodiment, the first field is set as an index of the second PCI.

In one subembodiment of the above embodiment, the first field is set as a first configuration index, the first configuration index corresponds to a cell identified by the second PCI, and the first configuration index is a non-negative integer.

In one subsidiary embodiment of the subembodiment, the first configuration index is configured by an RRC message.

In one subsidiary embodiment of the subembodiment, the first configuration index is an index in an index set.

In one subordinate embodiment of the subsidiary embodiment, one index in the index set is not less than 0 and the configuration index is not greater than 7.

In one subordinate embodiment of the subsidiary embodiment, a number of index(es) in the index set corresponds to a number of candidate cell(s) for L1/L2-centric inter-cell mobility configured.

In one subembodiment of the embodiment, the first field indicates the target identity.

In one subembodiment of the above embodiment, the first field is set as the target identity, and the target identity is associated with the second PCI.

In one embodiment, the second signaling comprises at least one of the Serving Cell ID field, or the CORESET ID field, or the TCI State ID field or the first field.

In one subembodiment of the above embodiment, the second signaling consists of the Serving Cell ID field, the CORESET ID field and the TCI State ID field.

In one subembodiment of the above embodiment, the second signaling consists of the Serving Cell ID field, two CORESET ID fields and the TCI State ID field.

In one subembodiment of the above embodiment, the second signaling consists of the Serving Cell ID field, the CORESET ID field, the TCI State ID field and the first field.

In one subembodiment of the above embodiment, the second signaling consists of the Serving Cell ID field, two CORESET ID fields, the TCI State ID field and the first field.

In one embodiment, the phrase of as a response to the behavior of receiving a second signaling comprises: when the second signaling is received.

In one embodiment, the phrase of as a response to the behavior of receiving a second signaling comprises: if the second signaling is received.

In one embodiment, the phrase of as a response to the behavior of receiving a second signaling comprises: if an indication of the second signaling being received is received at the MAC layer.

In one embodiment, the phrase of as a response to the behavior of receiving a second signaling comprises: as a subsequent action of the second signaling being received.

In one embodiment, the behavior of receiving a second signaling triggers the behavior of monitoring a second PDCCH and discards monitoring the first PDCCH.

In one embodiment, the second PDCCH bears at least one DCI.

In one embodiment, the second PDCCH comprises a Downlink Control Information (DCI).

In one embodiment, the second PDCCH comprises a PDCCH candidate.

In one embodiment, a CRC of a DCI on the second PDCCH is scrambled by the target identity.

In one embodiment, the second PDCCH comprises a PDCCH candidate for a DCI whose CRC is scrambled by the target identity.

In one embodiment, the second PDCCH comprises a PDCCH transmission scrambled by the target identity.

In one embodiment, the second PDCCH comprises a PDCCH transmission scrambled by the target identity, and the PDCCH transmission comprises a DCI.

In one embodiment, the second PDCCH comprises a PDCCH search space.

In one embodiment, the second PDCCH comprises a PDCCH search space set.

In one embodiment, the second PDCCH comprises at least one PDCCH candidate.

In one embodiment, the second PDCCH comprises a CSS set.

In one embodiment, the second PDCCH comprises a USS set.

In one embodiment, the second PDCCH is a USS set.

In one embodiment, the second PDCCH is a Type3-PDCCH CSS set.

In one embodiment, the second PDCCH is a Type3A-PDCCH CSS set.

In one embodiment, the second PDCCH is a Type4-PDCCH CSS set.

In one embodiment, the second PDCCH does not comprise a Type0-PDCCH CSS set.

In one embodiment, the second PDCCH does not comprise a Type0A-PDCCH CSS set.

In one embodiment, the second PDCCH does not comprise a Type1-PDCCH CSS set.

In one embodiment, the second PDCCH does not comprise a Type2-PDCCH CSS set.

In one embodiment, the second PDCCH is associated with a search space, the search space is associated with a CORESET, and the CORESET is associated with the second downlink RS resource.

In one embodiment, a search space associated with the first PDCCH is different from a search space associated with the second PDCCH.

In one embodiment, a CORESET associated with the first PDCCH is different from a CORESET associated with the second PDCCH.

In one embodiment, a CORESET associated with the first PDCCH is the same as a CORESET associated with the second PDCCH.

In one embodiment, the phrase that the second PDCCH is associated with a second downlink RS resource comprises: the second PDCCH comprises a PDCCH dedicated to the first node.

In one embodiment, the phrase that the second PDCCH is associated with a second downlink RS resource comprises: the second PDCCH is associated with a time/frequency control resource set (CORESET), and the CORESET comprises the second downlink RS resource.

In one embodiment, the phrase that the second PDCCH is associated with a second downlink RS resource comprises: the second PDCCH is associated with a search space, the search space correspond to a CORESET, and the CORESET comprises the second downlink RS resource.

In one embodiment, the second downlink RS resource is used to determine a time-frequency control resource set for searching downlink control information.

In one embodiment, the second downlink RS resource corresponds to a CORESET identifier.

In one embodiment, the second downlink RS resource is associated with a CORESET.

In one embodiment, the second downlink RS resource corresponds to a TCI state identity.

In one embodiment, the second downlink RS resource is associated with a TCI state.

In one embodiment, the second downlink RS resource comprises at least one reference signal.

In one embodiment, the second downlink RS resource comprises at least one CSI-RS.

In one embodiment, the second downlink RS resource comprises at least one SSB.

In one embodiment, the second downlink RS resource comprises a CSI-RS indexed by NZP-CSI-RS-ResourceId.

In one embodiment, the second downlink RS resource comprises an SSB indexed by SSB-Index.

In one embodiment, the phrase that the second downlink RS resource is associated with the second PCI comprises: the second downlink RS resource is used to determine a time-frequency control resource set for searching downlink control information in the cell identified by the second PCI.

In one embodiment, the phrase that the second downlink RS resource is associated with the second PCI comprises: the second downlink RS resource is configured for the cell identified by the second PCI.

In one embodiment, the phrase that the second downlink RS resource is associated with the second PCI comprises: the second downlink RS resources is the cell identified by the second PCI dedicated.

In one embodiment, the phrase that the second downlink RS resource is associated with the second PCI comprises: any reference signal comprised in the second downlink RS resource is transmitted through a TRP in a cell identified by the second PCI.

In one embodiment, the phrase that the second downlink RS resource is associated with the second PCI comprises: any reference signal comprised in the second downlink RS resource corresponds to a beam of a TRP in the cell identified by the second PCI.

In one embodiment, the behavior of monitoring a second PDCCH and discarding monitoring the first PDCCH comprises: starting monitoring the second PDCCH and not continuing monitoring the first PDCCH.

In one embodiment, the behavior of monitoring a second PDCCH and discarding monitoring the first PDCCH comprises: starting monitoring the second PDCCH and not being expected to continue monitoring the first PDCCH.

In one embodiment, the phrase that the first PDCCH uses a source identity for scrambling comprises: a CRC of the first PDCCH uses the source identity for scrambling.

In one embodiment, the phrase that the first PDCCH uses a source identity for scrambling comprises: the source identity is used to generate a scrambling sequence for the first PDCCH.

In one embodiment, the phrase that the first PDCCH uses a source identity for scrambling comprises: the source identity is used to generate an initial scrambling sequence for the first PDCCH.

In one embodiment, the phrase that the second PDCCH uses the target identity for scrambling comprises: a CRC of the second PDCCH uses the target identity for scrambling.

In one embodiment, the phrase that the second PDCCH uses the target identity for scrambling comprises: the target identity is used to generate a scrambling sequence for the second PDCCH.

In one embodiment, the phrase that the second PDCCH uses the target identity for scrambling comprises: the target identity is used to generate an initial scrambling sequence for the second PDCCH.

In one embodiment, the phrase that the source identity is different from the target identity comprises: a name of the source identity and a name of the target identity are different.

In one embodiment, the phrase that the source identity is different from the target identity comprises: a name of the source identity and a name of the target identity are the same, but a value of the source identity and a value of the target identity are different.

In one embodiment, the phrase that the source identity is different from the target identity comprises: a name of the source identity and a name of the target identity are different, and a value of the source identity and a value of the target identity are different.

In one embodiment, the phrase that the source identity is different from the target identity comprises: a value of the source identity and a value of the target identity are different.

In one embodiment, a value of the RNTI comprises an integer.

In one embodiment, a value of the RNTI is an integer not less than 0 and not greater than 65535.

In one embodiment, a value of the RNTI comprises RNTI-Value.

In one embodiment, a value of the RNTI is a hexa-decimal integer.

In one embodiment, a value of the RNTI is a hexa-decimal integer, the value of the RNTI is not less than 0001, and the value of the RNTI is not greater than FFF2.

In one embodiment, the RNTI is a C-RNTI.

In one embodiment, the RNTI is an MCS-C-RNTI.

In one embodiment, the source identity is a C-RNTI, and the target identity is a C-RNTI.

In one embodiment, the source identity is an MCS-C-RNTI, and the target identity is a C-RNTI.

In one embodiment, the source identity is a C-RNTI, and the target identity is an MCS-C-RNTI.

In one embodiment, a name of the source identity is C-RNTI, while a name of the target identity is not C-RNTI.

In one embodiment, the source identity is an identity of the first node in the first cell, and the target identity is an identity of the first node in the second cell.

In one embodiment, the source identity is an identity of the first node in the second cell, and the target identity is an identity of the first node in the first cell.

In one embodiment, the source identity is an identity of the first node in the cell identified by the first PCI, and the target identity is an identity of the first node in the cell identified by the second PCI.

In one embodiment, the source identity is a C-RNTI of the first node in the cell identified by the first PCI; the target identity is a C-RNTI of the first node in the cell identified by the second PCI.

In one embodiment, a type of the source identity is the same as a type of the target identity.

In one embodiment, a type of the source identity is different from a type of the target identity.

In one embodiment, a name of the source identity is not C-RNTI, while a name of the target identity is C-RNTI.

In one embodiment, the source identity is an RNTI of the first node in a PCell.

In one embodiment, the source identity is a C-RNTI.

In one embodiment, the source identity is a C-RNTI of the first node for an MCG.

In one embodiment, a PCI of a serving cell configured to the first node is the same as the first PCI or the second PCI.

In one subembodiment of the above embodiment, a PCI of a serving cell configured to the first node is the same as the first PCI.

In one subembodiment of the above embodiment, a PCI of a serving cell configured to the first node is the same as the second PCI.

In one subembodiment of the above embodiment, a PCI of a serving cell configured to the first node is the same as the first PCI, and a PCI of any serving cell configured to the first node is different from the second PCI.

In one subembodiment of the above embodiment, a PCI of a serving cell configured to the first node is the same as the second PCI, and a PCI of any serving cell configured to the first node is different from the first PCI.

In one embodiment, the first PDCCH indicates scheduling information of the second signaling.

In one embodiment, a PDCCH indicates scheduling information of a PUSCH, and the PDCCH is the first PDCCH or the second PDCCH.

In one embodiment, a PDCCH indicates scheduling information of a PDSCH, and the PDCCH is the first PDCCH or the second PDCCH.

In one embodiment, the scheduling information comprises at least one of time-domain location, frequency-domain location, Modulation and Coding Scheme (MCS), Redundancy Version (RV), New Data Indicator (NDI), or HARQ Process Identity.

In one embodiment, the time-domain location comprises resource allocation in time domain.

In one embodiment, the time-domain location comprises slot allocation.

In one embodiment, the time-domain location comprises symbol allocation.

In one embodiment, the time-domain position is calculated according to section 5.1.2.1 of TS 38.214.

In one embodiment, the time-domain location is calculated based on a field in a DCI corresponding to the PDCCH, the field comprises a Time domain resource assignment field, and the PDCCH is either the first PDCCH or the second PDCCH.

In one embodiment, the time-domain location is determined based on Time domain resource assignment field.

In one embodiment, the time-domain location is determined based on PDSCH-TimeDomainResourceAllocation field.

In one embodiment, the time-domain location is determined according to Table 5.1.2.1.1-1 in TS 38.214.

In one embodiment, a field in a DCI corresponding to the PDCCH indicates a value of m, the value of m is used to determine the time-domain location, the value of m indicates a row index m+1 in Table 5.1.2.1.1-1 of TS 38.214, where the PDCCH is the first PDCCH or the second PDCCH.

In one embodiment, Time domain resource assignment field indicates the value of m.

In one embodiment, the row index m+1 is used to determine at least one of slot offset K0, or Start and Length Indicator Value (SLIV), or directly start symbol S, or allocation length L, or PDSCH mapping type.

In one embodiment, the frequency-domain location comprises resource allocation in frequency domain.

In one embodiment, the frequency-domain location is calculated according to section 5.1.2.2.2 of TS 38.214.

In one embodiment, the frequency-domain location is calculated based on a field in a DCI corresponding to the PDCCH, the field comprises a Frequency domain resource assignment field, and the PDCCH is either the first PDCCH or the second PDCCH.

In one embodiment, the frequency-domain location is determined based on downlink resource allocation method 0 (type 0).

In one embodiment, the frequency-domain location is determined based on downlink resource allocation method 1 (type 1).

In one embodiment, the frequency-domain location is determined by a bitmap, the bitmap indicates resource block groups (RBGs), and the resource group comprises a set of consecutive virtual resource blocks.

In one embodiment, a field in a DCI corresponding to the PDCCH indicates a resource indication value (RIV), the RIV indicates a start of a virtual resource block (RB start) and a length measured by continuously allocated resource blocks (L RBS), and the PDCCH is the first PDCCH or the second PDCCH.

In one embodiment, the Frequency domain resource assignment field indicates the RIV.

In one embodiment, the MCS is determined based on a field in a DCI corresponding to the PDCCH, the field comprises a modulation and coding scheme field (IMCS), and the PDCCH is the first PDCCH or the second PDCCH.

In one embodiment, the MCS comprises at least one of modulation order (Qm) or target code rate (R).

In one embodiment, the NDI is determined based on a field in a DCI corresponding to a PDCCH, the field comprises an NDI field, and the PDCCH is either the first PDCCH or the second PDCCH.

In one embodiment, the HARQ process number comprises a HARQ process number.

In one embodiment, the HARQ process number is determined based on a field in a DCI corresponding to the PDCCH, the field comprises a HARQ process number field, and the PDCCH is the first PDCCH or the second PDCCH.

In one embodiment, the RV is determined based on a field in a DCI corresponding to the PDCCH, the field comprises a redundant version (rv) field, and the PDCCH is either the first PDCCH or the second PDCCH.

In one embodiment, one of the cell identified by the first PCI and the cell identified by the second PCI is configured as a serving cell for the first node.

In one embodiment, the cell identified by the first PCI is the first cell, and the cell identified by the second PCI is the second cell.

In one embodiment, the source identity is an identity of the first node in the cell identified by the first PCI; the target identity is an identity of the first node in the cell identified by the second PCI.

In one embodiment, the first PCI is different from the second PCI.

In one embodiment, at least one slot before the behavior of receiving a second signaling and at least one slot after the behavior of receiving a second signaling, the first node always monitors a BCCH on the cell identified by the first PCI.

In one embodiment, at least one slot before the behavior of receiving a second signaling and at least one slot after the behavior of receiving a second signaling, the first node always monitors system information (SI) on the cell identified by the first PCI.

In one embodiment, the meaning of being associated with comprises: being addressed to.

In one embodiment, the meaning of being associated with comprises: being related to.

In one embodiment, the meaning of being associated with comprises: associate.

In one embodiment, the meaning of being associated with comprises: being associated with.

In one embodiment, the meaning of A1 being associated with B1 comprises: the B1 can be obtained through the A1.

In one embodiment, the meaning of A1 being associated with B1 comprises: the A1 can be obtained through the B1.

In one embodiment, the meaning of A1 being associated with B1 comprises: the A1 being used to determine the B1.

In one embodiment, the meaning of A1 being associated with B1 comprises: the B1 being used to determine the A1.

In one embodiment, the meaning of A1 being associated with B1 comprises: there is a one-to-one correspondence between the A1 and the B1.

In one embodiment, the meaning of A1 being associated with B1 comprises: the A1 comprises the B1.

In one embodiment, the meaning of A1 being associated with B1 comprises: the B1 comprises the A1.

In one embodiment, the meaning of A1 being associated with B1 comprises: the A1 being related to the B1.

In one embodiment, the meaning of A1 being associated with B1 comprises: the A1 and the B1 correspond to a same parameter.

In one embodiment, the meaning of A1 being associated with B1 comprises: the A1 and the B1 corresponding to a same identifier.

### Embodiment 1B

Embodiment 1B illustrates a flowchart of transmission of a first signaling and a second signaling according to one embodiment of the present application, as shown in FIG. 1B. In FIG. 1B, each box represents a step. It should be noted particularly that the order in which the boxes are arranged does not imply a chronological sequence of each step respectively marked.

In embodiment 1B, the first node in the present application receives a first signaling in step 101B, the first signaling is used to configure a first RS resource group, the first RS resource group comprises at least one RS resource; and assesses radio link quality based on the first RS resource group; receives a second signaling after receiving the first signaling; as a response to the behavior of receiving second signaling, executes a first action set, the first action set comprises resetting count of a first-type indication; herein, the first signaling is an RRC layer signaling, and the second signaling is a protocol-layer signaling below the RRC layer; the second signaling is used to indicate that all RS resources in a first RS resource subgroup are associated with a first PCI, the first RS resource subgroup comprises at least one RS resource, and any RS resource in the first RS resource subgroup belongs to the first RS resource group; the first-type indication is related to link failure.

In one embodiment, before the behavior of resetting count of the first-type indication, all RS resources in a second RS resource subgroup are associated with the second PCI, the second RS resource subgroup comprises at least one RS resource, and any RS resource in the second RS resource subgroup belongs to the first RS resource group.

In one embodiment, after the behavior of resetting count of the first-type indication, all RS resources in a first RS resource subgroup are associated with a first PCI, the first RS resource subgroup comprises at least one RS resource, and any RS resource in the first RS resource subgroup belongs to the first RS resource group.

In one embodiment, at least one assessment period before the behavior of receiving the second signaling and at least one assessment period after the behavior of receiving the second signaling, radio link quality is assessed according to the first RS resource group.

In one embodiment, at least one assessment period before the behavior of receiving the second signaling and at least one assessment period after the behavior of receiving the second signaling, RS resources in the first RS resource group used to assess radio link quality are different.

In one embodiment, within at least one assessment period before the behavior of receiving a second signaling, RS resources used to assess radio link quality are all RS resources in the second RS resource subgroup of the first RS resource group; in at least one assessment period after the behavior of receiving a second signaling, RS resources used to assess radio link quality are all RS resources in the first RS resource subgroup of the first RS resource group.

In one embodiment, if the first node remains in RRC_CONNECTED state, radio link quality is assessed based on the first RS resource group.

In one embodiment, if the first node remains in RRC_CONNECTED state, and the first cell is in activated state, radio link quality is assessed based on the first RS resource group.

In one embodiment, the phrase that the first signaling is an RRC layer signaling comprises: the first signaling is generated at the RRC layer.

In one embodiment, the phrase that the first signaling is an RRC layer signaling comprises: the first signaling is an RRC message.

In one embodiment, the phrase that the first signaling is an RRC layer signaling comprises: the first signaling is transmitted through an RRC message.

In one embodiment, the phrase that the first signaling is an RRC layer signaling comprises: the first signaling comprises an RRC Protocol Data Unit (PDU).

In one embodiment, the first signaling is transmitted via a Uu interface.

In one embodiment, the first signaling is transmitted via a PC5 interface.

In one embodiment, the first signaling comprises an RRCReconfiguration message.

In one embodiment, the first signaling comprises a System Information Block 1 (SIB1) message.

In one embodiment, the first signaling comprises a SystemInformation message.

In one embodiment, a logical channel of the first signaling comprises a Broadcast Control Channel (BCCH).

In one embodiment, a logical channel of the first signaling comprises a Dedicated Control Channel (DCCH).

In one embodiment, a logical channel of the first signaling comprises a Common Control Channel (CCCH).

In one embodiment, a logical channel of the first signaling comprises a Sidelink Control Channel (SCCH).

In one embodiment, a logical channel of the first signaling comprises a Sidelink Broadcast Control Channel (SBCCH).

In one embodiment, the first signaling comprises a Downlink (DL) signaling.

In one embodiment, the first signaling comprises a sidelink signaling.

In one embodiment, the first signaling is an RRC message.

In one embodiment, the first signaling comprises at least one RRC message.

In one embodiment, the first signaling comprises at least one IE in an RRC message.

In one embodiment, the first signaling comprises at least one field in an RRC message.

In one embodiment, the first signaling comprises a ControlResourceSet IE, and at least one field in the ControlResourceSet IE indicates the first RS resource group.

In one embodiment, the first signaling comprises a TCI State IE, and at least one field in the TCI State IE indicates the first RS resource group.

In one embodiment, the first signaling comprises at least one referenceSignal field, and the at least one referenceSignal field indicates the first RS resource group.

In one embodiment, the first signaling is a field or an IE other than IE RadioLinkMonitoringConfig.

In one embodiment, the first signaling comprises at least one IE other than IE RadioLinkMonitoringConfig.

In one embodiment, the first signaling does not comprise at least one IE other than IE RadioLinkMonitoringConfig.

In one embodiment, the first signaling comprises IE RadioLinkMonitoringConfig, as well as at least one field or at least one IE other than IE RadioLinkMonitoringConfig.

In one embodiment, the first signaling comprises M subsignaling(s), and each sub-signaling comprises an IE RadioLinkMonitoringConfig, M being a number of Bandwidth Part (BWP).

In one embodiment, the first signaling comprises at least one IE RadioLinkMonitoringConfig.

In one embodiment, the first signaling comprises at least one failureDetectionResourcesToAddModList field.

In one embodiment, the first signaling comprises a failureDetectionResourcesToAddModList field.

In one embodiment, a RadioLinkMonitoring RS field in the first signaling is used to configure one RS in the first RS resource group.

In one embodiment, a detectionResource field in the first signaling is used to configure an index of any RS resource in the at least one RS resource in the first RS resource group.

In one embodiment, a detectionResource field in the first signaling is used to configure a type of any RS resource in the at least one RS resource in the first RS resource group.

In one embodiment, a detectionResource field in the first signaling is used to configure a type and index of any RS resource in the at least one RS resource in the first RS resource group.

In one embodiment, the first signaling is used to configure a resource index set, and the resource index set is used to determine the first RS resource group.

In one embodiment, csi-RS-Index in the first signaling is used to determine a CSI-RS resource configuration index, or ssb-Index in the first signaling is used to determine an SS/PBCH block index (SSB index).

In one embodiment, the first node is not configured with RadioLinkMonitoringRS, and the first node is provided for PDCCH receptions TCI states that include one or more of a CSI-RS.

In one embodiment, the first node is configured with RadioLinkMonitoringRS, and the first node is provided with TCI state comprising one or more CSI-RSs for PDCCH receptions.

In one embodiment, the phrase that the first signaling is used to configure a first RS resource group comprises: the first signaling being used to determine any RS resource in the first RS resource group.

In one embodiment, the phrase that the first signaling is used to configure a first RS resource group comprises: the first signaling being used to determine an index of each RS resource in the first RS resource group.

In one embodiment, the phrase that the first signaling is used to configure a first RS resource group comprises: the first signaling being used to determine a type of each RS resource in the first RS resource group.

In one embodiment, the phrase that the first signaling is used to configure a first RS resource group comprises: the first signaling being used to determine an index and type of each RS resource in the first RS resource group.

In one embodiment, the first RS resource group refers to radio link monitoring resources.

In one embodiment, the first RS resource group is used for radio link monitoring.

In one embodiment, the first RS resource group comprises at least one set q̅₀.

In one embodiment, the first RS resource group only comprises one set q̅₀.

In one embodiment, the first RS resource group is associated with a cell identified by the first PCI.

In one embodiment, the first RS resource group is associated with a cell identified by the second PCI.

In one embodiment, the first RS resource group is simultaneously associated with a cell identified by the first PCI and a cell identified by the second PCI.

In one embodiment, RS resources in the first RS resource group are used for radio link monitoring or link recovery procedures.

In one embodiment, the first RS resource group comprises N1 RS resource(s), and N1 is a positive integer.

In one embodiment, among N1 RS resource(s) comprised in the first RS resource group, at most N2 RS resource(s) is(are) used for radio link monitoring, N1 is a positive integer, and N2 is not greater than N1.

In one embodiment, the N1 is N_{LR-RLM}, and the definition of the N_{LR-RLM} refers to section 5 in 3GPP TS38.213.

In one embodiment, the N1 is N_{LR-RLM}, the N2 is N_{RLM}, and the definition of the N_{LR-RLM} and the N_{RLM} refer to section 5 in 3GPP TS38. 213.

In one embodiment, the first RS resource group is used by a cell identified by the first PCI for Channel State Information Reference Signal (CSI-RS) resource of a UE of the serving cell.

In one embodiment, the first RS resource group is used by a cell identified by the first PCI for ZP-CSI-RS resource of a UE of the serving cell.

In one embodiment, the first RS resource group is used by a cell identified by the first PCI for interference measurement of a UE of the serving cell.

In one embodiment, the first RS resource group is used by a cell identified by the first PCI for CSI-IM-Resource of a UE of the serving cell.

In one embodiment, any RS resource in at least one RS resource in the first RS resource group is a Synchronization Signal Block (SSB) indexed by SSB-Index or ssb-Index.

In one embodiment, any RS resource in at least one RS resource in the first RS resource group is a CSI-RS indexed by csi-RS-Index or NZP-CSI-RS-ResourceId.

In one embodiment, any RS resource in at least one RS resource in the first RS resource group is a CSI-RS indexed by csi-RS-Index or NZP-CSI-RS-ResourceId, or, any RS resource in the at least one RS resource in the first RS resource group is an SSB indexed by SSB-Index or ssb-Index.

In one embodiment, the first RS resource group is Quasi co-located (QCL) with the cell identified by the first PCI and the cell identified by the second PCI.

In one embodiment, the phrase that the first RS resource group comprises at least one RS resource comprises: the first RS resource group comprises one RS resource.

In one embodiment, the phrase that the first RS resource group comprises at least one RS resource comprises: the first RS resource group comprises more than one RS resource.

In one embodiment, the phrase that the first RS resource group comprises at least one RS resource comprises: the first RS resource group comprises one or more than one RS resource.

In one embodiment, the phrase that the first RS resource group comprises at least one RS resource comprises: a number of RS resources in the first RS resource group is configurable.

In one embodiment, a type of an RS resource comprises a Synchronization Signal/Physical Broadcast Channel Block (SSB) resource.

In one embodiment, a type of an RS resource comprises CSI-RS resources.

In one embodiment, a type of an RS resource comprises CSI-IM resources.

In one embodiment, a type of an RS resource comprises Demodulation Reference Signal (DMRS) resources.

In one embodiment, a type of an RS resource comprises Sounding Reference Signal (SRS) resources.

In one embodiment, a type of an RS resource comprises Cell Reference Signal (CRS) resources.

In one embodiment, types of any two RS resources in the first RS resource group are the same.

In one embodiment, types of any two RS resources in the first RS resource group are different.

In one embodiment, the behavior of assessing radio link quality according to the first RS resource group comprises: within an assessment period, assessing radio link quality based on the first RS resource group.

In one embodiment, the behavior of assessing radio link quality according to the first RS resource group comprises: assessing the radio link quality based on a measurement taken against the first RS resource group.

In one embodiment, the behavior of assessing radio link quality according to the first RS resource group comprises: determining the radio link quality based on a measurement taken against the first RS resource group.

In one embodiment, the behavior of assessing radio link quality according to the first RS resource group comprises: the first RS resource set is used to determine the radio link quality.

In one embodiment, the behavior of assessing radio link quality according to the first RS resource group comprises: the first RS resource set is used to assess the radio link quality.

In one embodiment, the behavior of assessing radio link quality according to the first RS resource group comprises: a measurement result for at least one RS in the first RS resource group is used to determine the radio link quality.

In one embodiment, the behavior of assessing radio link quality according to the first RS resource group comprises: a measurement result for all RSs in the first RS resource group is used to determine the radio link quality.

In one embodiment, the behavior of assessing radio link quality according to the first RS resource group comprises: a measurement result for partial RSs in the first RS resource group is used to determine the radio link quality.

In one embodiment, the behavior of assessing radio link quality according to the first RS resource group comprises: assessing radio link quality based on the N2 RS resource(s) in the first RS resource group.

In one embodiment, the behavior of assessing radio link quality according to the first RS resource group comprises: assessing radio link quality based on a measurement of the N2 RS resource(s) in the first RS resource group.

In one embodiment, the radio link quality comprises: radio link quality.

In one embodiment, the radio link quality comprises: radio link measurement result.

In one embodiment, the radio link quality comprises: L1 (Layer 1)-RSRP (Reference Signal Received Power) measurement result.

In one embodiment, the radio link quality comprises: L1-RSRQ (Reference Signal Received Quality) measurement result.

In one embodiment, the radio link quality comprises: L1-SINR (Signal to Interference plus Noise Ratio) measurement result.

In one embodiment, the radio link quality comprises: Block Error Ratio (BLER).

In one embodiment, the radio link quality refers to radio link quality of a cell.

In one embodiment, the radio link quality refers to radio link quality of a beam.

In one embodiment, the radio link quality refers to radio link quality of a TRP.

In one embodiment, an assessment period of the radio link quality assessed according to the first RS resource group comprises at least one slot.

In one embodiment, an assessment period of the radio link quality assessed according to the first RS resource group is 1 frame.

In one embodiment, an assessment period of the radio link quality assessed according to the first RS resource group is 1 radio frame.

In one embodiment, a reporting period of the radio link quality assessed according to the first RS resource group comprises at least one slot.

In one embodiment, a reporting period of the radio link quality assessed according to the first RS resource group is 2 ms.

In one embodiment, a reporting period of the radio link quality assessed according to the first RS resource group is 10 ms.

In one embodiment, a reporting period of the radio link quality assessed according to the first RS resource group is a shortest period of the first RS resource group.

In one embodiment, a reporting period of the radio link quality assessed according to the first RS resource group is a smallest period in a periodic CSI-RS configuration and/or an SS/PBCH block (SSB) on a PCell or a PSCell in the first RS resource group.

In one embodiment, a maximum value between a minimum period in a periodic CSI-RS configuration in the first RS resource group and/or an SSB/PBCH block on a PCell or a PSCell and 2 ms is used to determine a reporting period of the radio link quality assessed by the first RS resource group.

In one embodiment, a maximum value of a shortest period of the first RS resource group and 10 ms is used to determine a reporting period of the radio link quality assessed according to the first RS resource group.

In one embodiment, the first node uses a maximum of a shortest period of the first RS resource group and 10 ms as a reporting period of the radio link quality assessed by the first RS resource group.

In one embodiment, the first node uses a maximum value of a minimum period in a periodic CSI-RS configuration in the first RS resource group and/or an SS/PBCH block on a PCell or a PSCell and 2 milliseconds as a reporting period of the radio link quality as assessed by the first RS resource group.

In one embodiment, the first node uses a maximum value of a shortest period of the first RS resource group and a DRX period as a reporting period of the radio link quality assessed by the first RS resource group.

In one embodiment, the assessment period comprises the previous time period.

In one embodiment, the assessment period is a time interval before the radio link quality is reported.

In one embodiment, at least one RS resource is assessed in the assessment period.

In one embodiment, the meaning of the assessment comprises at least one of measuring, filtering, processing, receiving, calculating, estimating, or determining.

In one embodiment, the reporting period comprises an indication period.

In one embodiment, the slot comprises at least one of slot, or subframe, or radio frame, or frame, or multiple Orthogonal Frequency Division Multiplexing (OFDM) symbols, or multiple Single Carrier Frequency Division Multiple Access (SC-FDMA) symbols.

In one embodiment, the slot comprises a time interval of at least 1 millisecond.

In one embodiment, the second signaling is used to determine associating RS resources used to assess radio link quality with the cell identified by the first PCI.

In one embodiment, the second signaling comprises a MAC Control Element (CE).

In one embodiment, the second signaling comprises a MAC subheader.

In one embodiment, the second signaling comprises a MAC PDU.

In one embodiment, the second signaling comprises a Downlink Control Information (DCI).

In one embodiment, the second signaling is UE-specific.

In one embodiment, the second signaling indicates UE-specific PDCCH TCI state.

In one embodiment, the second signaling indicates UE-specific PDSCH TCI state.

In one embodiment, after receiving the first signaling and before receiving the second signaling, all RS resources in the first RS resource subgroup are associated with a second PCI.

In one embodiment, the first PCI is associated with the first cell, and the second PCI is associated with the second cell.

In one embodiment, the first PCI is associated with the second cell, and the second PCI is associated with the first cell.

In one embodiment, the first PCI is a PCI of the first cell, and the second PCI is a PCI of the second cell.

In one embodiment, the first PCI is a PCI of the second cell, and the second PCI is a PCI of the first cell.

In one embodiment, the second PCI is different from the first PCI.

In one embodiment, the phrase that all RS resources in a first RS resource subgroup are associated with a first PCI comprises: the first PCI is used to generate a reference signal corresponding to all RS resources in the first RS resource subgroup.

In one embodiment, the phrase that all RS resources in a first RS resource subgroup are associated with a first PCI comprises: all RS resources in the first RS resource subgroup are QCL with a cell QCL identified by the first PCI.

In one embodiment, the phrase that all RS resources in a first RS resource subgroup are associated with a first PCI comprises: a reference signal corresponding to all RS resources in the first RS resource subgroup is transmitted in the cell identified by the first PCI.

In one embodiment, the phrase that all RS resources in a first RS resource subgroup are associated with a first PCI comprises: a reference signal in the cell identified by the first PCI is transmitted by using one RS resource in the first RS resource subgroup.

In one embodiment, the phrase that the second signaling is used to indicate that all RS resources in a first RS resource subgroup are associated with a first PCI comprises: the second signaling is used to determine that all RS resources in the first RS resource subgroup are associated with the first PCI.

In one embodiment, the phrase that the second signaling is used to indicate that all RS resources in a first RS resource subgroup are associated with a first PCI comprises: the second signaling explicitly indicates that all RS resources in the first RS resource subgroup are associated with the first PCI.

In one embodiment, the phrase that the second signaling is used to indicate that all RS resources in a first RS resource subgroup are associated with a first PCI comprises: the second signaling implicitly indicates that all RS resources in the first RS resource subgroup are associated with the first PCI.

In one embodiment, the second signaling indicates that the first PCI is used to determine that all RS resources in the first RS resource subgroup are associated with the first PCI.

In one embodiment, the second signaling indicates that an index of a cell identified by the first PCI is used to determine that all RS resources in the first RS resource subgroup are associated with the first PCI.

In one embodiment, the second signaling indicates that a target TCI state is used to determine that all RS resources in the first RS resource subgroup are associated with the first PCI; herein, the target TCI state is associated with a cell identified by the first PCI.

In one embodiment, the second signaling indicates that a target CORESET is used to determine that all RS resources in the first RS resource subgroup are associated with the first PCI; herein, the target CORESET is associated with a cell identified by the first PCI.

In one embodiment, the second signaling comprises a MAC CE, and at least one field within the MAC CE is used to determine that all RS resources in the first RS resource subgroup are associated with the first PCI.

In one embodiment, the second signaling comprises a DCI, and at least one field within the DCI is used to determine that all RS resources in the first RS resource subgroup are associated with the first PCI.

In one embodiment, the second signaling comprises at least one field in a MAC CE, and the at least one field in the MAC CE is used to determine that all RS resources in the first RS resource subgroup are associated with the first PCI.

In one embodiment, the second signaling comprises at least one field in a DCI, and the at least one field in the DCI is used to determine that all RS resources in the first RS resource subgroup are associated with the first PCI.

In one embodiment, the phrase that the first RS resource subgroup comprises at least one RS resource comprises: the first RS resource group comprises one RS resource.

In one embodiment, the phrase that the first RS resource subgroup comprises at least one RS resource comprises: the first RS resource subgroup comprises more than one RS resource.

In one embodiment, the phrase that the first RS resource subgroup comprises at least one RS resource comprises: the first RS resource subgroup comprises one or more than one RS resource.

In one embodiment, the phrase that the first RS resource subgroup comprises at least one RS resource comprises: a number of RS resources in the first RS resource subgroup is configurable.

In one embodiment, the phrase that any RS resource in the first RS resource subgroup belongs to the first RS resource group comprises: the first RS resource group comprises the first RS resource subgroup.

In one embodiment, the phrase that any RS resource in the first RS resource subgroup belongs to the first RS resource group comprises: any RS resource in the first RS resource subgroup is the same as an RS resource in the first RS resource group.

In one embodiment, the phrase that any RS resource in the first RS resource subgroup belongs to the first RS resource group comprises: the first RS resource subgroup is the same as the first RS resource group.

In one embodiment, the phrase that the second signaling is the protocol-layer signaling below the RRC layer comprises: the second signaling is a MAC layer signaling.

In one embodiment, the phrase that the second signaling is the protocol-layer signaling below the RRC layer comprises: the second signaling is a physical-layer signaling.

In one embodiment, the phrase that the second signaling is the protocol-layer signaling below the RRC layer comprises: the second signaling is not an RRC layer signaling.

In one embodiment, the phrase that the second signaling is the protocol-layer signaling below the RRC layer comprises: the second signaling is generated at the protocol layer below the RRC layer.

In one embodiment, the phrase of receiving a second signaling after receiving the first signaling comprises: a time when the first signaling is received is earlier than a time when the second signaling is received.

In one embodiment, the phrase of receiving a second signaling after receiving the first signaling comprises: after receiving the first signaling at the RRC layer, receiving the second signaling.

In one embodiment, the phrase of receiving a second signaling after receiving the first signaling comprises: when the second signaling is received, the first signaling has been successfully received.

In one embodiment, the phrase of receiving a second signaling after receiving the first signaling comprises: when the second signaling is received, the first node has received a configuration comprised in the first signaling.

In one embodiment, the phrase of as a response to the behavior of receiving a second signaling comprises: when the second signaling is received.

In one embodiment, the phrase of as a response to the behavior of receiving a second signaling comprises: if the second signaling is received.

In one embodiment, the phrase of as a response to the behavior of receiving a second signaling comprises: if the MAC entity receives the second signaling.

In one embodiment, the behavior of executing a first action set comprises: executing all actions in the first action set.

In one embodiment, the behavior of executing a first action set comprises: executing at least one action in the first action set.

In one embodiment, the behavior of executing a first action set comprises: executing one action in the first action set.

In one embodiment, the behavior of executing a first action set comprises: executing each action in the first action set.

In one embodiment, the phrase that the first action set comprises resetting count of a first-type indication comprises: the behavior of resetting count of a first-type indication is at least one action in the first action set.

In one embodiment, the phrase that the first action set comprises resetting count of a first-type indication comprises: the first action set comprises one action, and the action is resetting count of the first-type indication.

In one embodiment, the phrase that the first action set comprises resetting count of a first-type indication comprises: the first action set refers to reset count of the first-type indication.

In one embodiment, the phrase that the first action set comprises resetting count of a first-type indication comprises: the first action set refers to reset count of Q1 first-type indication(s), Q1 being a positive integer.

In one subembodiment of the above embodiment, the Q1 first-type indication(s) comprises at least one of beam failure instance indication, or LBT failure indication, or “in-sync” indication, or “out-of-sync” indication, or an RLC SDU or an RLC SDU segment being considered retransmission.

In one subembodiment of the above embodiment, Q1 is equal to 1.

In one subembodiment of the above embodiment, Q1 is greater than 1.

In one subembodiment of the above embodiment, Q1 is not greater than 64.

In one embodiment, the behavior of resetting count of a first-type indication comprises: resetting all counts of the first-type indication.

In one embodiment, the behavior of resetting count of a first-type indication comprises: resetting count of at least one the first-type indication.

In one embodiment, the behavior of resetting count of a first-type indication comprises: resetting count of the first-type indication.

In one embodiment, the behavior of resetting count of a first-type indication comprises: clearing a counter used to count a number of first-type indications to zero.

In one embodiment, the behavior of resetting count of a first-type indication comprises: clearing count of the first-type indication to zero.

In one embodiment, the behavior of resetting count of a first-type indication comprises: setting count of the first-type indication to 0.

In one embodiment, the behavior of resetting count of a first-type indication comprises: setting count of the first-type indication to an initial value.

In one embodiment, the behavior of resetting count of a first-type indication comprises: resetting a counter, and the counter being used to count a count the first-type indication.

In one embodiment, when the behavior of resetting a first-type indication is executed, no RRC message is received for reconfiguring the first value.

In one embodiment, when the behavior of resetting a first-type indication is executed, no RRC message is received for reconfiguring a first RS resource group.

In one embodiment, when the behavior of resetting a first-type indication is executed, no RRC message is received for reconfiguring beamFailureDetectionTimer.

In one embodiment, count of the first-type indication refers to a number of first-type indications.

In one embodiment, count of the first-type indication refers to number of the first-type indication(s).

In one embodiment, a counter is used for a count of the first-type indication.

In one embodiment, BFI_COUNTER is used for a count of the first-type indication.

In one embodiment, N310 is used for a count of the first-type indication.

In one embodiment, N311 is used for a count of the first-type indication.

In one embodiment, RETX_COUNT is used for a count of the first-type indication.

In one embodiment, the first-type indication is transmitted through the first node cross-layer interface.

In one embodiment, the first-type indication is not transmitted through a radio interface.

In one embodiment, the first-type indication is transmitted inside the first node.

In one embodiment, the first-type indication is transmitted from the physical layer of the first node to the higher layer of the first node.

In one subembodiment of the embodiment, the higher layer comprises a MAC layer.

In one subembodiment of the above embodiment, the higher layer comprises an RRC layer.

In one embodiment, the phrase that the first-type indication is related to link failure comprises: a number of first-type indications is related to the link failure.

In one embodiment, the phrase that the first-type indication is related to link failure comprises: a number of first-type indications is used to determine the link failure.

In one embodiment, the phrase that the first-type indication is related to link failure comprises: a number of first-type indications is used to trigger the link failure.

In one embodiment, the phrase that the first-type indication is related to link failure comprises: a number of first-type indications is used to avoid the link failure.

In one embodiment, the phrase that the first-type indication is related to link failure comprises: a number of first-type indications is used to trigger the link failure.

In one embodiment, the more the first-type indications, the more likely it is to trigger the link failure.

In one embodiment, the more the first-type indications, the more likely it is to avoid the link failure.

In one embodiment, the link failure comprises: being related to radio link failure.

In one embodiment, the link failure comprises: being related to beam link failure (BLF).

In one embodiment, the link failure comprises: being related to beam link failure of a TRP.

In one embodiment, the link failure comprises: being related to beam link failure of a cell.

In one embodiment, the first-type indication comprises: beam failure instance indication.

In one embodiment, the first-type indication comprises: LBT failure indication.

In one embodiment, the first-type indication comprises: “in-sync” indication.

In one embodiment, the first-type indication comprises: “out-of-sync” indication.

In one embodiment, the first-type indication comprises: an RLC SDU or an RLC SDU segment is considered a retransmission.

### Embodiment 2

Embodiment 2 illustrates a schematic diagram of a network architecture according to one embodiment of the present application, as shown in FIG. 2. FIG. 2 is a diagram illustrating a network architecture 200 of 5G NR/Long-Term Evolution (LTE)/Long-Term Evolution Advanced (LTE-A) systems. The 5G NR/LTE/LTE-A network architecture 200 may be called a 5G System (5GS)/Evolved Packet System (EPS) 200 or other appropriate terms. The 5GS/EPS 200 comprises at least one of a UE 201, an RAN 202, a 5G Core Network/Evolved Packet Core (5GC/EPC) 210, a Home Subscriber Server (HSS)/Unified Data Management (UDM) 220 or an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The RAN comprises the node 203 and other nodes 204. The node 203 provides UE 201-oriented user plane and control plane protocol terminations. The node 203 may be connected to other nodes 204 via an Xn interface (e. g., backhaul)/X2 interface. The node 203 may be called a base station, a base transceiver station, a radio base station, a radio transceiver, a transceiver function, a Base Service Set (BSS), an Extended Service Set (ES S), a Transmitter Receiver Point (TRP) or some other applicable terms. The node 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The node 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 is a UE.

In one embodiment, the UE 201 is an ender.

In one embodiment, the node 203 corresponds to the second node in the present application.

In one embodiment, the node 203 is a BaseStation (BS).

In one embodiment, the node 203 is a Base Transceiver Station (BTS).

In one embodiment, the node 203 is a NodeB (NB).

In one embodiment, the node 203 is a gNB.

In one embodiment, the node 203 is an eNB.

In one embodiment, the node 203 is an ng-eNB.

In one embodiment, the node 203 is an en-gNB.

In one embodiment, the node 203 is a UE.

In one embodiment, the node 203 is a relay.

In one embodiment, the node 203 is gateway.

In one embodiment, the node 203 comprises at least one TRP.

In one embodiment, the node 204 corresponds to the third node in the present application.

In one embodiment, the node 204 corresponds to the fourth node in the present application.

In one embodiment, the node 204 is a BaseStation (BS).

In one embodiment, the node 204 is a BS.

In one embodiment, the node 204 is a BTS.

In one embodiment, the node 204 is an NB.

In one embodiment, the node 204 is a gNB.

In one embodiment, the node 204 is an eNB.

In one embodiment, the node 204 is an ng-eNB.

In one embodiment, the node 204 is an en-gNB.

In one embodiment, the node 204 is a UE.

In one embodiment, the node 204 is a relay.

In one embodiment, the node 204 is gateway.

In one embodiment, the node 204 comprises at least one TRP.

In one embodiment, the UE supports Terrestrial Network (NTN) transmission.

In one embodiment, the UE supports Non-Terrestrial Network (NTN) transmission.

In one embodiment, the UE supports communications within networks with large latency differences.

In one embodiment, the UE supports Dual Connection (DC) transmission.

In one embodiment, the UE comprises an aircraft.

In one embodiment, the UE comprises a vehicle terminal.

In one embodiment, the UE comprises a vessel.

In one embodiment, the UE comprises an Internet of Things (IoT) terminal.

In one embodiment, the UE comprises an Industrial Internet of Things (IIoT) terminal.

In one embodiment, the UE comprises a device supporting transmission with low-latency and high-reliability.

In one embodiment, the UE comprises test equipment.

In one embodiment, the UE comprises a signaling tester.

In one embodiment, the UE supports NR.

In one embodiment, the UE supports UTRA.

In one embodiment, the UE supports EUTRA.

In one embodiment, the base station supports transmission over a non-terrestrial network.

In one embodiment, the base station supports transmission over networks with large latency differences.

In one embodiment, the base station supports transmission over a terrestrial network.

In one embodiment, the base station comprises a Marco Cellular base station.

In one embodiment, the base station comprises a Micro Cell base station.

In one embodiment, the base station comprises a Pico Cell base station.

In one embodiment, the base station comprises a Femtocell.

In one embodiment, the base station comprises a base station supporting large latency differences.

In one embodiment, the base station comprises flight platform equipment.

In one embodiment, the base station comprises satellite equipment.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, the base station comprises test equipment.

In one embodiment, the base station comprises a signaling tester.

In one embodiment, the base station comprises an Integrated Access and Backhaul (IAB)-node.

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the relay comprises relay.

In one embodiment, the relay comprises an L3 relay.

In one embodiment, the relay comprises an L2 relay.

In one embodiment, the relay comprises a router.

In one embodiment, the relay comprises a switcher.

In one embodiment, the relay comprises a UE.

In one embodiment, the relay comprises a base station.

In one embodiment, at least one of a connection between the UE 201 and the node 203 or a connection between the UE 201 and the node 204 exists.

In one subembodiment of the embodiment, a connection between the UE 201 and the node 203 exists, and a connection between the UE 201 and the node 204 does not exist.

In one subembodiment of the embodiment, a connection between the UE 201 and the node 203 does not exist, and a connection between the UE 201 and the node 204 exists.

In one subembodiment of the embodiment, a connection between the UE 201 and the node 203 exists, and a connection between the UE 201 and the node 204 exists.

### Embodiment 3

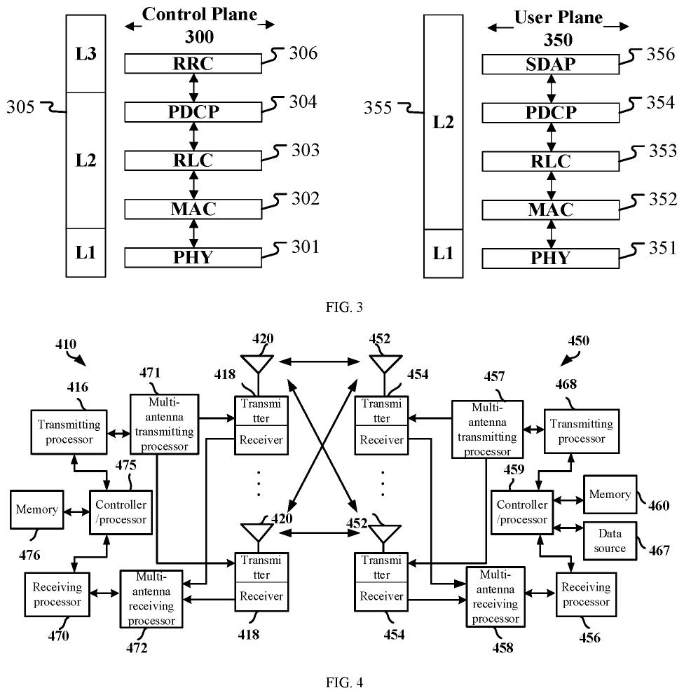

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for the control plane 300 is represented by three layers, which are a layer 1, a layer 2 and a layer 3, respectively. The layer 1 (L1) is the lowest layer and performs signal processing functions of various PHY layers. The L1 is called PHY 301 in the present application. L2 305, above the PHY 301, comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a data packet and provides support for handover. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating various radio resources (i.e., resources block) in a cell. The MAC sublayer 302 is also in charge of HARQ operation. The RRC sublayer 306 in L3 layer of the control plane 300 is responsible for acquiring radio resources (i.e., radio bearer) and configuring the lower layer with an RRC signaling. The radio protocol architecture of the user plane 350 comprises layer 1 (L1) and layer 2 (L2). In the user plane 350, the radio protocol architecture is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic.

In one embodiment, the radio protocol architecture in FIG. 3 is applicable to the first node in the present application.

In one embodiment, the radio protocol architecture in FIG. 3 is applicable to the second node in the present application.

In one embodiment, the radio protocol architecture in FIG. 3 is applicable to the third node in the present application.

In one embodiment, the radio protocol architecture in FIG. 3 is applicable to the fourth node in the present application.

In one embodiment, the first signaling in the present application is generated by the RRC 306.

In one embodiment, the first signaling in the present application is generated by the MAC 302 or the MAC 352.

In one embodiment, the first signaling in the present application is generated by the PHY 301 or the PHY 351.

In one embodiment, the second signaling in the present application is generated by the MAC 302 or the MAC 352.

In one embodiment, the second signaling in the present application is generated by the PHY 301 or the PHY 351.

In one embodiment, the first PDCCH in the present application is generated by the PHY 301 or the PHY 351.

In one embodiment, the second PDCCH in the present application is generated by the PHY 301 or the PHY 351.

In one embodiment, the first uplink grant in the present application is generated by the MAC 302 or the MAC 352.

In one embodiment, the first uplink grant in the present application is generated by the PHY 301 or the PHY 351.

In one embodiment, the second uplink grant in the present application is generated by the MAC 302 or the MAC 352.

In one embodiment, the second uplink grant in the present application is generated by the PHY 301 or the PHY 351.

In one embodiment, the first-type reference signal in the present application is generated by the PHY 301 or the PHY 351.

In one embodiment, the first radio signal in the present application is generated by the MAC 302 or the MAC 352.

In one embodiment, the first radio signal in the present application is generated by the PHY 301 or the PHY 351.

In one embodiment, the second radio signal in the present application is generated by the MAC 302 or the MAC 352.

In one embodiment, the second radio signal in the present application is generated by the PHY 301 or the PHY 351.

### Embodiment 4

Embodiment 4 illustrates a schematic diagram of a first communication device and a second communication device in the present application, as shown in FIG. 4. FIG. 4 is a block diagram of a first communication device 450 in communications with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410 side, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises at least one processor and at least one memory. at least one processor and at least one memory. The at least one memory comprises computer program codes; the at least one memory and the computer program codes are configured to be used in collaboration with the at least one processor, the first communication device 450 at least: receives a first signaling, the first signaling indicates a target identity; monitors a first PDCCH, the first PDCCH is associated with a first downlink RS resource, and the first downlink RS resource is associated with a first PCI; receives a second signaling, the second signaling is used to indicate a second PCI; as a response to the behavior of receiving the second signaling, monitors a second PDCCH and discards monitoring the first PDCCH, the second PDCCH is associated with a second downlink RS resource, and the second downlink RS resource is associated with the second PCI; herein, the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI.

In one embodiment, the first communication device 450 comprises at least one processor and at least one memory. A memory that stores a computer readable instruction program. The computer readable instruction program generates an action when executed by at least one processor. The action includes: receiving a first signaling, the first signaling indicating a target identity; monitoring a first PDCCH, the first PDCCH being associated with a first downlink RS resource, the first downlink RS resource being associated with a first PCI; receiving a second signaling, the second signaling being used to indicate a second PCI; as a response to the behavior of receiving the second signaling, monitoring a second PDCCH and discarding monitoring the first PDCCH, the second PDCCH being associated with a second downlink RS resource, and the second downlink RS resource being associated with the second PCI; herein, the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits a first signaling, the first signaling indicates a target identity; transmits a first PDCCH, the first PDCCH is associated with a first downlink RS resource, and the first downlink RS resource is associated with a first PCI; transmits a second signaling, the second signaling is used to indicate a second PCI; herein, as a response to the second signaling being received, a second PDCCH is monitored and the first PDCCH is discarded to be monitored, the second PDCCH is associated with a second downlink RS resource, and the second downlink RS resource is associated with the second PCI; the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI.

In one embodiment, the second communication device 410 comprises a memory that stores a computer readable instruction program. The computer readable instruction program generates an action when executed by at least one processor. The action includes: transmitting a first signaling, the first signaling indicating a target identity; transmitting a first PDCCH, the first PDCCH being associated with a first downlink RS resource, the first downlink RS resource being associated with a first PCI; transmitting a second signaling, the second signaling being used to indicate a second PCI; herein, as a response to the second signaling being received, a second PDCCH is monitored and the first PDCCH is discarded to be monitored, the second PDCCH is associated with a second downlink RS resource, and the second downlink RS resource is associated with the second PCI; the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI.

In one embodiment, the antenna 452, the receiver 454, the receiving processor 456, and the controller/processor 459 are used to receive a first signaling; at least one of the antenna 420, the transmitter 418, the transmitting processor 416, or the controller/processor 475 is used to transmit the first signaling. In one embodiment, the antenna 452, the receiver 454, the receiving processor 456, and the controller/processor 459 are used to receive a second signaling; at least one of the antenna 420, the transmitter 418, the transmitting processor 416, or the controller/processor 475 is used to transmit a second signaling.

In one embodiment, the antenna 452, the receiver 454, the receiving processor 456, and the controller/processor 459 are used to receive a first uplink grant; at least one of the antenna 420, the transmitter 418, the transmitting processor 416, or the controller/processor 475 is used to transmit a first uplink grant.

In one embodiment, the antenna 452, the receiver 454, the receiving processor 456, and the controller/processor 459 are used to receive a second uplink grant; at least one of the antenna 420, the transmitter 418, the transmitting processor 416, or the controller/processor 475 is used to transmit a second uplink grant.

In one embodiment, the antenna 452, the receiver 454, the receiving processor 456, and the controller/processor 459 are used to receive a first-type reference signal; at least one of the antenna 420, the transmitter 418, the transmitting processor 416, or the controller/processor 475 is used to transmit a first-type reference signal.

In one embodiment, the antenna 452, the receiver 454, the receiving processor 456, and the controller/processor 459 are used to monitor a first PDCCH; at least one of the antenna 420, the transmitter 418, the transmitting processor 416, or the controller/processor 475 is used to transmit a first PDCCH.

In one embodiment, the antenna 452, the receiver 454, the receiving processor 456, and the controller/processor 459 are used to monitor a second PDCCH; at least one of the antenna 420, the transmitter 418, the transmitting processor 416, or the controller/processor 475 is used to transmit a second PDCCH.

In one embodiment, the antenna 452, the transmitter 454, the transmitting processor 468, and the controller/processor 459 are used to transmit a second radio signal; at least one of the antenna 420, the receiver 418, the receiving processor 470, or the controller/processor 475 is used to receive a second radio signal.

In one embodiment, the first communication device 450 corresponds to a first node in the present application.

In one embodiment, the second communication device 410 corresponds to a second node in the present application.

In one embodiment, the second communication device 410 corresponds to a third node in the present application.

In one embodiment, the second communication device 410 corresponds to a fourth node in the present application.

In one embodiment, the first communication device 450 is a UE.

In one embodiment, the first communication device 450 is a UE that supports large delay differences.

In one embodiment, the first communication device 450 is a UE that supports NTN.

In one embodiment, the first communication device 450 is an aircraft device.

In one embodiment, the first communication device 450 has a positioning capability.

In one embodiment, the first communication device 450 does not have a positioning capability.

In one embodiment, the first communication device 450 is a UE that supports TN.

In one embodiment, the second communication device 410 is a base station (gNB/eNBing-eNB).

In one embodiment, the second communication device 410 is a base station that supports large delay differences.

In one embodiment, the second communication device 410 is a base station that supports NTN.

In one embodiment, the second communication device 410 is satellite equipment.

In one embodiment, the second communication device 410 is flying platform equipment.

In one embodiment, the second communication device 410 is a base station that supports TN.

### Embodiment 5A

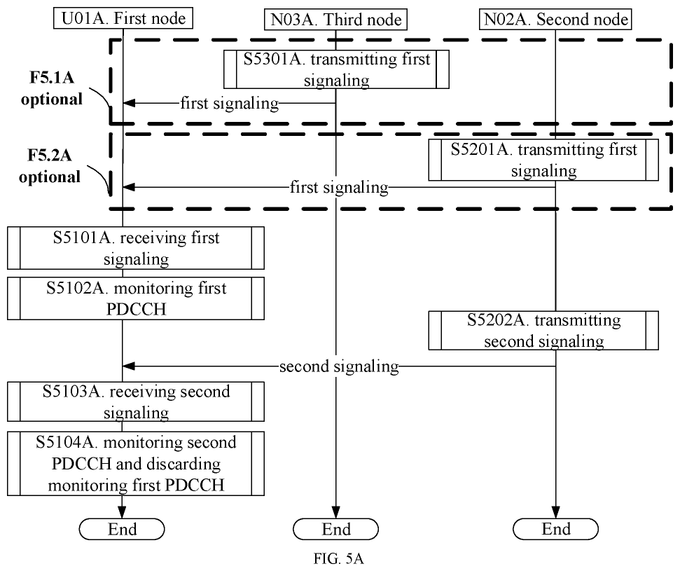

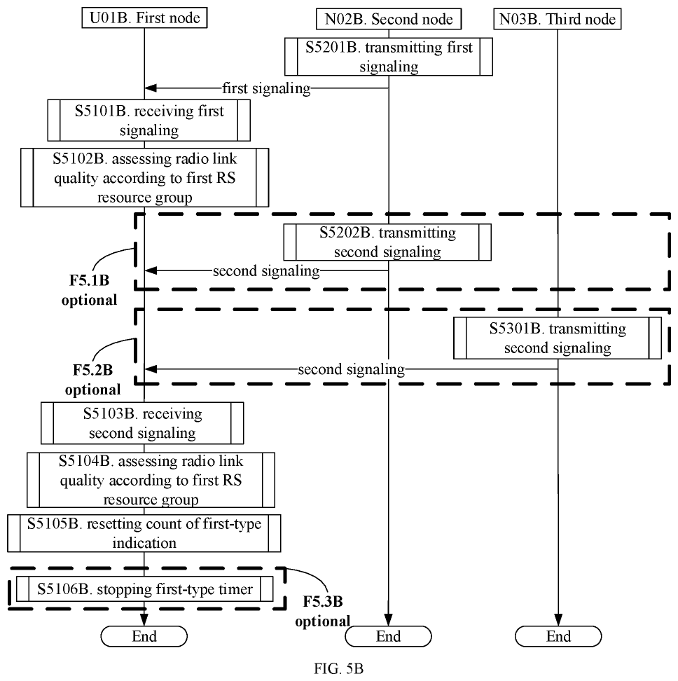

Embodiment 5A illustrates a flowchart of radio signal transmission according to one embodiment in the present application, as shown in FIG. 5. It is particularly underlined that the order illustrated in the embodiment does not put constraints over sequences of signal transmissions and implementations.

The first node U01A receives a first signaling in step S5101A, and the first signaling indicates a target identity; in step S5102A, monitors a first PDCCH, the first PDCCH is associated with a first downlink RS resource, the first downlink RS resource is associated with a first PCI; in step S5103A, receives a second signaling, and the second signaling is used to indicate a second PCI; in step S5104A, as a response to the behavior of receiving the second signaling, monitors a second PDCCH and discards monitoring a first PDCCH, the second PDCCH is associated with a second downlink RS resource, and the second downlink RS resource is associated with the second PCI.

The second node N02A transmits the first signaling in step S5201A; transmits the second signaling in step S5202A.

The third node N03A transmits the first signaling in step S5301A.

In embodiment 5A, the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI.

In one embodiment, the first node U01A is a UE.

In one embodiment, the first node U01A is a terminal.

In one embodiment, the second node N02A comprises a TRP.

In one embodiment, the second node N02A comprises a DU.

In one embodiment, the second node N02A comprises a gNB.

In one embodiment, the second node N02A comprises a base station.

In one embodiment, the second node N02A comprises a UE.

In one embodiment, the third node N03A comprises a TRP.

In one embodiment, the third node N03A comprises a CU.

In one embodiment, the third node N03A comprises a DU.

In one embodiment, the third node N03A comprises a gNB.

In one embodiment, the third node N03A comprises a base station.

In one embodiment, the third node N03A comprises a UE.

In one embodiment, the second node N02A and the third node N03A are respectively a TRP, the second node N02 is associated with the first PCI, and the third node N03A is associated with the second PCI.

In one embodiment, uplink transmission timing of the second node N02A and uplink transmission timing of the third node N03A are the same.

In one embodiment, uplink transmission timing of the second node N02A and uplink transmission timing of the third node N03A are different.

In one embodiment, an ideal backhaul is between the second node N02A and the third node N03A.

In one embodiment, a non-ideal backhaul is between the second node N02A and the third node N03A.

In one embodiment, the second node N02A and the third node N03A belong to a same DU.

In one embodiment, the second node N02A and the third node N03A belong to different DUs.

In one embodiment, the dotted box F5.1A is optional.

In one embodiment, the dotted box F5.1A exists.

In one embodiment, the dotted box F5.1A does not exist.

In one embodiment, the dotted box F5.2A is optional.

In one embodiment, the dotted box F5.2 exists.

In one embodiment, the dotted box F5.2A does not exist.

In one embodiment, the dotted box F5.1A exists, and the dotted box F5.2A does not exist.

In one embodiment, the third node N03A comprises a maintenance base station for a cell before a PCell of the first node U01A switches to the cell identified by the first PCI.

In one embodiment, the third node N03A comprises a maintenance base station for the cell identified by the second PCI.

In one embodiment, the second node N02A comprises a maintenance base station for the cell identified by the first PCI.

In one embodiment, the cell identified by the first PCI comprises the second cell.

In one embodiment, the second node N02A comprises a maintenance base station of the second cell.

In one embodiment, the second node N02A comprises the second TRP.

In one embodiment, the first signaling is used to synchronize the reconfiguration process.

In one embodiment, the first signaling is used for switching configuration.

In one embodiment, the first signaling comprises physical-layer parameters of the first node U01A in the first cell.

In one embodiment, the first signaling comprises a C-RNTI of the first node U01A in the first cell, and the C-RNTI is the target identity.

In one embodiment, the first signaling comprises MAC-layer parameters of the first node U01A in the first cell.

In one embodiment, the first signaling comprises PDCP-layer parameters of the first node U01A in the first cell.

In one embodiment, the first signaling comprises RLC-layer parameters of the first node U01A in the first cell.

In one embodiment, the first signaling comprises the second PCI of the first cell.

In one embodiment, the first signaling comprises a timer T304.

In one embodiment, the first signaling comprises a reconfigurationWithSync field.

In one embodiment, when the first signaling is received, a configuration in the first signaling is applied.

In one embodiment, the phrase that the first signaling indicates a target identity comprises: a value of an identity indicated by the first signaling is applied to the target identity.

In one subembodiment of the embodiment, the identifier comprises newUE-Identity; a value of the identity comprises an RNTI-Value; the target identity comprises a C-RNTI.

In one subembodiment of the embodiment, the first signaling comprises a field in an RRC message, and the name of the field comprises reconfigurationWithSync.

In one subembodiment of the embodiment, the first node U01A applies a value of an identity indicated by the first signaling to the target identity during the process of executing reconfiguration with sync.

In one subembodiment of the embodiment, the phrase of applying a value of an identity indicated by the first signaling as the target identity comprises: applying the value of the newUE-Identity as the C-RNTI for the first cell group

In one embodiment, the dotted box F5.1A does not exist, and the dotted box F5.2A exists.

In one embodiment, the second node N02A comprises a maintenance base station for the cell identified by the first PCI.

In one embodiment, the cell identified by the first PCI is the first cell.

In one embodiment, the second node N02A comprises a maintenance base station of the first cell.

In one embodiment, the second node N02A comprises the first TRP.

In one embodiment, the first signaling comprises an RRCReconfiguration message.

In one embodiment, the first signaling is used to configure a candidate cell.

In one embodiment, the first signaling is used to configure a C-RNTI.

In one embodiment, the first signaling is used to configure a C-RNTI of a cell other than a serving cell of the first node U01A.

In one embodiment, the first signaling comprises physical-layer parameters of the first node U01A in the second cell.

In one embodiment, the first signaling comprises a C-RNTI of the first node U01A in the second cell, and the C-RNTI is the target identity.

In one embodiment, when the first signaling is received, a configuration in the first signaling is not applied, and when the second signaling is received, a configuration in the first signaling is applied.

In one embodiment, the meaning of a maintenance base station of a cell comprises: a radio signal in the cell is transmitted or received by the maintenance base station.

In one embodiment, the meaning of a maintenance base station of a cell comprises: the cell is associated with the maintenance base station.

In one embodiment, the source identity is an identity of the first node U01A in the first cell, and the target identity is an identity of the first node U01A in the second cell.

In one embodiment, the source identity is an identity of the first node U01A in the second cell, and the target identity is an identity of the first node U01A in the first cell.

### Embodiment 5B

Embodiment 5B illustrates a flowchart of radio signal transmission according to one embodiment in the present application, as shown in FIG. 5. It is particularly underlined that the order illustrated in the embodiment does not put constraints over sequences of signal transmissions and implementations.

The first node U01B receives a first signaling in step S101B, the first signaling is used to configure a first RS resource group, the first RS resource group comprises at least one RS resource; and in step S5102B, assesses radio link quality based on the first RS resource group; receives a second signaling after receiving the first signaling in step S5103B; in step S5104B, assesses radio link quality based on the first RS resource group; in step S5105B, as a response to the behavior of receiving the second signaling, resets count of a first-type indication; in step S5106B, as a response to the behavior of receiving a second signaling, stops the first-type timer, and the first-type timer is related to link failure.

The second node N02B transmits the first signaling in step S5201B; transmits the second signaling in step S5202B.

The third node N03B transmits the second signaling in step S5301B.

In embodiment 5B, the first signaling is an RRC layer signaling, and the second signaling is a protocol-layer signaling below the RRC layer; the second signaling is used to indicate that all RS resources in a first RS resource subgroup are associated with a first PCI, the first RS resource subgroup comprises at least one RS resource, and any RS resource in the first RS resource subgroup belongs to the first RS resource group; the first-type indication is related to link failure; the first action set comprises stopping a first-type timer, and the first-type timer is related to link failure.

In one embodiment, the second node N02B is a maintenance base station of a serving cell of the first node N01B.

In one embodiment, the second node N02B and the third node N03B are two different TRPs.

In one embodiment, the second node N02B and the third node N03B belong to two different base stations.

In one embodiment, the second node N02B and the third node N03B belong to a same base station.

In one embodiment, the second node N02B and the third node N03B are two different UEs.

In one embodiment, the first node U01B receives a BCCH through the second node N02B.

In one embodiment, the first node U01B receives an SIB through the second node N02B.

In one embodiment, the first node U01B receives a BCCH not through the third node N03B.

In one embodiment, the first node U01B receives an SIB not through the third node N03B.

In one embodiment, the dotted box F5.1B is optional.

In one embodiment, the dotted box F5.2B is optional.

In one embodiment, one of the dotted boxes F5.1B and F5.2B exists.

In one embodiment, the dotted box F5.1B exists.

In one subembodiment of the embodiment, the third node N03B is a maintenance base station of a cell identified by the first PCI; the second node N02B is a maintenance base station of a cell identified by the second PCI.

In one embodiment, the dotted box F5. 2B exists.

In one subembodiment of the embodiment, the second node N02B is a maintenance base station of a cell identified by the first PCI; the third node N03B is a maintenance base station of a cell identified by the second PCI.

In one embodiment, the phrase that the first action set comprises stopping a first-type timer comprises: the behavior of stopping a first-type timer is at least one action in the first action set.

In one embodiment, the phrase that the first action set comprises stopping a first-type timer comprises: the first action set comprises an action, and the action is stopping a first-type timer.

In one embodiment, within a time interval between the behavior of receiving the second signaling and the behavior of stopping a first-type timer, no RRC message is received for reconfiguring the first-type timer.

In one embodiment, as a response to the behavior of receiving second signaling, execute a first action set, the first action set comprises resetting count of a first-type indication.

In one subembodiment of the embodiment, as a response to the behavior of receiving the second signaling, count of a first-type indication is reset.

In one embodiment, as a response to the behavior of receiving second signaling, execute a first action set, the first action set comprises resetting count of a first-type indication, and the first action set comprises stopping a first-type timer.

In one subembodiment of the embodiment, as a response to the behavior of receiving the second signaling, count of a first-type indication is reset.

In one subembodiment of the embodiment, as a response to the behavior of receiving the second signaling, count of a first-type indication is reset and a first-type timer is stopped.

In one subembodiment of the embodiment, as a response to the behavior of receiving the second signaling, a first-type timer is stopped.

In one embodiment, as a response to the behavior of receiving second signaling, execute a first action set, the first action set comprises stopping a first-type timer.

In one subembodiment of the embodiment, as a response to the behavior of receiving the second signaling, a first-type timer is stopped.

In one embodiment, when the first notification in the present application is received and if the first-type timer is running, the first-type timer is stopped.

In one embodiment, when the second signaling in the present application is received and if the first-type timer is running, the first-type timer is stopped.

In one embodiment, when the first notification in the present application is received and if the first-type timer is not running, the behavior of stopping the first-type timer is skipped.

In one embodiment, when the second signaling in the present application is received and if the first-type timer is not running, the behavior of stopping the first-type timer is skipped.

In one embodiment, the first-type timer does not comprise T300.

In one embodiment, the first-type timer does not comprise T301.

In one embodiment, the first-type timer does not comprise T302.

In one embodiment, the first-type timer does not comprise T311.

In one embodiment, the first-type timer does not comprise T319.

In one embodiment, the phrase that the first-type timer is related to link failure comprises: the first-type timer is related to the link failure.

In one embodiment, the phrase that the first-type timer is related to link failure comprises: the first-type timer is used to determine the link failure.

In one embodiment, the phrase that the first-type timer is related to link failure comprises: the first-type timer is used to trigger the link failure.

In one embodiment, the phrase that the first-type timer is related to link failure comprises: the first-type timer is used to avoid the link failure.

In one embodiment, the first-type timer comprises a T310.

In one embodiment, the first-type timer comprises a T312.

In one embodiment, the first-type timer comprises t-PollRetransmit.

In one embodiment, the first-type timer comprises beamFailureDetectionTimer.

In one embodiment, the meaning of stopping a timer comprises: the timer does not continue to run.

In one embodiment, the meaning of stopping a timer comprises: timing of the timer is cleared to zero.

In one embodiment, the meaning of stopping a timer comprises: not increasing timing of the timer.

In one embodiment, the meaning of stopping comprises: stop.

In one embodiment, the meaning of stopping comprises: suspend.

In one embodiment, timers and counters involved in the present application are for a same cell group.

In one embodiment, timers and counters involved in the present application only relate to one of a cell group MCG or SCG.

In one embodiment, as a response to the behavior of receiving a second signaling, execute: at least one of resetting count of the first indication in the present application, or resetting count of the second indication in the present application, or resetting count of the third indication in the present application.

In one embodiment, as a response to the behavior of receiving a second signaling, execute: at least one of stopping the first timer in the present application, or stopping the second timer in the present application, or stopping the third timer in the present application

In one embodiment, as a response to the behavior of receiving a second signaling, execute: at least one of resetting count of the first indication in the present application, or resetting count of the second indication in the present application, or resetting count of the third indication in the present application, or stopping the first timer in the present application, or stopping the second timer in the present application, or stopping the third timer in the present application.

### Embodiment 6A

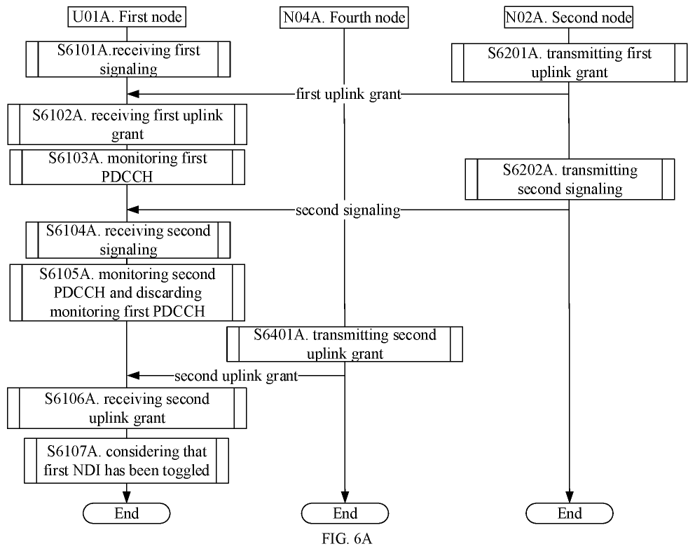

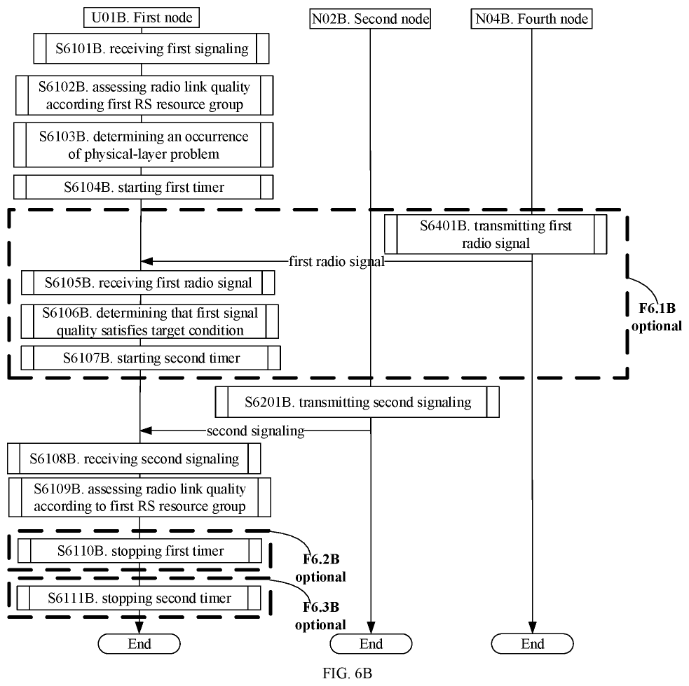

Embodiment 6A illustrates a flowchart of radio signal transmission according to another embodiment of the present application, as shown in FIG. 6A. It is particularly underlined that the order illustrated in the embodiment does not put constraints over sequences of signal transmissions and implementations.

The first node U01A receives a first signaling in step S6101A, and the first signaling indicates a target identity; receives a first uplink grant in step S6102A, the first uplink grant is associated with the source identity; in step S6103A, monitors a first PDCCH, the first PDCCH is associated with a first downlink RS resource, the first downlink RS resource is associated with a first PCI; in step S6104A, receives a second signaling, and the second signaling is used to indicate a second PCI; in step S6105A, as a response to the behavior of receiving the second signaling, monitors a second PDCCH and discards monitoring a first PDCCH, the second PDCCH is associated with a second downlink RS resource, and the second downlink RS resource is associated with the second PCI; in step S6106A, receives a second uplink grant, and the second uplink grant is associated with the target identity; in step S6107A, as a response to the behavior of receiving a first uplink grant and a second uplink grant, considers that a first NDI has been toggled.

The second node N02A transmits the first uplink grant in step S6201A; and transmits the second signaling in step S6202A.

The fourth node N04A transmits the second uplink grant in step S6401A.

In embodiment 6A, the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI; the first uplink grant and the second uplink grant are associated with a same HARQ process; a time for receiving the first uplink grant is earlier than a time for receiving the second uplink grant.

In one embodiment, the first PDCCH indicates scheduling information of the first uplink grant; the scheduling information comprises at least one of time-domain location, frequency-domain location, MCS, RV, NDI, or HARQ process number.

In one embodiment, the second PDCCH indicates scheduling information of the second uplink grant; the scheduling information comprises at least one of time-domain location, frequency-domain location, MCS, RV, NDI, or HARQ process number.

In one embodiment, there does not exist an Xn connection between the second node N02A and the fourth node N04A.

In one embodiment, there exists an Xn connection between the second node N02A and the fourth node N04A.

In one embodiment, an ideal backhaul is between the second node N02A and the fourth node N04A.

In one embodiment, a non-ideal backhaul is between the second node N02A and the fourth node N04A.

In one embodiment, the second node N02A and the fourth node N04A belong to a same physical cell.

In one embodiment, the second node N02A and the fourth node N04A belong to different physical cells.

In one embodiment, the second node N02A and the fourth node N04A have a same physical cell identity (PCI).

In one embodiment, the second node N02A and the fourth node N04A have different physical cell identities.

In one embodiment, the second node N02A and the fourth node N04A belong to two different stations.

In one embodiment, the first uplink grant comprises an UL grant.

In one embodiment, the first uplink grant is received at a PDCCH.

In one embodiment, the first uplink grant is a UL grant transmitted to the source identity.

In one embodiment, the first uplink grant is received on the first PDCCH.

In one embodiment, the first uplink grant is received on a PDCCH for the source identity.

In one embodiment, the second uplink grant comprises a UL grant.

In one embodiment, the second uplink grant is received at a PDCCH.

In one embodiment, the second uplink grant is a UL grant transmitted to the target identity.

In one embodiment, the second uplink grant is received on the second PDCCH.

In one embodiment, the second uplink grant is received on a PDCCH for the target identity.

In one embodiment, the phrase that the first uplink grant is associated with the source identity comprises: the first uplink grant is received on a PDCCH for the source identity.

In one embodiment, the phrase that the first uplink grant is associated with the source identity comprises: the first UL grant is for the source identity.

In one embodiment, the phrase that the second uplink grant is associated with the target identity comprises: the second uplink grant is received on a PDCCH for the target identity.

In one embodiment, the phrase that the second uplink grant is associated with the target identity comprises: the second uplink grant is given to the target identity.

In one embodiment, the phrase of as a response to the behavior of receiving a first uplink grant and a second uplink comprises: if the first uplink grant is received, and the second uplink grant is received.

In one embodiment, the phrase of as a response to the behavior of receiving a first uplink grant and a second uplink comprises: when the second uplink grant is received, and if the first uplink grant was previously received.

In one embodiment, the meaning of the behavior of “as a response to the behavior of receiving a first uplink grant and a second uplink grant, considering that a first NDI has been toggled” comprises: regardless of whether a value of the first NDI provided in HARQ information associated with the first uplink grant is different from a value of the first NDI provided in HARQ information associated with the second uplink grant, considering that the first NDI has been toggled.

In one embodiment, the meaning of the behavior of “as a response to the behavior of receiving a first uplink grant and a second uplink grant, considering that a first NDI has been toggled” comprises: as a response to the behavior of receiving a first uplink grant and a second uplink grant, considering that the second uplink grant is used for transmitting new data.

In one embodiment, the behavior of considering that a first NDI has been toggled comprises: considering that a value of the first NDI has changed.

In one embodiment, the behavior of considering that a first NDI has been toggled comprises: considering the first NDI to have been toggled.

In one embodiment, for a same HARQ process, if values of the first NDIs provided in HARQ information associated with two immediately closing UL grants are different, a latter UL grant is used to transmit new data.

In one embodiment, for a same HARQ process, if values of the first NDIs provided in HARQ information associated with two immediately closing UL grants are the same, a latter UL grant is used for a retransmission.

In one embodiment, the first NDI is an NDI.

In one embodiment, the first NDI comprises one bit.

In one embodiment, a value of the first NDI is equal to 0 or 1.

In one embodiment, the first NDI is received in HARQ information.

In one embodiment, the first NDI is received in DCI.

In one embodiment, the first NDI is HARQ-process dedicated.

In one embodiment, the first receiver receives a DCI, the DCI comprises the first uplink grant and first HARQ information, the first uplink grant is associated with a HARQ process, the HARQ process is identified by a target integer, the first HARQ information comprises the first NDI, and the first NDI is set to a first value; receives another DCI, the another DCI comprises the second uplink grant and the second HARQ information, the second uplink grant is associated with a HARQ process, the HARQ process is identified by the target integer, the second HARQ information comprises the first NDI, and the first NDI is set as a second value; herein, the DCI is associated with the first PDCCH; the another DCI is associated with the second PDCCH; the target integer is a non-negative integer.

In one subembodiment of the embodiment, the target integer is not less than 0 and not greater than 15.

In one subembodiment of the embodiment, the target integer is not less than 0 and not greater than 31.

In one subembodiment of the embodiment, the target integer is a HARQ process identity.

In one embodiment, within a time interval between a reception time of the first uplink grant and a reception time of the second uplink grant, a MAC entity is not reset.

In one embodiment, within a time interval between a reception time of the first uplink grant and a reception time of the second uplink grant, no other UL grant is received.

In one embodiment, within a time interval between a reception time of the first uplink grant and a reception time of the second uplink grant, no other UL grant is received through a PDCCH.

In one embodiment, the phrase that the first uplink grant and the second uplink grant are associated with a same HARQ process comprises: the first uplink grant and the second uplink grant have a same HARQ process ID.

In one embodiment, the phrase that the first uplink grant and the second uplink grant are associated with a same HARQ process comprises: the first uplink grant and the second uplink grant belong to a same HARQ process.

In one embodiment, a HARQ process associated with the first uplink grant is identified by the target integer, and a HARQ process associated with the second uplink grant is identified by the target integer.

In one embodiment, the second uplink grant is a UL grant after the first uplink grant.

In one embodiment, the behavior of “as a response to the behavior of receiving a second uplink grant, considering that a first NDI has been toggled” comprises: if the second uplink grant for the Serving Cell has been received on the PDCCH for the MAC entity's target identity, if the second uplink grant received for the MAC entity's second identity, and if the previous uplink grant delivered to the HARQ entity for the same HARQ process was an uplink grant received for the MAC entity's first identity, considering the NDI to have been toggled for the corresponding HARQ process regardless of the value of the NDI.

In one submebodiment of the embodiment, for section 5.4.1 of TS 38.321, proceed as follows:
if an uplink grant for this Serving Cell has been received on the PDCCH for the MAC entity's source identity or Temporary C-RNTI or the target identity; or
if an uplink grant has been received in a Random Access Response:
if the uplink grant is for MAC entity's C-RNTI and if the previous uplink grant delivered to the HARQ entity for the same HARQ process was either an uplink grant received for the MAC entity's CS-RNTI or a configured uplink grant, or,
if the uplink grant received for the MAC entity's target identity and if the previous uplink grant delivered to the HARQ entity for the same HARQ process was an uplink grant received for the MAC entity's source identity, or,
consider the NDI to have been toggled for the corresponding HARQ process regardless of the value of the NDI.

In one subsidiary embodiment of the subembodiment, at least one of the source identity or the target identity is a C-RNTI of the first node U01A in a serving cell.

In one subsidiary embodiment of the subembodiment, the source identity is a C-RNTI.

In one subordinate embodiment of the subsidiary subembodiment, the target identity is a C-RNTI of the first node U01A in the second cell.

In one subsidiary embodiment of the subembodiment, the target identity is a C-RNTI.

In one subordinate embodiment of the subsidiary subembodiment, the source identity is a C-RNTI of the first node U01A in the second cell.

### Embodiment 6B

Embodiment 6B illustrates a flowchart of radio signal transmission according to another embodiment of the present application, as shown in FIG. 6B. It is particularly underlined that the order illustrated in the embodiment does not put constraints over sequences of signal transmissions and implementations.

The first node U01B receives a first signaling in step 6101B, the first signaling is used to configure a first RS resource group, the first RS resource group comprises at least one RS resource; and in step S6102B, assesses radio link quality based on the first RS resource group; in step S6103B, determines an occurrence of the physical-layer problem; in step S6104B, as a response to the behavior of determining an occurrence of a physical-layer problem, starts a first timer; in step S6105B, receives a first radio signal, the first radio signal is used to determine first signal quality; in step S6106B, determines that first signal quality meets a target condition; in step S6107B, during a running period of the first timer, as a response to the behavior of determining that first signal quality meets a target condition, starts a second timer; in step S6108B, receives a second signaling after receiving the first signaling; in step S6109B, assesses radio link quality based on the first RS resource group; in step S6110B, as a response to the behavior of receiving a second signaling, stops a first timer; in step S6111B, as a response to the behavior of receiving a second signaling, stops a second timer.

The second node N02B in step S6201B, transmits the second signaling.

The fourth node N04B in step S6401B, transmits the first radio signal.

In embodiment 6B, the first signaling is an RRC layer signaling, and the second signaling is a protocol-layer signaling below the RRC layer; the second signaling is used to indicate that all RS resources in a first RS resource subgroup are associated with a first PCI, the first RS resource subgroup comprises at least one RS resource, and any RS resource in the first RS resource subgroup belongs to the first RS resource group; the first-type indication is related to link failure; the first action set comprises stopping a first-type timer, and the first-type timer is related to link failure; the first timer is maintained at the RRC layer; the first-type timer comprises the first timer; the target condition comprises a measurement report triggering event; the first-type timer comprises the second timer.

In one embodiment, the fourth node N04B is a maintenance base station for a neighboring cell.

In one embodiment, the fourth node N04B is a maintenance base station for a target cell.

In one embodiment, the fourth node N04B is a maintenance base station for a target cell satisfying the target condition.

In one embodiment, the fourth node N04B is the same as the second node N02B.

In one embodiment, the fourth node N04B is different from the second node N02B.

In one embodiment, the dotted box F6.1B is optional.

In one embodiment, the dotted box F6.1B exists.

In one embodiment, the dotted box F6.1B does not exist.

In one embodiment, the dotted box F6.2B is optional.

In one embodiment, the dotted box F6.3B is optional.

In one embodiment, at least one of the dotted boxes F6.2B or F6.3B exists.

In one embodiment, when the dotted F6.3B exists, the dotted box F6.1B exists.

In one embodiment, when the dotted box F6.3B does not exist, the dotted box F6.1B exists and or does not exist.

In one embodiment, after the step S6104B and before the step S6110B, the first timer continues running.

In one embodiment, after the step S6104B and before the step S6110B, the first timer is not stopped.

In one embodiment, after the step S6104B and before the step S6110B, timing of the first timer does not reach an expiration value of the first timer.

In one embodiment, after the step S6107B and before the step S7111B, the second timer continues running.

In one embodiment, after the step S6107B and before the step S7111B, the second timer is not stopped.

In one embodiment, after the step S6107B and before the step S7111B, timing of the second timer does not reach an expiration value of the second timer.

In one embodiment, in the step S6102B, the first RS resource group is associated with a cell identified by the second PCI; in the step S6108B, the first RS resource group is associated with a cell identified by the first PCI.

In one embodiment, in the step S6102B, the first RS resource group is associated with a cell identified by the second PCI and a cell identified by the first PCI; in the step S6108B, the first RS resource group is associated with a cell identified by the first PCI.

In one embodiment, the first timer is associated with a Master Cell Group (MCG).

In one embodiment, the first timer is associated with a PCell.

In one embodiment, the first timer is associated with a Secondary Cell Group (SCG).

In one embodiment, the first timer is associated with a PSCell.

In one embodiment, as a response to the behavior of determining an occurrence of the physical-layer problem comprises: when N310 continuous “out of sync” indications are received and T300, T301, T304, T311, T316, and T319 are not running.

In one embodiment, as a response to the behavior of determining an occurrence of the physical-layer problem comprises: when it is determined that a physical-layer problem occurs.

In one embodiment, the behavior of determining an occurrence of the physical-layer problem comprises: confirming that the physical-layer problem has occurred in the SpCell.

In one embodiment, the behavior of determining an occurrence of the physical-layer problem comprises: detecting the physical-layer problem.

In one embodiment, the behavior of determining an occurrence of physical-layer problem comprises: receiving N310 out-of-sync indications and T300, T301, T304, T311, T316, and T319 are not running.

In one embodiment, the behavior of determining an occurrence of the physical-layer problem comprises: receiving a first integer number of the first indication(s) and T300, T301, T304, T311, T316, and T319 are not running

In one subembodiment of the embodiment, the first integer is N310.

In one subembodiment of the embodiment, the first integer is configurable.

In one subembodiment of the above embodiment, the first integer is configured through an RRC message.

In one subembodiment of the above embodiment, the first indication is an out-of-sync indication.

In one embodiment, the phrase that the first timer is maintained at the RRC layer comprises: the first timer is an RRC layer timer.

In one embodiment, the phrase that the first timer is maintained at the RRC layer comprises: the first timer runs at the RRC layer.

In one embodiment, the phrase that the first-type timer comprises the first timer comprises: the first timer is the first-type timer.

In one embodiment, the phrase that the first-type timer comprises the first timer comprises: the first timer belongs to the first-type timer.

In one embodiment, the first radio signal comprises at least one reference signal.

In one embodiment, the first radio signal comprises at least one physical-layer signal.

In one embodiment, the first radio signal comprises at least one SSB.

In one embodiment, the first radio signal comprises at least one CSI-RS.

In one embodiment, the phrase that the first radio signal is used to determine first signal quality comprises: determining the first signal quality based on the first radio signal.

In one embodiment, the phrase that the first radio signal is used to determine first signal quality comprises: a measurement for the first radio signal is used to determine the first signal quality.

In one embodiment, the phrase that the first radio signal is used to determine first signal quality comprises: a measurement result of the first radio signal are subjected to Layer 3 filtering to obtain the first signal quality.

In one embodiment, the first signal quality refers to a measurement result.

In one embodiment, the first signal quality is a measurement result for a neighboring cell.

In one embodiment, the first signal quality comprises an RSRP measurement result, and the unit for measurement of the first signal quality is dBm.

In one embodiment, the first signal quality comprises an RSRQ measurement result, and the unit for measurement of the first signal quality is dB.

In one embodiment, the first signal quality comprises an RS-SINR measurement result, and the unit for measurement of the first signal quality is dB.

In one embodiment, reportType of the first node U01B is configured as eventTriggered.

In one embodiment, the second timer is configured.

In one embodiment, in reportConfiguration, use T312 is configured as true.

In one embodiment, the measurement report triggering event comprises an entering condition of Event A3 in Section 5.5.4.4 of 3GPP TS 38.331; herein, the first signal quality corresponds to Mn in inequality A3-1.

In one embodiment, the measurement report triggering event comprises an entering condition for Event A4 in Section 5.5.4.5 of 3GPP TS 38.331; herein, the first signal quality corresponds to Mn in inequality A4-1.

In one embodiment, the measurement report triggering event comprises an entering condition for Event A5 in Section 5.5.4.6 of 3GPP TS 38.331; herein, the first signal quality corresponds to Mn in inequality A5-2.

In one embodiment, the behavior of determining that first signal quality satisfies a target condition comprises: determining that the first signal quality meets the measurement report triggering event.

In one embodiment, the behavior of determining that first signal quality satisfies a target condition comprises: determining that the measurement report triggering event is satisfied based on at least the first signal quality.

In one embodiment, the behavior of determining that first signal quality satisfies a target condition comprises: determining that a measurement report is triggered.

In one embodiment, during a running period of the first timer, as a response to the behavior of determining that first signal quality meets a target condition and the second timer is not running, the second timer is activated.

In one embodiment, during a running period of the first timer, as a response to the behavior of determining that first signal quality meets a target condition and the second timer is running, the second timer is not activated.

In one embodiment, during a running period of the first timer, as a response to the behavior of determining that first signal quality meets a target condition, a second timer is started; herein, when the first signal quality being determined satisfies a target condition, the second timer is not running.

In one embodiment, the phrase of when the first timer is running comprises: if the first timer is running.

In one embodiment, the phrase of when the first timer is running comprises: when the first timer is running.

In one embodiment, when the first notification is received and if the first timer is running, the first timer is stopped.

In one embodiment, when the second signaling is received and if the first timer is running, the first timer is stopped.

In one embodiment, the phrase of as a response to the behavior of determining that first signal quality satisfies a target condition comprises: when it is determined that the first signal quality meets a target condition.

In one embodiment, the phrase of as a response to the behavior of determining that first signal quality satisfies a target condition comprises: if the first signal quality satisfies a target condition.

In one embodiment, the phrase of as a response to the behavior of determining that first signal quality satisfies a target condition comprises: when a measurement report is triggered.

In one embodiment, the phrase that the first-type timer comprises the second timer comprises: the second timer is the first-type timer.

In one embodiment, the phrase that the first-type timer comprises the second timer comprises: the second timer belongs to the first-type timer.

In one embodiment, when the first notification is received and if the second timer is running, the second timer is stopped.

In one embodiment, when the second signaling is received and if the second timer is running, the second timer is stopped.

In one embodiment, the second timer is T312.

In one embodiment, the second timer is T316.

In one embodiment, if the second timer is configured for a cell group and the second timer is configured for a measurement identity, and the second timer is enabled and the first timer is running, the second timer is started.

In one embodiment, replace the second node N02B in embodiment 6 with the third node N03B to solve the same technical problem to achieve the same technical effect.

### Embodiment 7A

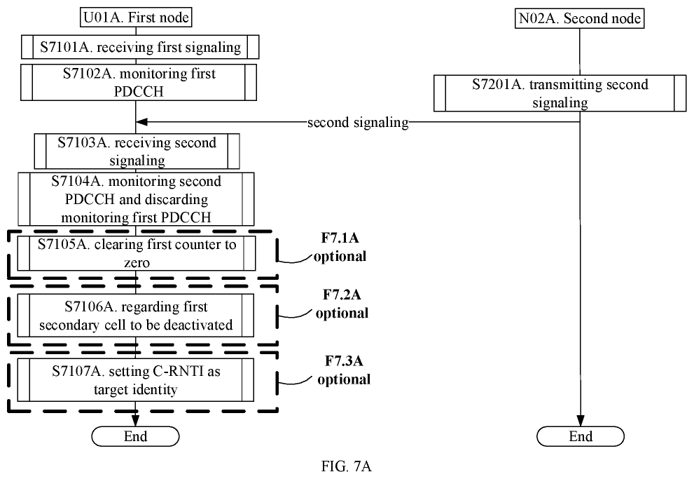

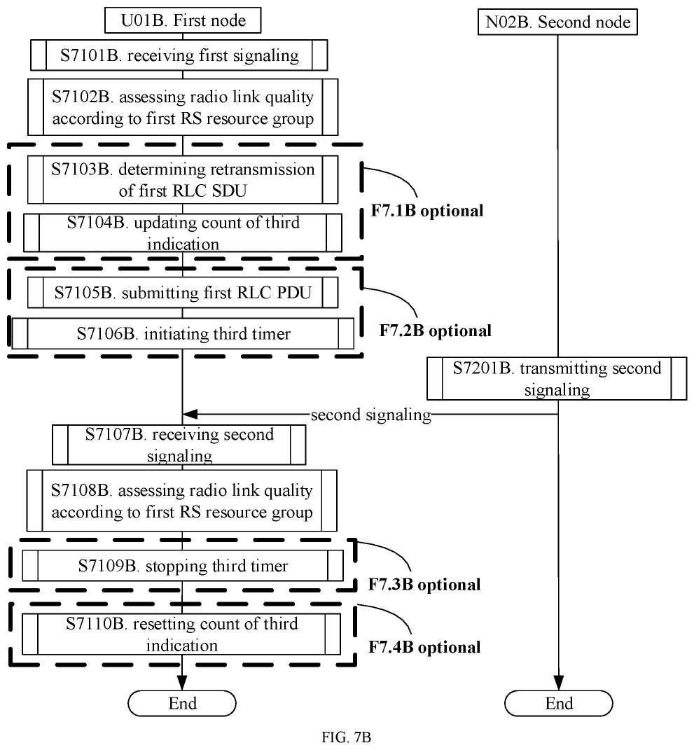

Embodiment 7A illustrates a flowchart of radio signal transmission according to another embodiment in the present application, as shown in FIG. 7A. It is particularly underlined that the order illustrated in the embodiment does not put constraints over sequences of signal transmissions and implementations.

The first node U01A receives a first signaling in step S7101A, and the first signaling indicates a target identity; in step S7102A, monitors a first PDCCH, the first PDCCH is associated with a first downlink RS resource, the first downlink RS resource is associated with a first PCI; in step S7103A, receives a second signaling, and the second signaling is used to indicate a second PCI; in step S7104A, as a response to the behavior of receiving the second signaling, monitors a second PDCCH and discards monitoring a first PDCCH, the second PDCCH is associated with a second downlink RS resource, and the second downlink RS resource is associated with the second PCI; in step S7105A, as a response to the behavior of receiving a second signaling, clears a first counter to zero; in step S7106A, as a response to the behavior of receiving a second signaling, treats a first secondary cell to be in deactivated state; in step S7107A, as a response to the behavior of receiving a second signaling, sets a C-RNTI as a target identity.

The second node N02 transmits the second signaling in step S7201A.

In embodiment 7A, the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI; the first counter is maintained at the MAC layer; the first secondary cell and a cell identified by the first PCI belong to a same cell group.

In one embodiment, the behavior of receiving a second signaling triggers clearing a first counter to zero.

In one embodiment, the behavior of receiving a second signaling triggers the behavior of treating a first secondary cell to be in deactivated state.

In one embodiment, the behavior of receiving a second signaling triggers the behavior of setting a C-RNTI as a target identity.

In one embodiment, the behavior of receiving a second signaling triggers at least one of the behavior of monitoring a second PDCCH and discards monitoring a first PDCCH, or the behavior of clearing the first counter to zero, or the behavior of treating the first secondary cell to be in deactivated state, or the behavior of setting a C-RNTI to a target identity.

In one embodiment, a first receiver receives a first signaling, and the first signaling indicates a target identity; monitors a first PDCCH, the first PDCCH is associated with a first downlink RS resource, the first downlink RS resource is associated with a first PCI; receives a second signaling, the second signaling is used to indicate a second PCI; as a response to the behavior of receiving the second signaling, treats the first secondary cell to be in deactivated state, monitors a second PDCCH and discards monitoring the first PDCCH, the second PDCCH is associated with a second downlink RS resource, and the second downlink RS resource is associated with the second PCI; herein, the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI; the first secondary cell and a cell identified by the first PCI belong to a same cell group.

In one embodiment, the first secondary cell is an SCell.

In one embodiment, the first secondary cell is an SCell in an MCG.

In one embodiment, the first secondary cell is an SCell in an SCG.

In one embodiment, the first secondary cell is any SCell in an MCG.

In one embodiment, the first secondary cell is any SCell in an SCG.

In one embodiment, the phrase of treating a first secondary cell as deactivated comprises: if the first secondary cell is in activated state, converting the first secondary cell to the deactivated state.

In one embodiment, the phrase of treating a first secondary cell as deactivated comprises: if the first secondary cell is in deactivated state, maintaining the first secondary cell in the deactivated state.

In one embodiment, the phrase of treating a first secondary cell as deactivated comprises: regardless of whether the first secondary cell is in a deactivated state or not, the first secondary cell executes the behavior of deactivation.

In one embodiment, the phrase of treating a first secondary cell as deactivated comprises at least one of the following behaviors:
stopping sCellDeactivationTimer associated with the first secondary cell.
stopping bwp-InactivityTimer associated with the first secondary cell.
deactivating any active BWP associated with the first secondary cell.
deleting the configured downlink assignment and configured uplink grant type 2 associated with the first secondary cell.
deleting PUSCH resources of a semi-continuous CSI reporting associated with the first secondary cell.
suspending configured uplink grant Type 1 associated with the first secondary cell.
refreshing all HARQ buffers associated with the first secondary cell.
if there is continuous LBT failure triggered for the first secondary cell, canceling continuous LBT failure triggered for the first secondary cell.

In one embodiment, the phrase of treating a first secondary cell as deactivated comprises: not transmitting an SRS on the first secondary cell.

In one embodiment, the phrase of treating a first secondary cell as deactivated comprises: not reporting a CSI on the first secondary cell.

In one embodiment, the phrase of treating a first secondary cell as deactivated comprises: not transmitting on a UL-SCH on the first secondary cell.

In one embodiment, the phrase of treating a first secondary cell as deactivated comprises: not transmitting on an RACH on the first secondary cell.

In one embodiment, the phrase of treating a first secondary cell as deactivated comprises: not monitoring a PDCCH on the first secondary cell.

In one embodiment, the phrase of treating a first secondary cell as deactivated comprises: not monitoring a PDCCH for the first secondary cell.

In one embodiment, the phrase of treating a first secondary cell as deactivated comprises: not transmitting a PUCCH on the first secondary cell.

In one embodiment, the first secondary cell comprises an SCell.

In one embodiment, the same cell group is an MCG.

In one embodiment, the same cell group is an SCG.

In one embodiment, the phrase that the first secondary cell and a cell identified by the first PCI identity belong to a same cell group comprises: the first secondary cell and the cell identified by the first PCI are two cells in the same cell group.

In one embodiment, the phrase that the first secondary cell and a cell identified by the first PCI identity belong to a same cell group comprises: the first secondary cell and the cell identified by the first PCI are configured with same cellGroupId.

In one embodiment, the cell identified by the first PCI is a PCell of an MCG, and the first secondary cell is an SCell of the MCG.

In one embodiment, the cell identified by the first PCI is a PSCell of an SCG, and the first secondary cell is an SCell of the SCG.

In one embodiment, the first secondary cell and a cell identified by the second PCI belong to different TAGs.

In one embodiment, the first secondary cell and a cell identified by the second PCI belong to a same TAG.

In one embodiment, a first receiver receives a first signaling, and the first signaling indicates a target identity; monitors a first PDCCH, the first PDCCH is associated with a first downlink RS resource, the first downlink RS resource is associated with a first PCI; receives a second signaling, the second signaling is used to indicate a second PCI; as a response to the behavior of receiving the second signaling, sets the C-RNTI as a value of the target identity, monitors a second PDCCH and discards monitoring the first PDCCH, the second PDCCH is associated with a second downlink RS resource, and the second downlink RS resource is associated with the second PCI; herein, the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI.

In one embodiment, the behavior of setting a C-RNTI as the target identity comprises: the C-RNTI being set as a value of the target identity.

In one embodiment, the behavior of setting a C-RNTI as the target identity comprises: setting the C-RNTI as a value of the target identity.

In one embodiment, the behavior of setting a C-RNTI as the target identity comprises: modifying a C-RNTI from the source ID to the target ID at the MAC layer.

In one embodiment, the behavior of setting a C-RNTI as the target identity comprises: modifying a C-RNTI from the source ID to the target ID at the PHY layer.

In one embodiment, set a C-RNTI as the target identity at the MAC layer.

In one embodiment, set a C-RNTI as the target identity at the PHY layer.

In one embodiment, the C-RNTI is a C-RNTI of the first node U01A in a MAC entity corresponding to a cell group to which a cell identified by the first PCI belongs.

In one embodiment, the C-RNTI is a C-RNTI of the first node U01A in a MAC entity corresponding to a cell group to the first cell belongs.

In one embodiment, the C-RNTI is a C-RNTI of the first node U01A in a MAC entity corresponding to an MCG.

In one embodiment, the C-RNTI is a C-RNTI of the first node U01A in a MAC entity corresponding to an SCG.

In one embodiment, the C-RNTI is maintained by a MAC entity of the first node U01A in a cell group to which a cell identified by the first PCI belongs.

In one embodiment, the C-RNTI is associated with a cell group to which a cell identified by the first PCI belongs.

In one embodiment, the C-RNTI corresponds to a cell group to which a cell identified by the first PCI belongs.

In one embodiment, the C-RNTI is an identity of the first node U01A in the first cell group.

In one embodiment, just before the behavior of setting a C-RNTI as the target ID, the C-RNTI is a value of the source ID, and just after the behavior of setting the C-RNTI as the target ID, the C-RNTI is a value of the target ID.

In one embodiment, just before the behavior of setting a C-RNTI as the target ID, the first node U01A monitors the first PDCCH; just after the behavior of setting a C-RNTI as the target ID, the first node U01A monitors the second PDCCH.

In one embodiment, a first receiver receives a first signaling, and the first signaling indicates a target identity; monitors a first PDCCH, the first PDCCH is associated with a first downlink RS resource, the first downlink RS resource is associated with a first PCI; receives a second signaling, the second signaling is used to indicate a second PCI; as a response to the behavior of receiving the second signaling, clears a first counter to zero, monitors a second PDCCH and discards monitoring the first PDCCH, the second PDCCH is associated with a second downlink RS resource, and the second downlink RS resource is associated with the second PCI; herein, the first signaling comprises an RRC message; the second signaling comprises a signaling below the RRC layer; the first PDCCH uses a source identity for scrambling; the second PDCCH uses the target identity for scrambling; the source identity and the target identity are different; the first counter is maintained at the MAC layer.

In one embodiment, the phrase of as a response to the behavior of receiving a second signaling comprises: when the second signaling is received.

In one embodiment, the phrase of as a response to the behavior of receiving a second signaling comprises: if the second signaling is received.

In one embodiment, the phrase of as a response to the behavior of receiving a second signaling comprises: if the MAC entity receives the second signaling.

In one embodiment, the phrase of as a response to the behavior of receiving a second signaling comprises: if the MAC entity receives the second signaling.

In one embodiment, the behavior of clearing a first counter to zero comprises: setting the first counter to O.

In one embodiment, the behavior of clearing a first counter to zero comprises: setting a value of the first counter to 0.

In one embodiment, the behavior of clearing a first counter to zero comprises: resetting the first counter.

In one embodiment, the behavior of clearing a first counter to zero comprises: setting the first counter as an initial value.

In one embodiment, the behavior of clearing a first counter to zero comprises: initializing the first counter, and an initial value of the first counter being 0.

In one embodiment, the phrase that the first counter is maintained at the MAC layer comprises: the first counter being a MAC layer counter.

In one embodiment, the phrase that the first counter is maintained at the MAC layer comprises: the first counter being maintained at the MAC entity.

In one embodiment, the first counter is a counter of beam failure instance indication, and an initial value of the first counter is set as 0.

In one embodiment, the first counter is used to count a number of beam failure instances indication(s).

In one embodiment, the first counter is a counter of LBT failure indication, and an initial value of the first counter is set to 0.

In one embodiment, the first counter is used to count a number of LBT failure indication(s).

In one embodiment, the beam failure instance indication is indicated by the physical layer to the MAC layer.

In one embodiment, the first counter is BFI_COUNTER.

In one embodiment, the first counter is LBT_COUNTER.

In one embodiment, as a response to the behavior of receiving a second signaling, stop a first timer, and the first timer is maintained at the MAC layer.

In one embodiment, as a response to the behavior of receiving the second signaling, clear a first counter to zero and stop the first timer; the first counter is maintained at the MAC layer, and the first timer is maintained at the MAC layer.

In one embodiment, the first timer comprises lbt-FailureDetectionTimer.

In one embodiment, the first timer comprises beamFailureDetectionTimer.

In one embodiment, the first timer is lbt-FailureDetectionTimer.

In one embodiment, the first timer is beamFailureDetectionTimer.

In one embodiment, the dotted box F7.1A is optional.

In one embodiment, the dotted box F7.1A exists.

In one embodiment, the dotted box F7.1A does not exist.

In one embodiment, the dotted box F7.2A is optional.

In one embodiment, the dotted box F7. 2A exists.

In one embodiment, the dotted box F7.2A does not exist.

In one embodiment, the dotted box F7.3A is optional.

In one embodiment, the dotted box F7.3A exists.

In one embodiment, the dotted box F7.3A does not exist.

In one embodiment, at least one of the dotted box F7.1A, or the dotted box F7.2A or the dotted box F7.3A exists.

### Embodiment 7B

Embodiment 7B illustrates a flowchart of radio signal transmission according to another embodiment in the present application, as shown in FIG. 7B. It is particularly underlined that the order illustrated in the embodiment does not put constraints over sequences of signal transmissions and implementations.

The first node U01B receives a first signaling in step 7101B, the first signaling is used to configure a first RS resource group, the first RS resource group comprises at least one RS resource; and in step S7102B, assesses radio link quality based on the first RS resource group; in step S7103B, determines a retransmission of a first RLC SDU; in step S7104B, as a response to the behavior of determining a retransmission of a first RLC SDU, updates count of a third indication; in step S7105B, submits a first RLC PDU, the first RLC PDU comprises a polling indication; in step S7106B, accompanying the behavior of submitting a first RLC PDU, starts a third timer; in step S7107B, receives a second signaling after receiving the first signaling; in step S7108B, assesses radio link quality based on the first RS resource group; in step S7109B, as a response to the behavior of receiving a second signaling, stops a third timer; in step S7110B, as a response to the behavior of receiving a second signaling, resets count of the third indication.

The second node N02B in step S7201B, transmits the second signaling.

In embodiment 7B, the first signaling is an RRC layer signaling, and the second signaling is a protocol-layer signaling below the RRC layer; the second signaling is used to indicate that all RS resources in a first RS resource subgroup are associated with a first PCI, the first RS resource subgroup comprises at least one RS resource, and any RS resource in the first RS resource subgroup belongs to the first RS resource group; an expiration of the third timer is used to determine a retransmission of a polling indication; the first-type timer comprises the third timer; the first-type indication is related to link failure; count of the third indication is used to determine a number of times the first RLC SDU is retransmitted; the first-type indication comprises the third indication.

In one embodiment, the dotted box F7.1B is optional.

In one embodiment, the dotted box F7.1B exists.

In one embodiment, the dotted box F7.1B does not exist.

In one embodiment, the dotted box F7.2B is optional.

In one embodiment, the dotted box F7. 2B exists.

In one embodiment, the dotted box F7.2B does not exist.

In one embodiment, the dotted box F7.3B is optional.

In one embodiment, the dotted box F7.3B exists.

In one embodiment, the dotted box F7.3B does not exist.

In one embodiment, the dotted box F7.4B is optional.

In one embodiment, the dotted box F7.4B exists.

In one embodiment, the dotted box F7.4B does not exist.

In one embodiment, after the step S7106B and before the step S7109B, the third timer continues running.

In one embodiment, after the step S7106B and before the step S7109B, the third timer is not stopped.

In one embodiment, after step S7106B and before step S7109B, timing of the third timer does not reach an expiration value of the third timer.

In one embodiment, after step S7104B and before step S7110B, count of the third indication is not reset.

In one embodiment, after step S7104B and before step S7110B, count of the third indication is not increased.

In one embodiment, after step S7104B and before step S7110B, count of the third indication does not reach a third value.

In one embodiment, in the step S7102B, the first RS resource group is associated with a cell identified by the second PCI; in the step S7108B, the first RS resource group is associated with a cell identified by the first PCI.

In one embodiment, in the step S7102B, the first RS resource group is associated with a cell identified by the second PCI and a cell identified by the first PCI; in the step S7108B, the first RS resource group is associated with a cell identified by the first PCI.

In one embodiment, the behavior of submitting a first RLC PDU comprises: transmitting the first RLC PDU via a radio interface.

In one embodiment, the behavior of submitting a first RLC PDU comprises: submitting the first RLC PDU to a lower layer.

In one embodiment, the behavior of submitting a first RLC PDU comprises: the first node U01B submits the first RLC PDU to the MAC layer at the RLC layer.

In one embodiment, the first RLC PDU comprises an RLC PDU.

In one embodiment, the first RLC PDU is an Acknowledged Mode Data (AMD) PDU.

In one embodiment, the first RLC PDU is an RLC layer PDU.

In one embodiment, the first RLC PDU is an RLC data PDU.

In one embodiment, the first RLC PDU comprises a data field.

In one embodiment, the first RLC PDU comprises an AMD PDU header.

In one embodiment, the structure of the first RLC PDU is referred to section 6.2.2.4 of 3GPP TS 38.322.

In one embodiment, an AMD PDU header in the first RLC PDU comprises a P field, where the P field comprises 1 bit; herein, the P field is set to 1 to indicate that a status report is requested, and the P field is set to 0 to indicate that a status report is not requested.

In one embodiment, the polling indication is used to request a status report.

In one embodiment, the polling indication is set through a Polling bit (P) field.

In one embodiment, the phrase that the first RLC PDU comprises a polling indication comprises: a polling indication in the first RLC PDU is set.

In one embodiment, the phrase that the first RLC PDU comprises a polling indication comprises: the P field in an AMD PDU header in the first RLC PDU is set to 1.

In one embodiment, accompanying the behavior of submitting a first RLC PDU, a transmitting end of the AM RLC entity initiates a third timer.

In one embodiment, the behavior of initiating a third timer comprises: starting the third timer.

In one embodiment, the behavior of initiating a third timer comprises: restarting the third timer.

In one embodiment, the behavior of initiating a third timer comprises: starting or restarting the third timer.

In one embodiment, accompanying the behavior of submitting a first RLC PDU and if the third timer is not running, start the third timer.

In one embodiment, accompanying the behavior of submitting a first RLC PDU and if the third timer is running, restart the third timer.

In one embodiment, the third timer is t-PollRetransmit.

In one embodiment, the third timer is an RRC-layer timer.

In one embodiment, the third timer is maintained at the RLC layer.

In one embodiment, a reception of a status report comprises that a status report for a positive or negative acknowledgement of an RLC SDU with sequence number POLL_SN is used to determine stopping and resetting the third timer.

In one embodiment, when the first notification is received and if the third timer is running, the third timer is stopped.

In one embodiment, when the second signaling is received and if the third timer is running, the third timer is stopped.

In one embodiment, the phrase that an expiration of the third timer is used to determine a retransmission of polling indication comprises: an expiration of the third timer is used to determine a retransmission of an AMD PDU containing the polling indication.

In one embodiment, the phrase that an expiration of the third timer is used to determine a retransmission of polling indication comprises: an expiration of the third timer is used to determine a transmission of an AMD PDU containing the polling indication.

In one embodiment, the phrase that an expiration of the third timer is used to determine a retransmission of polling indication comprises: an expiration of the third timer is used to determine a re-request status report.

In one embodiment, the behavior of determining a retransmission of a first RLC SDU comprises: considering a retransmission of the first RLC SDU; herein, a negative acknowledgement is received for the first RLC SDU.

In one subembodiment of the embodiment, SN of the first RLC SDU is not less than TX_Next_Ack and is not greater than a highest SN of an AMD PDU submitted to the lower layer.

In one subembodiment of the embodiment, the negative confirmation is received through a status report (status PDU) of a peer AM RLC entity.

In one embodiment, the behavior of determining a retransmission of a first RLC SDU comprises: when the third timer expires, considering a retransmission of the first RLC SDU; herein, the first RLC SDU is an RLC SDU with the highest SN submitted to an RLC SDU of the lower layer, or the first RLC SDU is any RLC SDU that has not been correctly confirmed.

In one subembodiment of the embodiment, transmission buffer and a retransmission buffer are both empty (except for an RLC SDU or RLC SDU segment that has been transmitted pending for a confirmation).

In one subembodiment of the embodiment, a new RLC SDU or RLC SDU segment cannot be transmitted.

In one subsidiary embodiment of the subembodiment, a new RLC SDU or RLC SDU segment cannot be transmitted because the transmission window is stalling.

In one subsidiary embodiment of the subembodiment, a new RLC SDU or RLC SDU segment cannot be transmitted because the retransmission window is stalling.

In one embodiment, the first RLC SDU is an RLC SDU.

In one embodiment, the first RLC SDU is an RLC SDU segment.

In one embodiment, the first RLC SDU is a segment of an RLC SDU.

In one embodiment, the first RLC SDU is an RLC SDU or an RLC SDU segment.

In one embodiment, the first RLC PDU comprises the first RLC SDU.

In one embodiment, the first RLC PDU comprises a segment of the first RLC SDU.

In one embodiment, count of the third indication is for the first RLC SDU.

In one embodiment, counter RETX_COUNT is used to count a count of the third indication.

In one embodiment, counter RETX_COUNT is equal to a count of the third indication.

In one embodiment, count of the third indication refers to a value of counter RETX_COUNT.

In one embodiment, the behavior of updating count of a third indication comprises: updating counter RETX_COUNT.

In one embodiment, the behavior of updating count of a third indication comprises: setting count of the third indication to 0.

In one embodiment, the behavior of updating count of a third indication comprises: adding 1 to count of the third indication.

In one embodiment, the phrase of “as a response to the behavior of determining a retransmission of a first RLC SDU, updating count of a third indication” comprises: as a response to the behavior of determining a retransmission of a first RLC SDU, if the first RLC SDU is considered retransmitted for the first time, setting count of the third indication associated with the first RLC SDU to 0 (zero).

In one embodiment, the phrase of “as a response to the behavior of determining a retransmission of a first RLC SDU, updating count of a third indication” comprises: as a response to the behavior of determining a retransmission of a first RLC SDU, if the first RLC SDU is not considered retransmitted for the first time, increasing count of the third indication.

In one embodiment, the phrase of “as a response to the behavior of determining a retransmission of a first RLC SDU, updating count of a third indication” comprises: as a response to the behavior of determining a retransmission of a first RLC SDU, if the first RLC SDU is not considered a retransmission for the first time, the first RLC SDU is not pending for retransmission already, and count of the third indication associated with the first RLC SDU has not been incremented due to another negative acknowledgment in the same STATUS PDU, increasing count of the third indication.

In one embodiment, count of the third indication reaching a third value is used to indicate to the higher layer that a maximum number of retransmissions is reached.

In one subembodiment of the embodiment, the higher layer receiving an indication of the reaching a maximum number of retransmissions is used to trigger RLF.

In one subembodiment of the embodiment, the third value comprises maxRetxThreshold.

In one subembodiment of the embodiment, the third value is configurable.

In one subembodiment of the above embodiment, the third value is configured through an RRC message.

In one subembodiment of the embodiment, the third value is a non-negative integer.

In one embodiment, the phrase that count of the third indication is used to determine a number of times the first RLC SDU is retransmitted comprises: count of the third indication is equal to a number of times the first RLC SDU is retransmitted.

In one embodiment, the phrase that count of the third indication is used to determine a number of times the first RLC SDU is retransmitted comprises: count of the third indication is used to count a number of times the first RLC SDU is retransmitted.

In one embodiment, the phrase that count of the third indication is used to determine a number of times the first RLC SDU is retransmitted comprises: count of the third indication counts a number of retransmissions of the first RLC SDU.

In one embodiment, the meaning of the times is number.

In one embodiment, the meaning of the times is quantity.

### Embodiment 8A

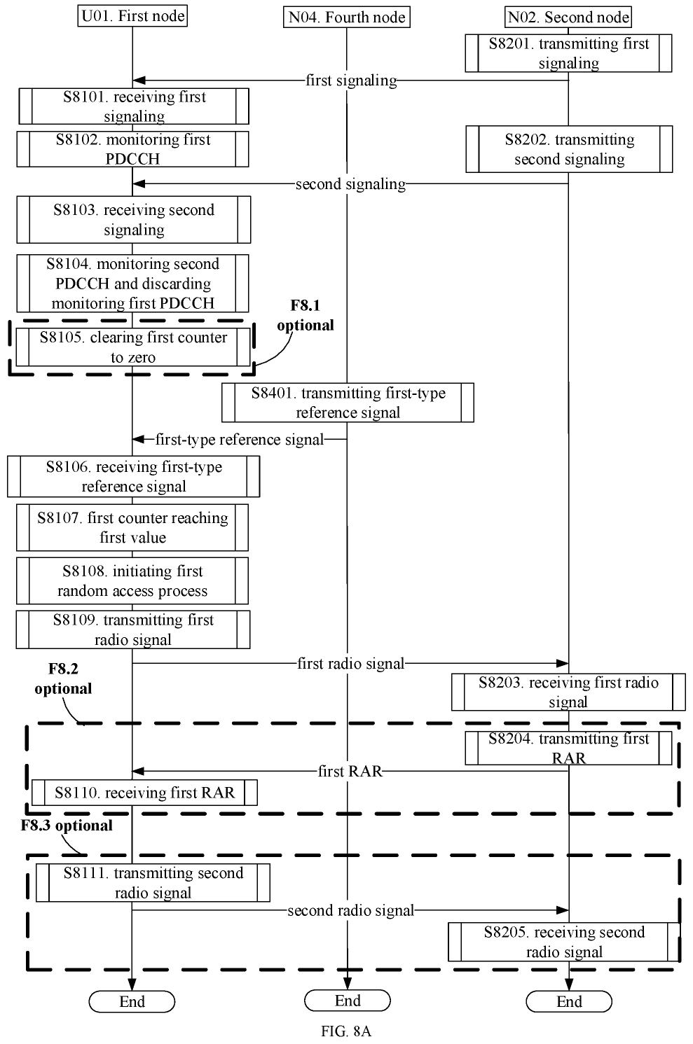

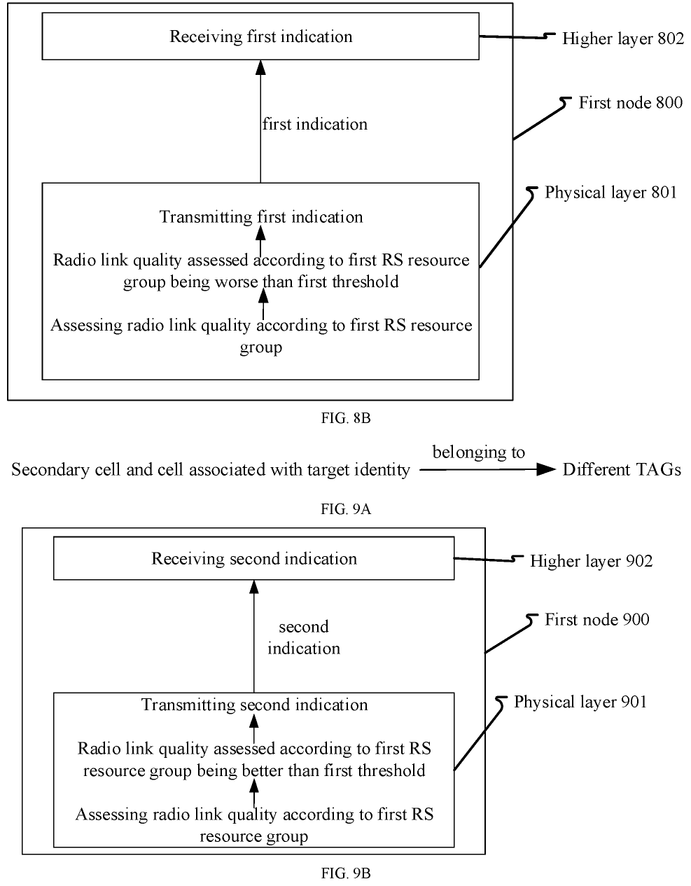

Embodiment 8A illustrates a flowchart of radio signal transmission according to another embodiment in the present application, as shown in FIG. 8A. It is particularly underlined that the order illustrated in the embodiment does not put constraints over sequences of signal transmissions and implementations.

The first node U01 receives a first signaling in step S8101, and the first signaling indicates a target identity; in step S8102, monitors a first PDCCH, the first PDCCH is associated with a first downlink RS resource, and the first downlink RS resource is associated with a first PCI; in step S8103, receives a second signaling, and the second signaling is used to indicate a second PCI; in step S8104, as a response to the behavior of receiving the second signaling, monitors a second PDCCH and discards monitoring a first PDCCH, the second PDCCH is associated with a second downlink RS resource, and the second downlink RS resource is associated with the second PCI; in step S8105, as a response to the behavior of receiving a second signaling, clears a first counter to zero; in step S8106, receives a first-type reference signal, the first-type reference signal is associated with the second PCI, and a measurement for the first-type reference signal is used to determine updating the first counter; in step S8107, a first counter reaches a first value; in step S8108, when the first counter reaches a first value, initiates a first random access process; in step S8109, as a response to the behavior of initiating a first random access process, transmits a first radio signal, and the first radio signal is associated with the first PCI; in step S8110, receives a first RAR; in step S8111, transmits a second radio signal, the second radio signal comprises the source identity.

The second node N02 transmits the first signaling in step S8201; in step S8202, transmits the second signaling; in step S8203, receives the first radio signal; transmits the first RAR in step S8204; receives the second radio signal in step S8205.

The fourth node N04 transmits the first-type reference signal in step S8401.

In embodiment 8A, the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI; the first counter is maintained at the MAC layer; the first value is a positive integer; the first-type reference signal is unrelated to the first PCI; the second radio signal belongs to the first random access process; the second radio signal is transmitted after the first radio signal.

In one embodiment, the cell identified by the first PCI is the first cell; the cell identified by the second PCI is the second cell.

In one embodiment, the first counter is BFI_COUNTER.

In one embodiment, the phrase that the first-type reference signal is associated with the second PCI comprises: the first-type reference signal is only for the cell identified by the second PCI.

In one embodiment, the phrase that the first-type reference signal is associated with the second PCI comprises: the first-type reference signal is configured for the cell identified by the second PCI.

In one embodiment, the phrase that the first-type reference signal is associated with the second PCI comprises: the first-type reference signal is transmitted by a maintenance base station of the cell identified by the second PCI.

In one embodiment, the phrase that the first-type reference signal is associated with the second PCI comprises: the first-type reference signal is dedicated to the cell identified by the second PCI.

In one embodiment, the first-type reference signal is used for beam measurement.

In one embodiment, the first-type reference signal is used for L1 measurement.

In one embodiment, the first-type reference signal is used for Beam Failure Detection (BFD).

In one embodiment, the first-type reference signal is a physical-layer signal.

In one embodiment, the first-type reference signal is cell-dedicated.

In one embodiment, the first-type reference signal is beam-dedicated.

In one embodiment, the first-type reference signal is a periodic signal.

In one embodiment, the first-type reference signal is antenna port-dedicated.

In one embodiment, the first-type reference signal is associated with a beam.

In one embodiment, the first-type reference signal is associated with a beam of the first cell.

In one embodiment, the first-type reference signal is associated with a beam of the second cell.

In one embodiment, the first-type reference signal comprises an SSB.

In one embodiment, the first-type reference signal comprises CSI-RS.

In one embodiment, the phrase that when the first counter reaches a first value comprises: if the first counter reaches a first value.

In one embodiment, the phrase that when the first counter reaches a first value comprises: if the first counter is equal to the first value.

In one embodiment, the phrase that when the first counter reaches a first value comprises: if the first counter is greater than the first value.

In one embodiment, the phrase that when the first counter reaches a first value comprises: if the first timer is not less than the first value.

In one embodiment, the behavior of initiating a first random access process comprises: triggering the first random access process.

In one embodiment, the behavior of initiating a first random access process comprises: initiating the first random access process.

In one embodiment, the behavior of initiating a first random access process comprises: starting executing section 5.1.1 or 5.1.1a in TS 38.321.

In one embodiment, the behavior of initiating a first random access process comprises: starting executing section 5.1.2 or 5.1.2a in TS 38.321.

In one embodiment, the initiating refers to initiate.

In one embodiment, the first random access process refers to a random access process on the cell identified by the first PCI, where the cell identified by the first PCI is a PCell or a PSCell.

In one embodiment, the first random access procedure is used for BFR.

In one embodiment, the first random access process is used to fallback to the cell identified by the first PCI.

In one embodiment, the phrase of as a response to the behavior of initiating a first random access process comprises: after the first random access process is triggered.

In one embodiment, the phrase of as a response to the behavior of initiating a first random access process comprises: when the first random access process is executed.

In one embodiment, the phrase of as a response to the behavior of initiating a first random access process comprises: during an execution of the first random access process.

In one embodiment, the first radio signal comprises at least a random access preamble.

In one embodiment, the first radio signal is for a four-step random access process, and the first radio signal only comprises a random access preamble.

In one embodiment, the first radio signal is for a two-step random access process, and the first radio signal comprises a random access preamble.

In one embodiment, the first radio signal is for a two-step random access process, and the first radio signal comprises a random access preamble and a PUSCH transmission.

In one subembodiment of the embodiment, the PUSCH transmission comprises a MAC CE.

In one subembodiment of the embodiment, the PUSCH transmission comprises a C-RNTI MAC CE.

In one subsidiary embodiment of the subembodiment, the PUSCH transmission comprises the second radio signal.

In one subsidiary embodiment of the subembodiment, the PUSCH transmission is the second radio signal.

In one subembodiment of the above embodiment, the first radio signal is MSGA.

In one embodiment, the first value is configurable.

In one embodiment, the first value is pre-configured.

In one embodiment, the first value is configured through an RRC message.

In one embodiment, the first value is configured for the cell identified by the second PCI.

In one embodiment, the phrase that the first-type reference signal is unrelated to the first PCI comprises: the first-type reference signal is unrelated to the cell identified by the first PCI.

In one embodiment, the phrase that the first-type reference signal is unrelated to the first PCI comprises: any reference signal in the first-type reference signal is different from any reference signal in the cell identified by the first PCI.

In one embodiment, the phrase that the first-type reference signal is unrelated to the first PCI comprises: any reference signal in the first-type reference signal is not associated with any reference signal in the cell identified by the first PCI.

In one embodiment, the second radio signal comprises MSG3.

In one embodiment, the second radio signal comprises a MAC PDU.

In one embodiment, the second radio signal comprises a MAC subheader.

In one embodiment, the second radio signal comprises a C-RNTI MAC CE.

In one embodiment, the second radio signal is transmitted through a UL-SCH.

In one embodiment, the phrase that the second radio signal comprises the source identity comprises: the second radio signal indicates the source identity.

In one embodiment, the phrase that the second radio signal comprises the source identity comprises: a field in the second radio signal indicates the source identity.

In one embodiment, the phrase that the second radio signal comprises the source identity comprises:

the second radio signal is a C-RNTI MAC CE, and a C-RNTI field in the C-RNTI MAC CE indicates the source identity.

In one embodiment, the phrase that the second radio signal belongs to the first random access process comprises: the second radio signal is a signal in the first random access process.

In one embodiment, the phrase that the second radio signal belongs to the first random access process comprises: the second radio signal is transmitted in the first random access process.

In one embodiment, the phrase that the second radio signal belongs to the first random access process comprises: uplink resources used by the second radio signal are indicated by an RAR received in the first random access process.

In one embodiment, the first RAR is a MAC RAR.

In one embodiment, the first RAR is a fallbackRAR.

In one embodiment, the first RAR is a successRAR.

In one embodiment, the first RAR is used to determine a UL grant of the second radio signal.

In one embodiment, the dotted box F8.1 is optional.

In one embodiment, the dotted box F8.1 exists.

In one embodiment, the dotted box F8.1 does not exist.

In one embodiment, the dotted box F8.2 is optional.

In one embodiment, the dotted box F8. 2 exists.

In one embodiment, the dotted box F8. 2 does not exist.

In one embodiment, the dotted box F8.3 is optional.

In one embodiment, the dotted box F8.3 exists.

In one embodiment, the dotted box F8.3 does not exist.

In one embodiment, the dotted box F8.2 does not exist and the dotted box F8.3 does not exist.

In one subembodiment of the embodiment, the first radio signal is for a four-step random access process, and the first radio signal only comprises a random access preamble.

In one subembodiment of the embodiment, the first radio signal is for a two-step random access process, and the first radio signal comprises a random access preamble.

In one subembodiment of the embodiment, the first RAR is not successfully received.

In one subembodiment of the embodiment, the first RAR is not transmitted.

In one subembodiment of the above embodiment, the first radio signal is not received by the second node N02.

In one embodiment, the dotted box F8.2 exists and the dotted box F8.3 exists.

In one subembodiment of the embodiment, the first radio signal is for a four-step random access process, and the first radio signal only comprises a random access preamble.

In one subembodiment of the above embodiment, the second radio signal comprises MSG3.

In one embodiment, the dotted box F8.2 does not exist and the dotted box F8.3 exists.

In one subembodiment of the above embodiment, the first radio signal is for two-step random access.

In one subembodiment of the above embodiment, the first radio signal comprises a random access preamble and the second radio signal.

In one subembodiment of the above embodiment, the second radio signal is a part in the first radio signal.

### Embodiment 8B

Embodiment 8B illustrates a schematic diagram of the physical layer of a first node reporting a first indication to the higher layer of the first node according to one embodiment of the present application, as shown in FIG. 8B.

In embodiment 8B, each time the radio link quality assessed based on the first RS resource group is worse than a first threshold, the physical layer 801 of the first node 800 reports a first indication to the higher layer 802 of the first node 800; the first-type indication comprises the first indication; the first threshold is configurable.

In one embodiment, after reporting a first indication to the higher layer 802 of the first node 800 at the physical layer 801 of the first node 800, the higher layer 802 of the first node 800 receives the first indication; as a response to the behavior of the higher layer 802 of the first node 800 receiving the first indication, update count of the first indication.

In one embodiment, after reporting a first indication to the higher layer 802 of the first node 800 at the physical layer 801 of the first node 800, the higher layer 802 of the first node 800 receives the first indication; as a response to the higher layer 802 of the first node 800 receiving the first indication, determine whether to update count of the first indication based on whether a first timer is running; the behavior of determining whether to update count of the first indication based on whether the first timer is running comprises: when the first timer is running, not update count of the first indication; when the first timer is not running, update count of the first indication.

In one embodiment, the behavior of updating count of the first indication comprises: adding 1 to count of the first indication.

In one embodiment, the behavior of updating count of the first indication comprises: adding 1 to counter N310, and the counter N310 being used to count the first indication.

In one embodiment, the behavior of not updating count of the first indication comprises: maintaining count of the first indication.

In one embodiment, the behavior of not updating count of the first indication comprises: counter N310 is not increased.

In one embodiment, if count of the first indication reaches a first value, start the first timer.

In one subembodiment of the embodiment, the first value is equal to constant N310.

In one subembodiment of the embodiment, the first value is equal to beamFailureInstanceMaxCount.

In one subembodiment of the embodiment, the first value is a constant.

In one subembodiment of the embodiment, the first value is configurable.

In one subembodiment of the embodiment, the first value is a positive integer, and the first value is not greater than 64.

In one subembodiment of the embodiment, the first value is a maximum value of count of the first indication.

In one embodiment, the phrase that the radio link quality assessed according to the first RS resource group is worse than a first threshold comprises: radio link quality of each RS resource in the first RS resource group is worse than the first threshold.

In one embodiment, the phrase that the radio link quality assessed according to the first RS resource group is worse than a first threshold comprises: radio link quality of all RS resources in the first RS resource group is worse than the first threshold.

In one embodiment, the phrase that the radio link quality assessed according to the first RS resource group is worse than a first threshold comprises: the radio link quality assessed based on each RS resource in the first RS resource group is worse than the first threshold.

In one embodiment, the first threshold is configurable.

In one embodiment, the first threshold is pre-configured.

In one embodiment, the first threshold is configured through an RRC message.

In one embodiment, the first threshold comprises a BLER threshold.

In one embodiment, the first threshold comprises an RSRP threshold.

In one embodiment, the first indication is an out-of-sync indication.

In one subembodiment of the embodiment, the first threshold comprises Qout.

In one subembodiment of the embodiment, the first threshold is indicated by a field in an RRC message.

In one subembodiment of the embodiment, the first threshold is indicated by a field in an RRC message, and a name of the field comprises rlmInSyncOutOfSyncThreshold.

In one embodiment, the first indication is a beam failure instance indication.

In one subembodiment of the embodiment, the first threshold comprises Qout,RLM.

In one subembodiment of the embodiment, the first threshold comprises Qout,LR.

In one subembodiment of the embodiment, the first threshold is indicated by a field in an RRC message.

In one subembodiment of the embodiment, the first threshold is indicated by a field in an RRC message, and a name of the field comprises at least one of rlmInSyncOutOfSyncThreshold, or rsrp-ThresholdSSB, or rsrp-ThresholdBFR-r16, or rsrp-ThresholdBFR.

In one embodiment, each time the radio link quality assessed based on the first RS resource group is worse than a first threshold, the physical layer 801 of the first node 800 reports a first indication to the higher layer 802 of the first node 800; as a response to the higher layer 802 of the first node 800 receiving the first indication, update count of the first indication.

In one embodiment, the higher layer 802 a MAC layer.

In one embodiment, the higher layer 802 an RRC layer.

In one embodiment, the FIG. 8 only illustrates that the physical layer 801 and the higher layer 802 belong to the first node 800. The first node 800 also comprises protocol layers or components in addition to the physical layer 801 and the higher layer 802.

### Embodiment 9A

Embodiment 9A illustrates a schematic diagram of a first secondary cell and a cell identified by a second PCI belonging to different TAGs according to one embodiment of the present application, as shown in FIG. 9A.

In embodiment 9A, receive a first signaling, the first signaling indicates a target identity; monitor a first PDCCH, the first PDCCH is associated with a first downlink RS resource, the first downlink RS resource is associated with a first PCI; receive a second signaling, the second signaling is used to indicate a second PCI; as a response to the behavior of receiving the second signaling, monitor a second PDCCH and discard monitoring the first PDCCH, the second PDCCH is associated with a second downlink RS resource, and the second downlink RS resource is associated with the second PCI; as a response to the behavior of receiving a second signaling, treat a first secondary cell as deactivated; herein, the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI; the first secondary cell and a cell identified by the first PCI belong to a same cell group; the first secondary cell and a cell identified by the second PCI belong to different TAGs.

In one embodiment, uplink transmission timing of the first node in the first secondary cell is different from uplink transmission timing of the first node in a cell associated with the target identity.

In one embodiment, the first secondary cell and a cell associated with the target identity belong to different TAGs.

In one embodiment, the first secondary cell and a cell associated with the target identity are configured at different TAGs.

In one embodiment, when the first secondary cell and a cell associated with the target identity belong to different TAGs, as a response to receiving a second signaling, treat a first secondary cell as deactivated.

In one embodiment, when the first secondary cell and a cell associated with the target identity belong to a same TAG, as a response to receiving a second signaling, maintain a state of the first secondary cell.

In one subembodiment of the above embodiment, the behavior of maintaining a state of the first secondary cell comprises: the state of the first secondary cell remains unchanged.

In one subembodiment of the above embodiment, the behavior of maintaining a state of the first secondary cell comprises: if the state of the first secondary cell is activated before the behavior of receiving a second signaling, then the state of the first secondary cell is activated after the behavior of receiving the second signaling.

In one subembodiment of the above embodiment, the behavior of maintaining a state of the first secondary cell comprises: if the state of the first secondary cell is deactivated before the behavior of receiving a second signaling, then the state of the first secondary cell is deactivated after the behavior of receiving the second signaling.

### Embodiment 9B

Embodiment 9B illustrates a schematic diagram of the physical layer of a first node reporting a second indication to the higher layer of the first node according to one embodiment of the present application, as shown in FIG. 9B.

In embodiment 9B, each time the radio link quality assessed based on the first RS resource group is better than a second threshold, the physical layer 901 of the first node 900 reports a second indication to a higher layer 902 of the first node 900; the first-type indication comprises the second indication; the second threshold is configurable.

In one embodiment, after the physical layer 901 of the first node 900 reports a second instruction to the higher-layer 902 of the first node 900, the higher-layer 902 of the first node 900 receives the second indication; as a response to the higher layer 902 of the first node 900 receiving the second indication, update count of the second indication.

In one embodiment, after the physical layer 901 of the first node 900 reports a second instruction to the higher-layer 902 of the first node 900, the higher-layer 902 of the first node 900 receives the second indication; as a response to the higher layer 902 of the first node 900 receiving the second indication, determine whether to update count of the second indication based on whether a first timer is running; the behavior of determining whether to update count of the second indication based on whether the first timer is running comprises: when the first timer is running, updating count of the second indication; when the first timer is not running, not updating count of the second indication.

In one embodiment, the behavior of not updating count of the second indication comprises: maintaining count of the second indication.

In one embodiment, the behavior of not updating count of the second indication comprises: counter N311 is not increased.

In one embodiment, the behavior of updating count of the second indication comprises: adding 1 to count of the second indication.

In one embodiment, the behavior of updating count of the second indication comprises: adding 1 to counter N311, and the counter N311 is used to count the second indication.

In one embodiment, if count of the continuously received second indication(s) reaches a second value, stop the first timer.

In one subembodiment of the embodiment, the second value is equal to constant N311.

In one subembodiment of the embodiment, the second value is a constant.

In one subembodiment of the embodiment, the second value is configurable.

In one subembodiment of the above embodiment, the second value is a positive integer, and the second value is not greater than 64.

In one subembodiment of the embodiment, the second value is a maximum value of count of the second indication.

In one embodiment, the first node 900 assesses radio link quality once per indication period for a period of time preceding an indication period.

In one embodiment, the phrase that the radio link quality assessed according to the first RS resource group is better than a second threshold comprises: radio link quality of one RS resource in the first RS resource group is better than the second threshold.

In one embodiment, the phrase that the radio link quality assessed according to the first RS resource group is better than a second threshold comprises: radio link quality of all RS resources in the first RS resource group is better than the second threshold.

In one embodiment, the phrase that the radio link quality assessed according to the first RS resource group is better than a second threshold comprises: the radio link quality assessed based on any RS resource in the first RS resource group is better than the second threshold.

In one embodiment, the second threshold is configurable.

In one embodiment, the second threshold is pre-configured.

In one embodiment, the second threshold is configured through an RRC message.

In one embodiment, the second threshold comprises a BLER threshold.

In one embodiment, the second threshold comprises an RSRP threshold.

In one embodiment, the first threshold comprises Qin.

In one embodiment, the first indication is a synchronous indication.

In one embodiment, the second threshold is indicated by a field in an RRC message.

In one subembodiment of the above embodiment, a name of the field comprises rlmInSyncOutOfSyncThreshold.

In one subembodiment of the embodiment, a name the field comprises rsrp-ThresholdSSB.

In one subembodiment of the embodiment, a name of the field comprises rsrp-ThresholdBFR.

In one embodiment, the higher layer 902 a MAC layer.

In one embodiment, the higher layer 902 an RRC layer.

In one embodiment, the FIG. 9 only illustrates that the physical layer 901 and the higher layer 902 belong to the first node 900. The first node 900 also comprises protocol layers or components in addition to the physical layer 901 and the higher layer 902.

### Embodiment 10A

Embodiment 10A illustrates a schematic diagram of a relation between a second node and a fourth node according to one embodiment of the present application, as shown in FIG. 10A.

In one embodiment, the second node comprises at least the first TRP 1002A.

In one embodiment, the first TRP 1002A belongs to the first DU 1004A.

In one embodiment, the first TRP 1002A is a part of the second node.

In one embodiment, the first TRP 1002A belongs to the first cell 1006A.

In one embodiment, the second node comprises the first DU 1004A.

In one embodiment, the first DU 1004A comprises a CU.

In one embodiment, the first DU 1004A comprises a DU.

In one embodiment, the first DU 1004A comprises a part of the second node.

In one embodiment, the fourth node comprises at least the second TRP 1003A.

In one embodiment, the second TRP 1003A belongs to the second DU 1005A.

In one embodiment, the second TRP 1003A is a part of the fourth node.

In one embodiment, the second TRP 1003A belongs to the second cell 1007A.

In one embodiment, the fourth node comprises the second DU 1005A.

In one embodiment, the second DU 1005A comprises a CU.

In one embodiment, the second DU 1005A comprises a DU.

In one embodiment, the second DU 1005A comprises a part of the fourth node.

In one embodiment, the first DU 1004A and the second DU 1005A are a same DU.

In one embodiment, the first DU 1004A and the second DU 1005 are two different DUs.

In one embodiment, a beam of the first TRP 1002A and a beam of the second TRP1003A correspond to a same CORESET.

In one embodiment, a beam of the first TRP 1002A and a beam of the second TRP1003A correspond to different CORESETs.

In one embodiment, the first cell 1006A comprises one or multiple beams in the second node.

In one embodiment, the first cell 1006A comprises one or multiple beams in the first TRP 1002A.

In one embodiment, the first cell 1006A is associated with the second node.

In one embodiment, a maintenance base station of the first cell 1006A is the second node.

In one embodiment, the first cell 1006A is a main cell of the first node, and the second cell 1007 is an adjacent cell of a main cell of the first node.

In one embodiment, the first cell 1006A is a physical cell.

In one embodiment, the first cell 1006A belongs to a serving cell of the first node 1001A, while the second cell 1007A does not belong to a serving cell of the first node 1001A.

In one embodiment, the first cell 1006A is an SPCell of the first node.

In one embodiment, the first downlink RS resource belongs to the first cell 1006A.

In one embodiment, the first downlink RS resource corresponds to at least one beam of the first TRP 1002A.

In one embodiment, the first downlink RS resource is associated with the first cell 1006A.

In one embodiment, the first PCI is used to identify the first cell 1006A.

In one embodiment, the second cell 1007A comprises one or multiple beams in the fourth node.

In one embodiment, the second cell 1007A comprises one or multiple beams in the second TRP 1003A.

In one embodiment, the second cell 1007A is associated with a fourth node.

In one embodiment, a maintenance base station of the second cell 1007A is the fourth node.

In one embodiment, the second cell 1007A is a physical cell.

In one embodiment, when the second cell 1007A is configured, the first node 1001A maintains an RRC connection with the first cell 1006A; when the second cell 1007A is applied, a serving cell identifier of the first node 1001A remains unchanged.

In one embodiment, the second downlink RS resource belongs to the second cell 1007A.

In one embodiment, the second downlink RS resource corresponds to at least one beam of the second TRP 1003A.

In one embodiment, the second downlink RS resource is associated with the second cell 1007A.

In one embodiment, the second PCI is used to identify the second cell 1007A.

In one embodiment, the first cell 1006A and the second cell 1007A are of same frequency.

In one embodiment, the first cell 1006A and the second cell 1007A are of different frequency.

In one embodiment, the cell identified by the first PCI is the first cell 1006A; the cell identified by the second PCI is the second cell 1007A.

In one embodiment, the cell identified by the first PCI is the second cell 1007A; the cell identified by the second PCI is the first cell 1006A.

In one embodiment, the first cell 1006A comprises a serving cell of the first node 1001A, and the second cell 1007A comprises a non-serving cell of the first node 1001A.

In one embodiment, the first cell 1006A comprises a serving cell of the first node 1001A, and the second cell 1007A comprises an adjacent cell of the first cell 1006A.

In one embodiment, there is an RRC connection between the first node 1001A and the first cell 1006A, and there is no RRC connection between the first node 1001A and the second cell 1007A.

In one embodiment, the first PDCCH is transmitted by a maintenance base station of the second cell 1007A; the second PDCCH is transmitted by a maintenance base station of the first cell 1006A.

In one embodiment, the first PDCCH is transmitted by the second TRP 1003A; the second PDCCH is transmitted by the first TRP 1002.

In one embodiment, the first PDCCH is transmitted by a maintenance base station of the first cell 1006A; the second PDCCH is transmitted by a maintenance base station of the second cell 1007A.

In one embodiment, the first PDCCH is transmitted by the first TRP 1002A; the second PDCCH is transmitted by the second TRP 1003A.

In one embodiment, arrow 1008A represents at least one of a BCCH, or a paging signal, or system information.

In one embodiment, arrow 1009A represents at least one of PUSCH, PDSCH, or PDCCH.

In one embodiment, arrow 1010A represents at least one of PUSCH, PDSCH, or PDCCH.

In one embodiment, one of arrow 1009A and arrow 1010A exists.

In one embodiment, one of arrow 1009A and arrow 1010A do not exist at the same time.

In one embodiment, arrow 1009A comprises the first PDCCH, and the arrow 1010A comprises the second PDCCH.

In one embodiment, arrow 1009A comprises the first uplink grant, and the arrow 1010A comprises the second uplink grant.

In one embodiment, arrow 1009A comprises the second PDCCH, and the arrow 1010A comprises the first PDCCH.

In one embodiment, arrow 1009A comprises the second uplink grant, and the arrow 1010A comprises the first uplink grant.

In one embodiment, the first node 1001A determines physical resources between the first cell 1006A and the second cell 1007A through the second signaling.

In one embodiment, when the first node 1001A moves between the first cell 1006A and the second cell 1007A, a serving cell of the first node 1001A remains unchanged.

In one subembodiment of the above embodiment, the phrase that a serving cell of the first node 1001A remains unchanged comprises: the protocol stack of at least one of RRC layer, PDCP layer, RLC layer, MAC layer, or PHY layer of the first node 1001A does not require relocation.

In one subembodiment of the above embodiment, the phrase that a serving cell of the first node 1001A remains unchanged comprises: an RRC connection of the first node 1001A remains unchanged.

In one subembodiment of the above embodiment, the phrase that a serving cell of the first node 1001A remains unchanged comprises: a serving cell identifier of the first node 1001A remains unchanged.

In one subembodiment of the above embodiment, the phrase that a serving cell of the first node 1001A remains unchanged comprises: all or part of configuration in ServingCellConfigCommon configuration of the first node 1001A remains unchanged.

In one subembodiment of the above embodiment, the phrase that a serving cell of the first node 1001A remains unchanged comprises: all or part of configuration in ServingCellConfigCommonSIB configuration of the first node 1001A remains unchanged.

In one embodiment, the serving cell refers to a PCell, a PSCell, or an SCell.

In one subembodiment of the above embodiment, the PCell refers to a cell working at primary frequency, and the first node 1001A executes an initial connection establishment process or initiates a connection re-establishment process on the PCell.

In one subembodiment of the above embodiment, the PSCell refers to an SCG cell where the first node 1001A executes a random access process for the first node 1001A configured with a dual connectivity operation when a synchronous reconfiguration process is executed.

In one subembodiment of the above embodiment, the SCell refers to a cell that provides extra radio resources above an SpCell for the first node 1001A configured with CA.

In one embodiment, the serving cell comprises the first cell 1006A.

In one embodiment, the second cell 1007A provides extra physical resources above the serving cell.

In one embodiment, the first node 1001A does not have an independent MAC entity for the second cell 1007A.

In one embodiment, the first node 1001A does not have an independent MAC process for the second cell 1007A.

In one embodiment, a MAC entity of the first node 1001A does not have an independent HARQ entity for the second cell 1007A.

In one embodiment, a MAC entity of the first node 1001A comprises a HARQ entity for the first cell 1006A and the second cell 1007A.

In one embodiment, a MAC entity of the first node 1001A shares a same HARQ entity for the first cell 1006A and the second cell 1007A.

In one embodiment, the first cell 1006A and the second cell 1007A are associated with a same HARQ entity.

### Embodiment 10B

Embodiment 10B illustrates a schematic diagram of a relation between a second node and a third node according to one embodiment of the present application, as shown in FIG. 10B.

In one embodiment, the second node comprises at least the first TRP 1002B; the first TRP 1002B belongs to the first DU1004B; the first DU 1004B comprises a part of the second node; the first TRP 1002B is a part of the second node.

In one embodiment, the third node comprises at least the second TRP 1003B; the second TRP 1003B belongs to the second DU 1005B; the second DU 1005B comprises a part of the third node; the second TRP 1003B is a part of the third node.

In one embodiment, the second node comprises the first DU 1004B.

In one embodiment, the third node comprises the second DU 1005B.

In one embodiment, the first DU 1004B comprises a Distributed Unit (DU).

In one embodiment, the second DU 1005B comprises a DU.

In one embodiment, the first DU 1004B and the second DU 1005B are a same DU.

In one embodiment, the first DU 1004B and the second DU 1005B are two different DUs.

In one embodiment, a beam of the first TRP 1002B and a beam of the second TRP1003B correspond to a same CORESET.

In one embodiment, a beam of the first TRP 1002B and a beam of the second TRP1003B correspond to different CORESETs.

In one embodiment, the first cell 1006B is associated with the second node.

In one embodiment, the first cell 1006B comprises one or multiple beams in the second node.

In one embodiment, the first cell 1006B is associated with one or multiple beams in the first TRP1002B.

In one embodiment, a maintenance base station of the first cell 1006B is the second node.

In one embodiment, the first cell 1006B is a physical cell.

In one embodiment, the first cell 1006B is a serving cell of the first node 1001B, and the serving cell refers to a PCell, a PSCell, or an SCell.

In one embodiment, the second cell 1007B is associated with the third node.

In one embodiment, the second cell 1007B comprises one or multiple beams in the third node.

In one embodiment, the second cell 1007B is associated with one or multiple beams of the second TRP 1003B.

In one embodiment, a maintenance base station of the second cell 1007B is the third node.

In one embodiment, the second cell 1007B is a physical cell.

In one embodiment, the second cell 1007B provides extra physical resources above the first cell.

In one embodiment, the second cell 1007B a candidate cell configured for L 1/L2 mobility.

In one embodiment, the first cell 1006B and the second cell 1007B are of same frequency.

In one embodiment, the first cell 1006B and the second cell 1007B are of different frequency.

In one embodiment, the cell identified by the first PCI is the first cell 1006B; the cell identified by the second PCI is the second cell 1007B.

In one embodiment, the cell identified by the first PCI is the second cell 1007B; the cell identified by the second PCI is the first cell 1006B.

In one embodiment, the first cell 1006B is a primary cell of the first node 1001B, and the second cell 1007B is an adjacent cell of a primary cell of the first node 1001B.

In one embodiment, the first cell 1006B belongs to a serving cell of the first node 1001B, while the second cell 1007B does not belong to a serving cell of the first node 1001B.

In one embodiment, the first cell 1006B comprises a serving cell of the first node 1001B, and the second cell 1007B comprises an adjacent cell of the first cell 1006B.

In one embodiment, the first cell 1006B comprises a serving cell of the first node 1001B, and the second cell 1007B comprises a non-serving cell of the first node 1001B.

In one embodiment, when the second cell 1007B is configured, the first node 1001B maintains an RRC connection with the first cell 1006B; when the second cell 1007B is applied, a serving cell identifier of the first node 1001B remains unchanged.

In one subembodiment of the embodiment, the phrase that a serving cell of the first node 1001B remains unchanged comprises: the protocol stack of at least one of RRC layer, PDCP layer, RLC layer, MAC layer, or PHY layer of the first node 1001B does not require relocation.

In one subembodiment of the embodiment, the phrase that a serving cell of the first node 1001B remains unchanged comprises: an RRC connection of the first node 1001B remains unchanged.

In one subembodiment of the embodiment, the phrase that a serving cell of the first node 1001B remains unchanged comprises: a serving cell identifier of the first node 1001B remains unchanged.

In one subembodiment of the above embodiment, the phrase that a serving cell of the first node 1001B remains unchanged comprises: all or part of configuration in ServingCellConfigCommon configuration of the first node 1001B remains unchanged.

In one subembodiment of the above embodiment, the phrase that a serving cell of the first node 1001B remains unchanged comprises: all or part of configuration in ServingCellConfigCommonSIB configuration of the first node 1001B remains unchanged.

In one embodiment, when the first node 1001B moves between the first cell 1006B and the second cell 1007B, a serving cell of the first node 1001B remains unchanged.

In one embodiment, there is an RRC connection between the first node 1001B and the first cell 1006B, and there is no RRC connection between the first node 1001B and the second cell 1007B.

In one embodiment, arrow 1008B represents at least one of a BCCH, or a paging signal, or system information.

In one embodiment, arrow 1009B represents at least one of PUSCH, PDSCH, or PDCCH.

In one embodiment, arrow 1010B represents at least one of PUSCH, PDSCH, or PDCCH.

In one embodiment, before the behavior of executing a first action set, the first node 1001B monitors a second PDCCH, and the second PDCCH is associated with a Cell Radio Network Temporary Identifier (C-RNTI) of the cell identified by the second PCI; after the behavior of executing a first action set, the first node 1001B monitors a first PDCCH, and the first PDCCH is associated with a C-RNTI of the cell identified by the first PCI.

In one embodiment, before the behavior of executing a first action set, PUSCH resources or PDSCH resources of the first node 1001B are associated with the cell identified by the second PCI; after the behavior of executing a first action set, PUSCH resources or PDSCH resources of the first node 1001B are associated with the cell identified by the first PCI.

In one embodiment, before the behavior of executing a first action set, PUSCH resources or PDSCH resources of the first node 1001B are associated with the cell identified by the second PCI; after the behavior of executing a first action set, PUSCH resources or PDSCH resources of the first node 1001B are associated with the cell identified by the first PCI and the cell identified by the second PCI.

In one embodiment, a PUSCH or a PDSCH of the first node in the cell identified by the first PCI and a PUSCH or a PDSCH of the first node in the cell identified by the first PCI are associated with two different Radio Network Temporary Identifiers (RNTIs).

In one embodiment, one of arrow 1009B and arrow 1010B exists.

In one embodiment, arrow 1009B and arrow 1010B exist at the same time.

### Embodiment 11A

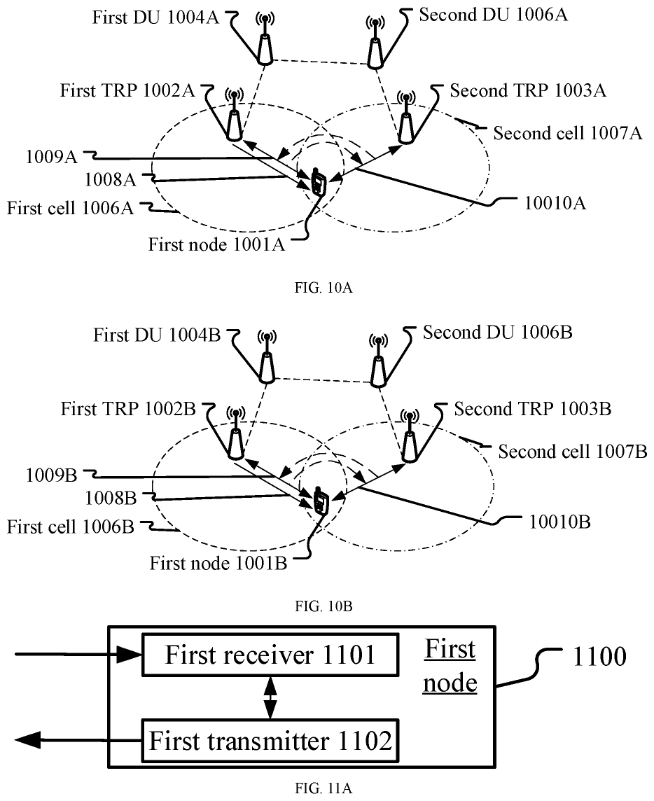

Embodiment 11A illustrates a structure block diagram of a processor in a first node according to one embodiment of the present application, as shown in FIG. 11A. In FIG. 11A, a processor 1100 in a first node comprises a first receiver 1101 and a first transmitter 1102.

The first receiver 1101 receives a first signaling, the first signaling indicates a target identity; monitors a first PDCCH, the first PDCCH is associated with a first downlink RS resource, the first downlink RS resource is associated with a first PCI; receives a second signaling, the second signaling is used to indicate a second PCI; as a response to the behavior of receiving the second signaling, monitoring a second PDCCH and discarding monitoring the first PDCCH, the second PDCCH being associated with a second downlink RS resource, and the second downlink RS resource being associated with the second PCI;

In embodiment 11A, the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI.

In one embodiment, the first receiver 1101, as a response to the behavior of receiving a second signaling, treats a first secondary cell as deactivated; herein, the first secondary cell and a cell identified by the first PCI belong to a same cell group.

In one embodiment, the first secondary cell and a cell identified by the second PCI belong to different TAGs.

In one embodiment, the first receiver 1101, as a response to the behavior of receiving a second signaling, sets a C-RNTI as the target identity.

In one embodiment, the first receiver 1101 receives a first uplink grant and a second uplink grant, the first uplink grant is associated with the source identity, the second uplink grant is associated with the target identity; as a response to the behavior of receiving a first uplink grant and a second uplink grant, considers that a first NDI has been toggled; herein, the first uplink grant and the second uplink grant are associated with a same HARQ process; a time for receiving the first uplink grant is earlier than a time for receiving the second uplink grant.

In one embodiment, the first receiver 1101, as a response to the behavior of receiving a second signaling, clears a first counter to zero; the first counter is maintained at the MAC layer.

In one embodiment, the first receiver 1101 receives a first-type reference signal, the first-type reference signal is associated with the second PCI, and a measurement for the first-type reference signal is used to determine updating the first counter; the first transmitter 1102, when the first counter reaches a first value, initiates a first random access process; as a response to the behavior of initiating a first random access process, transmitting a first radio signal, and the first radio signal being associated with the first PCI; herein, the first value is a positive integer; the first-type reference signal is unrelated to the first PCI.

In one embodiment, the first transmitter 1102 transmits a second radio signal, and the second radio signal comprises the source identity; herein, the second radio signal belongs to the first random access process; the second radio signal is transmitted after the first radio signal.

In one embodiment, the first receiver 1101 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1101 comprises the antenna 452, the receiver 454, the multi-antenna receiving processor 458 and the receiving processor 456 in FIG. 4 of the present application.

In one embodiment, the first receiver 1101 comprises the antenna 452, the receiver 454 and the receiving processor 456 in FIG. 4 of the present application.

In one embodiment, the first transmitter 1102 comprises the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1102 comprises the antenna 452, the transmitter 454, the multi-antenna transmitting processor 457 and the transmitting processor 468 in FIG. 4 of the present application.

In one embodiment, the first transmitter 1102 comprises the antenna 452, the transmitter 454 and the transmitting processor 468 in FIG. 4 of the present application.

### Embodiment 11B

Embodiment 11B illustrates a schematic diagram of assessing radio link quality according to a first RS resource group according to one embodiment of the present application, as shown in FIG. 11B.

In embodiment 11B, the behavior of assessing radio link quality according to the first RS resource group comprises: after the behavior of resetting count of the first-type indication, count of the first-type indication being unrelated to a measurement result on all REs occupied by the first RS resource subgroup before a first moment, and the second signaling being used to indicate the first moment.

In one embodiment, the phrase after the phrase of resetting count of the first-type indication comprises: after the second signaling is received.

In one embodiment, the phrase after the phrase of resetting count of the first-type indication comprises: the second signaling is received, and after the first notification is received.

In one embodiment, the phrase after the phrase of resetting count of the first-type indication comprises: after radio resources of the cell identified by the first PCI is applied.

In one embodiment, the phrase after the phrase of resetting count of the first-type indication comprises: within a time interval between an application of radio resources of the cell identified by the first PCI to an application of radio resources of a cell identified by another PCI; the first PCI in the another PCI field is different.

In one embodiment, the phrase after the phrase of resetting count of the first-type indication comprises: once count of the first-type indication is reset; herein, the behavior of resetting count of the first-type indication is triggered by the behavior of receiving a second signaling.

In one embodiment, the phrase after the phrase of resetting count of the first-type indication comprises: a time interval after resetting count of the first-type indication; herein, RS resources used to assess radio link quality within the time interval are associated with the first PCI.

In one embodiment, the phrase of “after the behavior of resetting count of the first-type indication, count of the first-type indication being unrelated to a measurement result on all REs occupied by the first RS resource subgroup before a first moment” comprises: after the behavior of resetting count of the first-type indication, a measurement result of all REs occupied by the first RS resource subgroup before a first moment is not used to update count of the first-type indication.

In one embodiment, the phrase of “after the behavior of resetting count of the first-type indication, count of the first-type indication being unrelated to a measurement result on all REs occupied by the first RS resource subgroup before a first moment” comprises: after the behavior of resetting count of the first-type indication, count of the first-type indication is related to a measurement result on all REs occupied by the first RS resource subgroup after a first moment.

In one embodiment, the phrase of “after the behavior of resetting count of the first-type indication, count of the first-type indication being unrelated to a measurement result on all REs occupied by the first RS resource subgroup before a first moment” comprises: after the behavior of resetting count of the first-type indication, count of the first-type indication is unrelated to a measurement result on all REs occupied by the second RS resource subgroup; herein, the second RS resource subgroup is only associated with the second PCI.

In one embodiment, a time interval between the first moment and an execution time of the behavior of resetting count of the first-type indication does not exceed a reporting period of the first-type indication.

In one embodiment, a time interval between the first moment and an execution time of the behavior of resetting count of the first-type indication does not exceed an assessment period of the first-type indication.

In one embodiment, the first-type indication reported before the first moment is invalid.

In one embodiment, the first-type indication reported before the first moment is not used to trigger BFR.

In one embodiment, the first-type indication reported before the first moment is not used to trigger RLF.

In one embodiment, the behavior of resetting count of a first-type indication comprises: the first-type indication reported before the first moment is not used as a reference for whether to trigger BFR or RLF.

In one embodiment, the phrase that the second signaling is used to indicate the first moment comprises: the second signaling explicitly indicates the first moment.

In one embodiment, the phrase that the second signaling is used to indicate the first moment comprises: the second signaling implicitly indicates the first moment.

In one embodiment, the phrase that the second signaling is used to indicate the first moment comprises: a time when the second signaling is received is used to indicate the first moment.

In one embodiment, the phrase that the second signaling is used to indicate the first moment comprises: a time when the second signaling is applied is used to indicate the first moment.

In one embodiment, the phrase that the second signaling is used to indicate the first moment comprises: the second signaling is received at the MAC layer and a time when the MAC layer transmits an indication to the physical layer is used to determine the first time.

In one embodiment, the phrase that the second signaling is used to indicate the first moment comprises: after receiving the second signaling at the MAC layer, the MAC layer transmits an indication to the physical layer, and the moment when the physical layer receives the indication is used to determine the first moment.

In one embodiment, the phrase that the second signaling is used to indicate the first moment comprises: the second signaling is received, and a moment at which the second protocol layer in the present application receives the first notification is used to determine the first time.

In one embodiment, the phrase that the second signaling is used to indicate the first moment comprises: after receiving the second signaling at the MAC layer, the MAC layer transmits an indication to the physical layer, and the moment when the physical layer receives the indication and a sum of K1 slot(s) are used to determine the first moment, K1 being a positive integer.

In one subembodiment of the above embodiment, a moment when the physical layer receives the indication increased by K1 slot(s) is equal to the first moment.

In one subembodiment of the above embodiment, the first moment is equal to a moment when the indication is received at the physical layer deferring K1 slot(s) in time.

In one subembodiment of the above embodiment, K1 is fixed.

In one subembodiment of the above embodiment, K1 is configurable.

In one subembodiment of the above embodiment, K1 is equal to 4.

In one subembodiment of the above embodiment, K1 is equal to 8.

### Embodiment 12A

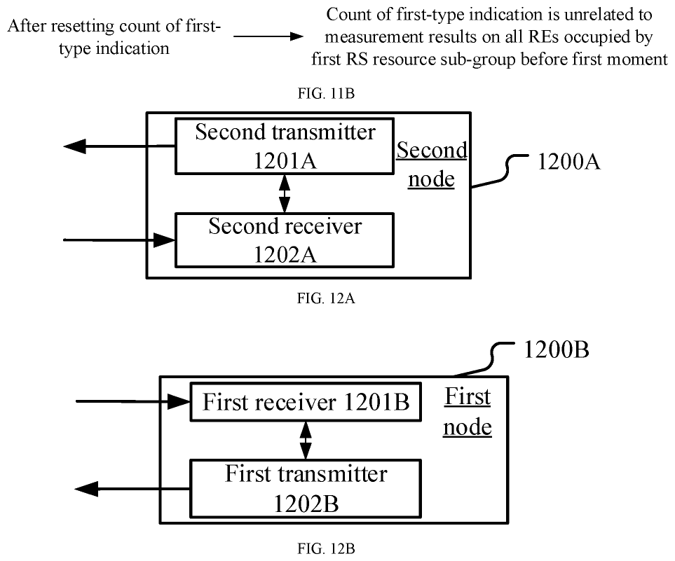

Embodiment 12A illustrates a structure block diagram of a processor in a second node according to one embodiment of the present application, as shown in FIG. 12A. In FIG. 12A, a processor 1200A in a second node comprises a second transmitter 1201A and a second receiver 1202A.

The second transmitter 1201A transmits a first signaling, the first signaling indicates a target identity; transmits a first PDCCH, the first PDCCH is associated with a first downlink RS resource, the first downlink RS resource is associated with a first PCI; transmits a second signaling, the second signaling is used to indicate a second PCI;

In embodiment 12A, as a response to the second signaling being received, a second PDCCH is monitored and the first PDCCH is discarded to be monitored, the second PDCCH is associated with a second downlink RS resource, and the second downlink RS resource is associated with the second PCI; the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI.

In one embodiment, the second PDCCH is transmitted by a maintenance base station of the cell identified by the second PCI.

In one embodiment, as a response to the second signaling being received, a first secondary cell is regarded to be deactivated; herein, the first secondary cell and a cell identified by the first PCI belong to a same cell group.

In one embodiment, the first secondary cell and a cell identified by the second PCI belong to different TAGs.

In one embodiment, as a response to the second signaling being received, a C-RNTI is set as the target identity.

In one embodiment, the C-RNTI is set as the target identity in a MAC entity of a receiver of the second signaling.

In one embodiment, the second transmitter 1201A transmits a first uplink grant, and the first uplink grant is associated with the source identity; herein, as a response to the first uplink grant and the second uplink grant being received, a first NDI is considered to be toggled; the second uplink grant is associated with the target identity; the first uplink grant and the second uplink grant are associated with a same HARQ process; a time for receiving the first uplink grant is earlier than a time for receiving the second uplink grant.

In one embodiment, the first NDI is considered toggled by a receiver of the second signaling.

In one embodiment, as a response to the second signaling being received, a first counter is cleared to zero; the first counter is maintained at the MAC layer.

In one embodiment, the first counter is cleared to zero by a MAC entity of a receiver of the second signaling.

In one embodiment, the second receiver 1202A receives a first radio signal, and the first radio signal is associated with the first PCI; herein, a first-type reference signal is received, the first-type reference signal is associated with the second PCI, and a measurement for the first-type reference signal is used to determine updating the first counter; when the first counter reaches a first value, a first random access process is initiated; as a response to the first random access process being initiated, the first radio signal is transmitted; the first value is a positive integer; the first-type reference signal is unrelated to the first PCI.

In one embodiment, the first-type reference signal is received by a receiver of the second signaling.

In one embodiment, the first random access process is transmitted by a receiver of the second signaling.

In one embodiment, the first radio signal is transmitted by a receiver of the second signaling.

In one embodiment, the second receiver 1202A receives a second radio signal, and the second radio signal comprises the source identity; herein, the second radio signal belongs to the first random access process; the second radio signal is transmitted after the first radio signal.

In one embodiment, the second transmitter 1201A comprises the antenna 420, the transmitter 418, the multi-antenna transmitting processor 471, the transmitting processor 416, the controller/processor 475 and the memory 476 in FIG. 4 of the present application.

In one embodiment, the second transmitter 1201A comprises the antenna 420, the transmitter 418, the multi-antenna transmitting processor 471 and the transmitting processor 416 in FIG. 4 of the present application.

In one embodiment, the second transmitter 1201A comprises the antenna 420, the transmitter 418 and the transmitting processor 416 in FIG. 4 of the present application.

In one embodiment, the second receiver 1202A comprises the antenna 420, the receiver 418, the multi-antenna receiving processor 472, the receiving processor 470, the controller/processor 475 and the memory 476 in FIG. 4 of the present application.

In one embodiment, the second receiver 1202A comprises the antenna 420, the receiver 418, the multi-antenna receiving processor 472 and the receiving processor 470 in FIG. 4 of the present application.

In one embodiment, the second receiver 1202A comprises the antenna 420, the receiver 418 and the receiving processor 470 in FIG. 4 of the present application.

### Embodiment 12B

Embodiment 12B illustrates a structure block diagram of a processor in first second node according to one embodiment of the present application, as shown in FIG. 12B. In FIG. 12B, a processor 1200B of a first node comprises a first receiver 1201B and a first transmitter 1202B.

The first receiver 1201B receives a first signaling, the first signaling is used to configure a first RS resource group, the first RS resource group comprises at least one RS resource; and assesses radio link quality based on the first RS resource group; receives a second signaling after receiving the first signaling; as a response to the behavior of receiving second signaling, executes a first action set, the first action set comprises resetting count of a first-type indication;

In embodiment 12B, the first signaling is an RRC layer signaling, and the second signaling is a protocol-layer signaling below the RRC layer; the second signaling is used to indicate that all RS resources in a first RS resource subgroup are associated with a first PCI, the first RS resource subgroup comprises at least one RS resource, and any RS resource in the first RS resource subgroup belongs to the first RS resource group; the first-type indication is related to link failure.

In one embodiment, the first receiver 1201B, each time the radio link quality assessed based on the first RS resource group is worse than a first threshold, the physical layer of the first node reports a first indication to a higher layer of the first node; the first-type indication comprises the first indication; the first threshold is configurable.

In one embodiment, the first receiver 1201B, each time the radio link quality assessed based on the first RS resource group is better than a second threshold, the physical layer of the first node reports a second indication to the higher layer of the first node; the first-type indication comprises the second indication; the second threshold is configurable.

In one embodiment, the behavior of assessing radio link quality according to the first RS resource group comprises: after the behavior of resetting count of the first-type indication, count of the first-type indication being unrelated to a measurement result on all REs occupied by the first RS resource subgroup before a first moment, and the second signaling being used to indicate the first moment.

In one embodiment, the first action set comprises stopping a first-type timer, and the first-type timer is related to link failure.

In one embodiment, the first receiver 1201B determines that the physical-layer problem occurs; as a response to the behavior of determining an occurrence of a physical-layer problem, starts the first timer; herein, the first timer is maintained at the RRC layer; the first-type timer comprises the first timer.

In one embodiment, the first receiver 1201B receives a first radio signal, and the first radio signal is used to determine first signal quality; determines that first signal quality meets a target condition; during a running period of the first timer, as a response to the behavior of determining that first signal quality meets a target condition, starts a second timer; herein, the target condition comprises a measurement report triggering event; the first-type timer comprises the second timer.

In one embodiment, the first transmitter 1202B submits a first RLC PDU, and the first RLC PDU comprises a polling indication; accompanying the behavior of submitting a first RLC PDU, starts a third timer; herein, an expiration of the third timer is used to determine a retransmission of a polling indication; the first-type timer comprises the third timer.

In one embodiment, the first receiver 1201B determines a retransmission of a first RLC SDU; as a response to the behavior of determining a retransmission of a first RLC SDU, updates count of a third indication; herein, count of the third indication is used to determine a number of times the first RLC SDU is retransmitted; the first-type indication comprises the third indication.

In one embodiment, the first receiver 1201B comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1201B comprises the antenna 452, the receiver 454, the multi-antenna receiving processor 458 and the receiving processor 456 in FIG. 4 of the present application.

In one embodiment, the first receiver 1201B comprises the antenna 452, the receiver 454 and the receiving processor 456 in FIG. 4 of the present application.

In one embodiment, the first transmitter 1202B comprises the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1202B comprises the antenna 452, the transmitter 454, the multi-antenna transmitting processor 457 and the transmitting processor 468 in FIG. 4 of the present application.

In one embodiment, the first transmitter 1202B comprises the antenna 452, the transmitter 454 and the transmitting processor 468 in FIG. 4 of the present application.

### Embodiment 13A

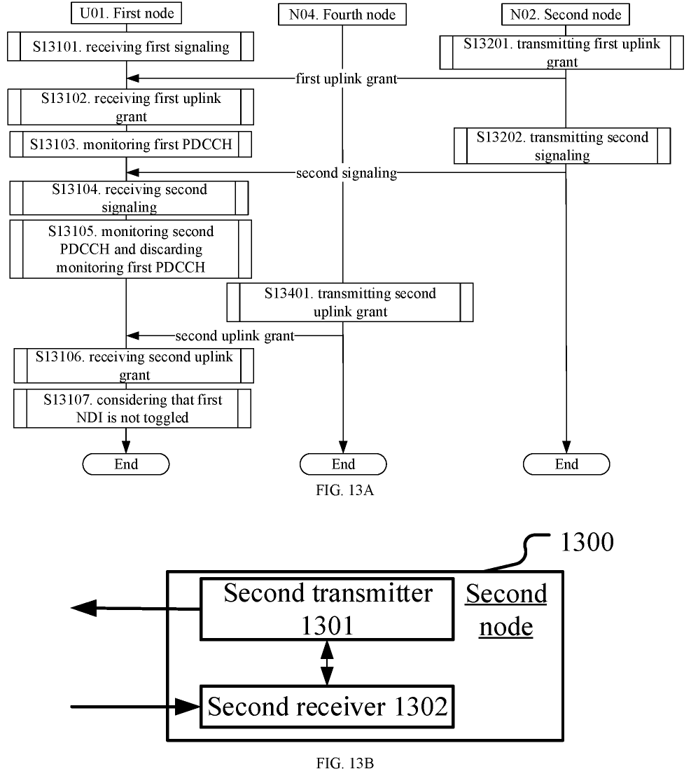

Embodiment 13A illustrates a flowchart of radio signal transmission of receiving a first uplink grant and a second uplink grant being used to determine considering that a first NDI is not toggled according to one embodiment of the present application, as shown in FIG. 13A. It is particularly underlined that the order illustrated in the embodiment does not put constraints over sequences of signal transmissions and implementations.

The first node U01 receives a first signaling in step S13101, and the first signaling indicates a target identity; receives a first uplink grant in step S13102, the first uplink grant is associated with the source identity; in step S13103, monitors a first PDCCH, the first PDCCH is associated with a first downlink RS resource, the first downlink RS resource is associated with a first PCI; in step S13104, receives a second signaling, and the second signaling is used to indicate a second PCI; in step S13105, as a response to the behavior of receiving the second signaling, monitors a second PDCCH and discards monitoring a first PDCCH, the second PDCCH is associated with a second downlink RS resource, and the second downlink RS resource is associated with the second PCI; in step S13106, receives a second uplink grant, and the second uplink grant is associated with the target identity; in step S13107, as a response to the behavior of receiving a first uplink grant and a second uplink grant, considers that a first NDI is not toggled.

The second node N02 transmits the first uplink grant in step S13201; transmits the second signaling in step S13202.

The fourth node N04 transmits the second uplink grant in step S13401.

In embodiment 13, the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI; the first uplink grant and the second uplink grant are associated with a same HARQ process; a time for receiving the first uplink grant is earlier than a time for receiving the second uplink grant.

In one embodiment, the meaning of the behavior of “as a response to the behavior of receiving a first uplink grant and a second uplink grant, considering that a first NDI is not toggled” comprises: regardless of whether a value of the first NDI provided in HARQ information associated with the first uplink grant is different from a value of the first NDI provided in HARQ information associated with the second uplink grant, considering that the first NDI is not toggled.

In one embodiment, the meaning of the behavior of “as a response to the behavior of receiving a first uplink grant and a second uplink grant, considering that a first NDI is not toggled” comprises: as a response to the behavior of receiving a first uplink grant and a second uplink grant, considering that the second uplink grant is used for retransmission.

In one embodiment, the behavior of “as a response to the behavior of receiving a second uplink grant, considering that a first NDI is not toggled” comprises: if the second uplink grant is received on a PDCCH for the target identity of the MAC entity, and if the second uplink grant is to the target identity of a MAC entity, and if a previous uplink grant of a same HARQ process delivered to a HARQ entity is an uplink grant to the source identity of a MAC entity, regardless of a value of the NDI, considering that the NDI of a corresponding HARQ process is not toggled.

In one embodiment, the behavior of considering a first NDI is not toggled comprises: considering the first NDI not to have been toggled.

In one embodiment, the behavior of considering a first NDI is not toggled comprises: considering that a value of the first NDI does not changed.

### Embodiment 13B

Embodiment 13B illustrates a structure block diagram of a processor in a second node according to one embodiment of the present application, as shown in FIG. 13B. In FIG. 13B, a processor 1300 of a second node comprises a second transmitter 1301 and a second receiver 1302.

The second transmitter 1301 transmits a first signaling, the first signaling is used to configure a first RS resource group, and the first RS resource group comprises at least one RS resource; and transmits a second signaling after transmitting the first signaling;

In embodiment 13B, radio link quality is assessed according to the first RS resource group; as a response to the second signaling being received, a first action set is executed, the first action set comprises resetting count of a first-type indication; the first signaling is an RRC layer signaling, and the second signaling is a protocol-layer signaling below the RRC layer; the second signaling is used to indicate that all RS resources in a first RS resource subgroup are associated with a first PCI, the first RS resource subgroup comprises at least one RS resource, and any RS resource in the first RS resource subgroup belongs to the first RS resource group; the first-type indication is related to link failure.

In one embodiment, each time the radio link quality assessed based on the first RS resource group is worse than a first threshold, a first indication is reported by the physical layer of a receiver of the first signaling to the higher layer of a receiver of the first signaling; the first-type indication comprises the first indication; the first threshold is configurable.

In one embodiment, each time the radio link quality assessed based on the first RS resource group is better than a second threshold, a second indication is reported by the physical layer of the first node to the higher layer of the first node; the first-type indication comprises the second indication; the second threshold is configurable.

In one embodiment, the phrase that radio link quality is assessed according to the first RS resource group comprises: after the behavior of resetting count of the first-type indication, count of the first-type indication being unrelated to a measurement result on all REs occupied by the first RS resource subgroup before a first moment, and the second signaling being used to indicate the first moment.

In one embodiment, the first action set comprises stopping a first-type timer, and the first-type timer is related to link failure.

In one embodiment, an occurrence of physical-layer problem is determined; as a response to the occurrence of the physical-layer problem being determined, a first timer is started; herein, the first timer is maintained at the RRC layer; the first-type timer comprises the first timer.

In one embodiment, the second transmitter 1301 transmits a first radio signal, and the first radio signal is used to determine first signal quality; herein, the first signal quality satisfying a target condition is determined; during a running period of the first timer, and as a response to the first signal quality satisfying the target condition being determined, a second timer is started; the target condition comprises a measurement report triggering event; the first-type timer comprises the second timer.

In one embodiment, a first RLC PDU is submitted, the first RLC PDU comprises a polling indication; accompanying the first RL PDU being submitted, a third timer is started; herein, an expiration of the third timer is used to determine a retransmission of a polling indication; the first-type timer comprises the third timer.

In one embodiment, a first RLC SDU is determined to be retransmitted; as a response to the first RLC SDU being determined to be retransmitted, count of a third indication is updated; herein, count of the third indication is used to determine a number of times the first RLC SDU is retransmitted; the first-type indication comprises the third indication.

In one embodiment, the second transmitter 1301 comprises the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises the antenna 420, the transmitter 418, the multi-antenna transmitting processor 471 and the transmitting processor 416 in FIG. 4 of the present application.

In one embodiment, the second transmitter 1301 comprises the antenna 420, the transmitter 418 and the transmitting processor 416 in FIG. 4 of the present application.

In one embodiment, the second receiver 1302 comprises the antenna 420, the receiver 418, the multi-antenna receiving processor 472, the receiving processor 470, the controller/processor 475 and the memory 476 in FIG. 4 of the present application.

In one embodiment, the second receiver 1302 comprises the antenna 420, the receiver 418, the multi-antenna receiving processor 472 and the receiving processor 470 in FIG. 4 of the present application.

In one embodiment, the second receiver 1302 comprises the antenna 420, the receiver 418 and the receiving processor 470 in FIG. 4 of the present application.

### Embodiment 14

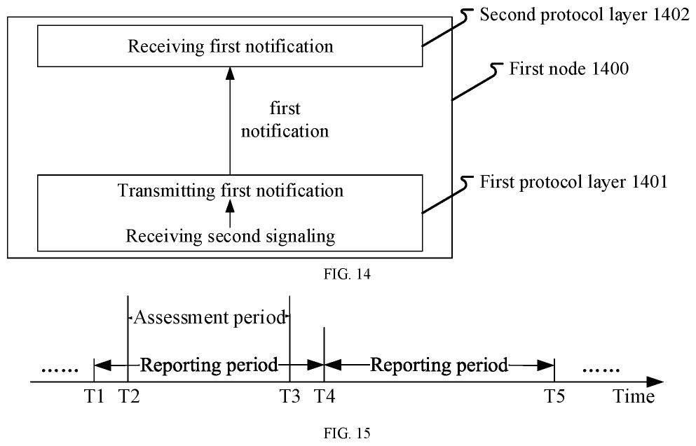

Embodiment 14 illustrates a schematic diagram of a first notification according to one embodiment of the present application, as shown in FIG. 14.

In embodiment 14, the first action set comprises: the first node 1400 at first protocol layer 1401 transmits a first notification to a second protocol layer 1402 that the first node 1400 is at; the first node 1400 receives the first notification at the second protocol layer 1402.

In one embodiment, the first notification is used to determine that the second signaling is received.

In one embodiment, the first notification is used to determine that the first node starts applying radio resources of the cell identified by the first PCI.

In one embodiment, the behavior of the first node 1400 receiving the first notification at the second protocol layer 1402 is used to trigger the behavior of stopping the first-type timer.

In one subembodiment of the above embodiment, when the first node 1400 receives the first notification at the second protocol layer 1402, stop a first-type timer.

In one subembodiment of the above embodiment, as the response to the behavior of receiving a second signaling, when the first node 1400 receives the first notification at the second protocol layer 1402, stop a first-type timer.

In one subembodiment of the above embodiment, as a response to the behavior of receiving second signaling, execute a first action set, the first action set comprises stopping a first-type timer; herein, the first action set comprises: the first node 1400 at first protocol layer 1401 transmits a first notification to a second protocol layer 1402 that the first node 1400 is at; the first node 1400 receives the first notification at the second protocol layer 1402; the behavior of the first node 1400 receiving the first notification at the second protocol layer 1402 is used to trigger the behavior of stopping the first-type timer.

In one embodiment, the behavior of the first node 1400 receiving the first notification at the second protocol layer 1402 is used to trigger the behavior of resetting count of a first-type indication.

In one subembodiment of the above embodiment, when the first node 1400 receives the first notification at the second protocol layer 1402, reset count of a first-type indication.

In one subembodiment of the above embodiment, as the response to the behavior of receiving a second signaling, when the first node 1400 receives the first notification at the second protocol layer 1402, reset count of a first-type indication.

In one subembodiment of the above embodiment, as a response to the behavior of receiving second signaling, execute a first action set, the first action set comprises resetting count of a first-type indication; herein, the first action set comprises: the first node 1400 at first protocol layer 1401 transmits a first notification to a second protocol layer 1402 that the first node 1400 is at; the first node 1400 receives the first notification at the second protocol layer 1402; the behavior of the first node 1400 receiving the first notification at the second protocol layer 1402 is used to trigger the behavior of resetting count of a first-type indication.

In one embodiment, the first protocol layer 1401 comprises a MAC layer.

In one embodiment, the first protocol layer 1401 comprises a physical layer.

In one embodiment, the second protocol layer 1402 comprises an RLC layer.

In one embodiment, the second protocol layer 1402 comprises an RRC layer.

In one embodiment, the first protocol layer 1401 is located below the second protocol layer 1402.

In one embodiment, the first protocol layer 1401 is a lower layer of the second protocol layer 1402.

In one embodiment, the second protocol layer 1402 is an upper layer of the first protocol layer 1401.

In one embodiment, the first protocol layer 1401 is the physical layer, and the second protocol layer 1402 is the MAC layer.

In one embodiment, the first protocol layer 1401 is the physical layer, and the second protocol layer 1402 is the RRC layer.

In one embodiment, the first notification is a message between protocol layers.

In one embodiment, the first notification is not a radio message.

In one embodiment, the first notification is transmitted inside the first node 1400.

In one embodiment, the FIG. 14 only illustrates that the first protocol layer 1401 and the second protocol layer 1402 belong to the first node 1400; the first node 1400 also comprises protocol layers or components other than the first protocol layer 1401 and the second protocol layer 1402.

### Embodiment 15

Embodiment 15 illustrates a schematic diagram of a reporting period and an assessment period according to one embodiment of the present application, as shown in FIG. 15. In FIG. 15, the horizontal axis represents time, T1, T4, and T5 are three chronologically ascending moments, the moment of T1, the moment of T4, and the moment of T5 are the moments at which the first-type indication are reported, a time interval between any two adjacent moments of the moment of T1, the moment of T4, and the moment of T5 is equal, and a time interval between any two adjacent moments of the moment of T1, the moment of T4, and the moment of T5 is equal to the reporting period; T2 and T3 are two chronologically ascending moments, and a time interval between the moment of T2 and the moment of T3 is equal to the assessment period.

In one embodiment, the moment of T2 is not less than the moment of T1; the moment of T3 is not greater than the moment of T4.

In one embodiment, there exists an assessment period within each reporting period.

In one embodiment, radio link quality is assessed based on the first RS resource group during a time interval between the moment of T2 and the moment of T3.

In one embodiment, the moment of T1 and the moment of T4 are any two adjacent reporting moments.

In one embodiment, a moment when last the first-type indication is reported and the reporting period are used to determine a moment when this time the first-type indication is reported.

In one embodiment, the first-type indication is reported every other reporting period.

In one embodiment, the first-type indication is not reported every other reporting period.

In one embodiment, every other reporting period, one of the first indication or the second indication is reported.

In one embodiment, every other reporting period, no indication is reported.

In one embodiment, every other reporting period, if the radio link quality assessed based on the first RS resource group is worse than a first threshold, the physical layer of the first node reports a first indication to a higher layer of the first node.

In one embodiment, every other reporting period, if the radio link quality assessed based on the first RS resource group is better than a second threshold, the physical layer of the first node reports a second indication to the higher layer of the first node.

In one embodiment, every other reporting period, if the radio link quality assessed based on the first RS resource group is worse than a first threshold, the physical layer of the first node reports a first indication to the higher layer of the first node; if the radio link quality assessed based on the first RS resource group is better than a second threshold, the physical layer of the first node reports a second indication to the higher layer of the first node.

In one embodiment, every other reporting period, if the radio link quality assessed based on the first RS resource group is worse than a first threshold, the physical layer of the first node reports a first indication to the higher layer of the first node; if the radio link quality assessed based on the first RS resource group is better than a second threshold, the physical layer of the first node does not report an indication to the higher layer of the first node.

In one embodiment, the moment only represents a length of time and a relative relation between moments, without considering the impact of system software and hardware on time, and does not represent a specific moment.

In one embodiment, the assessment period refers to a period of time interval after one reporting time and before a next reporting time.

In one embodiment, the assessment period is not longer than the reporting period.

In one embodiment, the assessment period is as long as the reporting period.

In one embodiment, the assessment period is shorter than the reporting period.

In one embodiment, the moment of T3 is the same as the moment of T4.

In one embodiment, the moment of T3 is different the moment of T4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IOT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first signaling, the first signaling indicating a target identity; monitoring a first PDCCH, the first PDCCH being associated with a first downlink RS resource, the first downlink RS resource being associated with a first PCI; receiving a second signaling, the second signaling being used to indicate a second PCI; as a response to the behavior of receiving the second signaling, monitoring a second PDCCH and discarding monitoring the first PDCCH, the second PDCCH being associated with a second downlink RS resource, and the second downlink RS resource being associated with the second PCI;
wherein the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI.

2. The first node according to claim 1, wherein the first signaling is used to configure a candidate cell; the first signaling comprises an RRCReconfiguration message or the first signaling comprises an RRCResume message.

3. The first node according to claim 1, wherein the first PCI is different from the second PCI; the second PCI is used to identify a second cell; the first signaling comprises physical-layer parameters of the first node in the second cell, and/or, the first signaling comprises a C-RNTI of the first node in the second cell, the C-RNTI is the target identity, and/or, the first signaling comprises a timer T304.

4. The first node according to claim 1, wherein the first PDCCH being associated with a first downlink RS resource comprises: the first PDCCH is associated with a CORESET, and the CORESET comprises the first downlink RS resource; the second PDCCH is associated with a second downlink RS resource comprises: the second PDCCH is associated with a CORESET, and the CORESET comprises the second downlink RS resource.

5. The first node according to claim 1, wherein the first downlink RS resource corresponds to a TCI state identity; the second downlink RS resource corresponds to a TCI state identity; the first downlink RS resource comprises a CSI-RS indexed by NZP-CSI-RS-ResourceId, or the first downlink RS resource comprises an SSB indexed by SSB-Index; the second downlink RS resource comprises a CSI-RS indexed by NZP-CSI-RS-ResourceId, or the second downlink RS resource comprises an SSB indexed by SSB-Index.

6. The first node according to claim 1, wherein the second signaling comprises a MAC CE; the phrase that the second signaling comprises a signaling below the RRC layer comprises: the second signaling is generated at the MAC layer.

7. The first node according to claim 1, wherein the second signaling comprises a TCI State ID field, the TCI State ID field is used to indicate a TCI state, and the TCI state is associated with the second downlink RS resource; wherein the second downlink RS resource is associated with the second PCI.

8. The first node according to claim 1, wherein the second signaling comprises a first field, the first field indicates the second PCI, the first field is set as a first configuration index, the first configuration index corresponds to a cell identified by the second PCI, and the first configuration index is a non-negative integer.

9. The first node according to claim 1, wherein the first PDCCH indicates scheduling information of the second signaling.

10. The first node according to claim 1, wherein the second PDCCH comprises a USS set.

11. The first node according to claim 1, wherein when the first signaling is received, a configuration in the first signaling is not applied, and when the second signaling is received, a configuration in the first signaling is applied.

12. The first node according to claim 1, comprising:
the first receiver, as a response to the behavior of receiving a second signaling, regarding a first secondary cell to be deactivated;
wherein the first secondary cell and a cell identified by the first PCI belong to a same cell group.

13. The first node according to claim 12, wherein the first secondary cell and a cell identified by the second PCI belong to different TAGs.

14. The first node according to claim 1, comprising:
the first receiver, as a response to the behavior of receiving a second signaling, setting a C-RNTI as the target identity.

15. The first node according to claim 1, wherein the source identity is a C-RNTI of the first node in the cell identified by the first PCI; the target identity is a C-RNTI of the first node in the cell identified by the second PCI.

16. The first node according to claim 1, comprising:
the first receiver, as a response to the behavior of receiving a second signaling, clearing a first counter to zero; the behavior of clearing a first counter to zero comprises: setting the first counter to 0; the first counter being maintained at the MAC layer.

17. The first node according to claim 1, wherein the first counter is BFI_COUNTER, or, the first counter is LBT_COUNTER.

18. The first node according to claim 1, wherein as a response to the behavior of receiving a second signaling, stop a first timer, the first timer is maintained at the MAC layer; the first timer is lbt-FailureDetectionTimer, or, the first timer is beamFailureDetectionTimer.

19. A second node for wireless communications, comprising:
a second transmitter, transmitting a first signaling, the first signaling indicating a target identity; transmitting a first PDCCH, the first PDCCH being associated with a first downlink RS resource, the first downlink RS resource being associated with a first PCI; transmitting a second signaling, the second signaling being used to indicate a second PCI;
wherein as a response to the second signaling being received, a second PDCCH is monitored and the first PDCCH is discarded to be monitored, the second PDCCH is associated with a second downlink RS resource, and the second downlink RS resource is associated with the second PCI; the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI.

20. A method in a first node for wireless communications, comprising:
receiving a first signaling, the first signaling indicating a target identity;
monitoring a first PDCCH, the first PDCCH being associated with a first downlink RS resource, the first downlink RS resource being associated with a first PCI;
receiving a second signaling, the second signaling being used to indicate a second PCI; and
as a response to the behavior of receiving a second signaling, monitoring a second PDCCH and discarding monitoring the first PDCCH, the second PDCCH being associated with a second downlink RS resource, and the second downlink RS resource being associated with the second PCI;
wherein the first signaling comprises an RRC message; the second signaling comprises a signaling below the RRC layer; the first PDCCH uses a source identity for scrambling; the second PDCCH uses the target identity for scrambling; the source identity and the target identity are different; the source identity and the target identity are respectively an RNTI.
